(19) United States
(12) Patent Application Publication
(10) Pub. No.: US 2022/0269405 A1
(43) Pub. Date: Aug. 25, 2022

(54) Floating Window Management Method and Related Apparatus

(71) Applicant: Huawei Technologies Co., Ltd., Shenzhen (CN)

(72) Inventors: Xia Wu, Shenzhen (CN); Xiao Han, Shenzhen (CN)

(21) Appl. No.: 17/631,168

(22) PCT Filed: Jul. 25, 2020
(86) PCT No.: PCT/CN2020/104682

§ 371 Date: Jan. 28, 2022

(30) Foreign Application Priority Data
Jul. 31, 2019 (CN) 201910704781.5

(51) Int. Cl. G06F 3/04883; G06F 3/0485; G06F 1/16

(52) U.S. Cl. CPC G06F 3/04883; G06F 3/0485; G06F 1/1616

(57) ABSTRACT

A floating window management method includes a first electronic device displaying a first user interface and a floating window on a display, where the floating window displays an image collected by a camera of a second electronic device of a video contact. The first electronic device receives a first user operation of dragging the floating window to a status bar in the first user interface. The first electronic device hides the floating window in response to the first user operation.

This application claims priority to Chinese Patent Application No. 201910704781.5, filed with the China National Intellectual Property Administration on Jul. 31, 2019 and entitled “FLOATING WINDOW MANAGEMENT METHOD AND RELATED APPARATUS”, which is incorporated herein by reference in its entirety.

### TECHNICAL FIELD

This application relates to the field of electronic technologies, and in particular, to a floating window management method and a related apparatus.

### BACKGROUND

As shown in FIG. 1A, when a user makes a video call, a display of an electronic device displays a video call interface. The user may exit the current video call interface without declining the video call. When the user switches the current video call interface to another user interface, the display of the electronic device displays both the another user interface and a floating window. The floating window is used to display an image collected by a camera of an electronic device of a video contact. For example, as shown in FIG. 1A and FIG. 1B, when the user switches the current video call interface to a home screen by touching a home screen button in the video call interface, the display of the electronic device displays both the home screen and the floating window. It can be learned from FIG. 1B that the floating window blocks a part of the home screen. Therefore, the floating window may affect browsing interface information on the home screen by the user, or affect a user operation performed by the user on the home screen.

In conclusion, the floating window used for the video call affects the user operation, causing inconvenience of the user operation.

### SUMMARY

Embodiments of this application provide a floating window management method and a related apparatus. According to this application, when a video call is kept, a floating window can be prevented from blocking a user interface, to improve convenience of a user operation.

According to a first aspect, this application provides a floating window management method, including: An electronic device displays a first user interface and a floating window on a display, where the floating window is used to display an image collected by a camera of an electronic device of a video contact. The electronic device receives a first user operation, where the first user operation is that a user drags the floating window to a status bar in the first user interface. The electronic device hides the floating window in response to the first user operation.

According to the method in the first aspect, when a video call is kept, the floating window can be prevented from blocking a user interface, to improve convenience of a user operation.

With reference to the first aspect, in some embodiments, after the electronic device hides the floating window in response to the first user operation, the method further includes: The electronic device receives a second user operation performed on a status bar in a second user interface. The electronic device displays the second user interface and the floating window on the display in response to the second user operation.

With reference to the first aspect, in some embodiments, after the electronic device hides the floating window in response to the first user operation, the method further includes: The electronic device receives a third user operation performed on the status bar in the second user interface. The electronic device displays, on the display in full screen mode in response to the third user operation, a video call interface corresponding to the floating window.

With reference to the first aspect, in some embodiments, the display includes a first area and a second area, and after the electronic device hides the floating window in response to the first user operation, the method further includes: The electronic device receives a fourth user operation performed on the status bar in the second user interface. In response to the fourth user operation, the electronic device displays the second user interface in the first area, and the electronic device displays the video call interface corresponding to the floating window in the second area.

With reference to the first aspect, in some embodiments, the floating window and the status bar cannot be displayed in an overlapping manner; and the first user operation is that a finger of the user slides on the display, to drag the floating window upward to the status bar in the first user interface, and a first preset condition is met.

With reference to the first aspect, in some embodiments, the first preset condition is: an upper edge of the floating window coincides with a lower edge of a status bar in the first user interface; when the upper edge of the floating window coincides with the lower edge of the status bar in the first user interface, the finger of the user stops sliding and stops touching an area in which the floating window is located on the display; after the upper edge of the floating window coincides with the lower edge of the status bar in the first user interface, a distance by which the finger of the user continues to slide upward on the display reaches a first distance threshold; after the upper edge of the floating window coincides with the lower edge of the status bar in the first user interface, when the distance by which the finger of the user continues to slide upward on the display is greater than or equal to the first distance threshold, the finger of the user stops sliding and stops touching the display; after the upper edge of the floating window coincides with the lower edge of the status bar in the first user interface, a time period for which the finger of the user continues to touch the area in which the floating window is located on the display reaches a first time threshold; after the upper edge of the floating window coincides with the lower edge of the status bar in the first user interface, when the distance by which the finger of the user continues to slide upward on the display is greater than or equal to the first distance threshold, the finger of the user stops sliding and stops touching the display; a distance between the upper edge of the floating window and an upper edge of the status bar in the first user interface is less than a first width value; or when the distance between the upper edge of the floating window and the upper edge of the status bar in the first user interface is less than the first width value, the finger of the user stops touching the area in which the floating window is located on the display.

With reference to the first aspect, in some embodiments, the floating window and the status bar may be displayed in an overlapping manner, and after an upper edge of the floating window coincides with an upper edge of the status bar in the first user interface, the floating window cannot continue to move upward; a width of a status bar on the electronic device is a first width value; and the first user operation is that a finger of the user slides on the display, to drag the floating window upward to the status bar in the first user interface, and a second preset condition is met.

With reference to the first aspect, in some embodiments, the second preset condition is: when a distance between the upper edge of the floating window and the upper edge of the status bar in the first user interface is less than the first width value, a time period for which the finger of the user stops sliding and continues to touch an area in which the floating window is located on the display reaches a second time threshold; after the distance between the upper edge of the floating window and the upper edge of the status bar in the first user interface is less than the first width value, when the time period for which the finger of the user stops sliding and continues to touch the area in which the floating window is located on the display is greater than or equal to the second time threshold, the finger of the user stops touching the area in which the floating window is located on the display; the upper edge of the floating window coincides with the upper edge of the status bar in the first user interface; when the upper edge of the floating window coincides with the upper edge of the status bar in the first user interface, the finger of the user stops sliding and stops touching the area in which the floating window is located on the display; after the upper edge of the floating window coincides with the upper edge of the status bar in the first user interface, a distance by which the finger of the user continues to slide upward on the display reaches a second distance threshold; after the upper edge of the floating window coincides with the upper edge of the status bar in the first user interface, when the distance by which the finger of the user continues to slide upward on the display is greater than or equal to the second distance threshold, the finger of the user stops sliding and stops touching the display; after the upper edge of the floating window coincides with the upper edge of the status bar in the first user interface, a time period for which the finger of the user continues to touch the area in which the floating window is located on the display reaches a third time threshold; or after the upper edge of the floating window coincides with the upper edge of the status bar in the first user interface, when the time period for which the finger of the user continues to touch the area in which the floating window is located on the display is greater than or equal to the third time threshold, the finger of the user stops touching the area in which the floating window is located on the display.

With reference to the first aspect, in some embodiments, the floating window and the status bar in the first user interface may be displayed in an overlapping manner, and after an upper edge of the floating window coincides with an upper edge of the status bar in the first user interface, the floating window may continue to move upward; a current height of the floating window is a first height value, and a third distance threshold is less than the first height value; and the first user operation is that a finger of the user slides on the display, to drag the floating window upward to the status bar in the first user interface, and a third preset condition is met.

With reference to the first aspect, in some embodiments, the third preset condition is: a distance between a lower edge of the floating window and the upper edge of the status bar in the first user interface is less than the first height value; when the distance between the lower edge of the floating window and the upper edge of the status bar in the first user interface is less than the first height value, the finger of the user stops touching an area in which the floating window is located on the display; the distance between the lower edge of the floating window and the upper edge of the status bar in the first user interface reaches the third distance threshold; or when the distance between the lower edge of the floating window and the upper edge of the status bar in the first user interface is less than the third distance threshold, the finger of the user stops sliding and stops touching the display.

With reference to the first aspect, in some embodiments, the second user operation is that the finger of the user single-taps or double-taps the status bar in the second user interface; the second user operation is that the finger of the user slides leftward or rightward on the status bar in the second user interface for a time period greater than or equal to a fourth time threshold; the second user operation is that the finger of the user slides leftward or rightward on the status bar in the second user interface by a distance greater than or equal to a fourth distance threshold; the second user operation is that the finger of the user touches and holds the status bar in the second user interface for a time period greater than or equal to a fifth time threshold; or the second user operation is that the finger of the user slides downward by using the status bar in the second user interface as a start point, and when a distance by which the finger of the user slides downward is greater than a fifth distance threshold, the finger of the user stops sliding and stops touching the display.

With reference to the first aspect, in some embodiments, the third user operation is that the finger of the user single-taps or double-taps the status bar in the second user interface; the third user operation is that the finger of the user slides leftward or rightward on the status bar in the second user interface for a time period greater than or equal to a fourth time threshold; the third user operation is that the finger of the user slides leftward or rightward on the status bar in the second user interface by a distance greater than or equal to a fourth distance threshold; the third user operation is that the finger of the user touches and holds the status bar in the second user interface for a time period greater than or equal to a fifth time threshold; or the third user operation is that the finger of the user slides downward by using the status bar in the second user interface as a start point, and when a distance by which the finger of the user slides downward is greater than a fifth distance threshold, the finger of the user stops sliding and stops touching the display.

With reference to the first aspect, in some embodiments, the fourth user operation is that the finger of the user single-taps or double-taps the status bar in the second user interface; the fourth user operation is that the finger of the user slides leftward or rightward on the status bar in the second user interface for a time period greater than or equal to a fourth time threshold; the fourth user operation is that the finger of the user slides leftward or rightward on the status bar in the second user interface by a distance greater than or equal to a fourth distance threshold; the fourth user operation is that the finger of the user touches and holds the status bar in the second user interface for a time period greater than or equal to a fifth time threshold; or the fourth user operation is that the finger of the user slides downward by using the status bar in the second user interface as a start point, and when a distance by which the finger of the user slides downward is greater than a fifth distance threshold, the finger of the user stops sliding and stops touching the display.

With reference to the first aspect, in some embodiments, a distance by which the finger of the user slides downward is a distance between a lower edge of the status bar in the second user interface and the finger of the user; a fifth user operation is that the finger of the user slides downward on the display by using the status bar in the second user interface as a start point, when a distance by which the finger of the user slides downward is less than a fifth distance threshold, the finger of the user stops sliding and stops touching the display, and the fifth user operation is used to trigger the electronic device to display a system notification bar interface in full screen mode; the second user operation is that the finger of the user slides downward on the display by using the status bar in the second user interface as a start point, and when a distance by which the finger of the user slides downward is greater than or equal to the fifth distance threshold and less than a sixth distance threshold, the finger of the user stops sliding and stops touching the display; the third user operation is that the finger of the user slides downward on the display by using the status bar in the second user interface as a start point, and when a distance by which the finger of the user slides downward is greater than or equal to the sixth distance threshold and less than a seventh distance threshold, the finger of the user stops sliding and stops touching the display; and the fourth user operation is that the finger of the user slides downward on the display by using the status bar in the second user interface as a start point, and a distance by which the finger of the user slides downward reaches the seventh distance threshold; or the fourth user operation is that the finger of the user slides downward on the display by using the status bar in the second user interface as a start point, and when a distance by which the finger of the user slides downward is greater than or equal to the seventh distance threshold, the finger of the user stops sliding and stops touching the display.

With reference to the first aspect, in some embodiments, a distance by which the finger of the user slides downward is a distance between a lower edge of the status bar in the second user interface and the finger of the user; the status bar in the second user interface is divided into two parts: a first preset area and a second preset area, and widths of the status bar, the first preset area, and the second preset area in the second user interface are the same; the second user operation is that the finger of the user slides downward on the display by using the first preset area as a start point, and when a distance by which the finger of the user slides downward is less than an eighth distance threshold, the finger of the user stops sliding and stops touching the display; the third user operation is that the finger of the user slides downward on the display by using the first preset area as a start point, and a distance by which the finger of the user slides downward reaches the eighth distance threshold; or the third user operation is that the finger of the user slides downward on the display by using the first preset area as a start point, and when a distance by which the finger of the user slides downward is greater than or equal to the eighth distance threshold, the finger of the user stops sliding and stops touching the display; a fifth user operation is that the finger of the user slides downward on the display by using the second preset area as a start point, and when a distance by which the finger of the user slides downward is less than a fifth distance threshold, the finger of the user stops sliding and stops touching the display; and the fourth user operation is that the finger of the user slides downward on the display by using the second preset area as a start point, and a distance by which the finger of the user slides downward reaches the fifth distance threshold; or the fourth user operation is that the finger of the user slides downward on the display by using the second preset area as a start point, and when a distance by which the finger of the user slides downward is greater than or equal to the fifth distance threshold, the finger of the user stops sliding and stops touching the display.

With reference to the first aspect, in some embodiments, the display of the electronic device is a notch screen or a hole-punch display, a notch of the notch screen or a small hole of the hole-punch display is located at a middle location of an upper edge of the display, and the status bar in the second user interface is divided into left and right parts by using the notch or the small hole as a division point; and the first preset area is a left half part of the status bar in the second user interface, and the second preset area is a right half part of the status bar in the second user interface; or the first preset area is a right half part of the status bar in the second user interface, and the second preset area is a left half part of the status bar in the second user interface.

With reference to the first aspect, in some embodiments, the display of the electronic device is a foldable screen, and the second user interface is divided into a first interface and a second interface by using a folding track of the foldable screen as a division line; and the first preset area is a status bar in the first interface, and the second preset area is a status bar in the second interface; or the first preset area is a status bar in the second interface, and the second preset area is a status bar in the first interface.

With reference to the first aspect, in some embodiments, the display of the electronic device is a hole-punch display, a small hole of the hole-punch display is located on the status bar in the second user interface, and that the electronic device receives a second user operation performed on a status bar in a second user interface includes: The electronic device receives a sixth user operation performed on the status bar in the second user interface, where the sixth user operation is that the finger of the user approaches the small hole in a floating manner. The electronic device displays a menu navigation window around the small hole in response to the sixth user operation, where the menu navigation window includes a first option control, and the first option control is used to trigger the electronic device to display the hidden floating window. The electronic device receives the second user operation, where the second user operation is that the finger of the user taps the first option control.

With reference to the first aspect, in some embodiments, the display of the electronic device is a hole-punch display, a small hole of the hole-punch display is located on the status bar in the second user interface, and that the electronic device receives a third user operation performed on the status bar in the second user interface includes: The electronic device receives a sixth user operation performed on the status bar in the second user interface, where the sixth user operation is that the finger of the user approaches the small hole in a floating manner. The electronic device displays a menu navigation window around the small hole in response to the sixth user operation, where the menu navigation window includes a second option control, and the second option control is used to trigger the electronic device to display, in full screen mode, the video call interface corresponding to the hidden floating window. The electronic device receives the third user operation, where the third user operation is that the finger of the user taps the second option control.

With reference to the first aspect, in some embodiments, the display of the electronic device is a hole-punch display, a small hole of the hole-punch display is located on the status bar in the second user interface, and that the electronic device receives a third user operation performed on the status bar in the second user interface includes: The electronic device receives a sixth user operation performed on the status bar in the second user interface, where the sixth user operation is that the finger of the user approaches the small hole in a floating manner. The electronic device displays a menu navigation window around the small hole in response to the sixth user operation, where the menu navigation window includes a third option control, and the third option control is used to trigger the electronic device to display, in full screen mode, the video call interface corresponding to the hidden floating window. The electronic device receives the fourth user operation, where the fourth user operation is that the finger of the user taps the third option control.

With reference to the first aspect, in some embodiments, before the electronic device hides the floating window in response to the first user operation, the method further includes: The electronic device displays prompt information on the display before the user drags the floating window to the status bar in the first user interface, where the prompt information is used to prompt that the user drags the floating window to the status bar to hide the floating window.

With reference to the first aspect, in some embodiments, that the electronic device displays prompt information on the display before the user drags the floating window to the status bar in the first user interface includes: The electronic device displays the prompt information on the display when the electronic device detects that a distance between the upper edge of the floating window and the lower edge of the status bar in the first user interface is less than or equal to a ninth distance threshold, and the finger of the user continues to drag the floating window upward.

With reference to the first aspect, in some embodiments, the prompt information may be an animation, a text, and/or a picture.

With reference to the first aspect, in some embodiments, after the electronic device hides the floating window, the method further includes: The electronic device displays identification information on a status bar on the display, where the identification information is used to identify the hidden floating window.

With reference to the first aspect, in some embodiments, the prompt information may be an animation, a text, and/or a picture.

According to a second aspect, this application provides an electronic device, including one or more processors and one or more memories. The one or more memories are coupled to the one or more processors, the one or more memories are configured to store computer program code, where the computer program code includes computer instructions, and when the one or more processors execute the computer instructions, the electronic device performs the floating window management method according to the first aspect.

According to a third aspect, this application provides a computer storage medium, including computer instructions. When the computer instructions are run on an electronic device, the electronic device is enabled to perform the floating window management method according to the first aspect.

According to a fourth aspect, this application provides a computer program product. When the computer program product runs on a computer, the computer is enabled to perform the floating window management method according to the first aspect.

According to this application, when displaying a floating window used for a video call, the electronic device may hide the floating window based on a user operation, and the electronic device may further re-invoke the hidden floating window based on a user operation. In addition, in the foregoing process, when the electronic device continuously keeps the video call, the floating window is prevented from blocking a user interface, to improve convenience of the user operation.

### BRIEF DESCRIPTION OF DRAWINGS

FIG. 1A is a schematic diagram of a video call interface according to this application;

FIG. 1B is a schematic diagram of a floating window according to this application:

FIG. 2A is a schematic diagram of a structure of an electronic device according to this application;

FIG. 2B is a block diagram of a software structure of an electronic device according to this application;

FIG. 2C-1 and FIG. 2C-2 are a schematic diagram of working procedures of software and hardware of an electronic device according to this application;

FIG. 3 is a schematic diagram of a video call interface according to an embodiment of this application;

FIG. 4A to FIG. 4F are schematic diagrams of a group of interfaces according to an embodiment of this application;

FIG. 5A to FIG. 5I are schematic diagrams of another group of interfaces according to an embodiment of this application;

FIG. 6A to FIG. 6C are schematic diagrams of another group of interfaces according to an embodiment of this application;

FIG. 7A to FIG. 7G are schematic diagrams of another group of interfaces according to an embodiment of this application;

FIG. 8A to FIG. 8D are schematic diagrams of another group of interfaces according to an embodiment of this application;

FIG. 9A to FIG. 9G are schematic diagrams of another group of interfaces according to an embodiment of this application;

FIG. 10A to FIG. 10F are schematic diagrams of another group of interfaces according to an embodiment of this application:

FIG. 11A to FIG. 11D are schematic diagrams of another group of interfaces according to an embodiment of this application:

FIG. 12A to FIG. 12F are schematic diagrams of another group of interfaces according to an embodiment of this application;

FIG. 13A and FIG. 13B are schematic diagrams of another group of interfaces according to an embodiment of this application;

FIG. 14A to FIG. 14F are schematic diagrams of another group of interfaces according to an embodiment of this application;

FIG. 15 is a schematic diagram of a button of an electronic device according to an embodiment of this application;

FIG. 16 is a schematic diagram of a gesture of a user according to an embodiment of this application;

FIG. 17A and FIG. 17B are schematic diagrams of another group of interfaces according to an embodiment of this application;

FIG. 18A to FIG. 18G are schematic diagrams of another group of interfaces according to an embodiment of this application:

FIG. 19A to FIG. 19F are schematic diagrams of another group of interfaces according to an embodiment of this application;

FIG. 20A to FIG. 20H are schematic diagrams of another group of interfaces according to an embodiment of this application;

FIG. 21A to FIG. 21C are schematic diagrams of a group of notch screens and a hole-punch display according to an embodiment of this application:

FIG. 22A to FIG. 22K are schematic diagrams of another group of interfaces according to an embodiment of this application;

FIG. 23A is a schematic diagram of a foldable screen according to an embodiment of this application;

FIG. 23B is a schematic diagram of a hole-punch display according to an embodiment of this application:

FIG. 24A to FIG. 24H are schematic diagrams of another group of interfaces according to an embodiment of this application;

FIG. 25A to FIG. 25C are schematic diagrams of another group of interfaces according to an embodiment of this application;

FIG. 26A to FIG. 26C are schematic diagrams of another group of interfaces according to an embodiment of this application;

FIG. 27A to FIG. 27C are schematic diagrams of another group of interfaces according to an embodiment of this application;

FIG. 28A to FIG. 28C are schematic diagrams of another group of interfaces according to an embodiment of this application,

FIG. 29A to FIG. 29C are schematic diagrams of another group of interfaces according to an embodiment of this application, and

FIG. 30A to FIG. 30C are schematic diagrams of another group of interfaces according to an embodiment of this application.

### DESCRIPTION OF EMBODIMENTS

The following clearly describes technical solutions in the embodiments of this application in detail with reference to accompanying drawings. In descriptions of the embodiments of this application, unless otherwise stated, “/” indicates “or”. For example, A/B may indicate A or B. The term “and/or” in this specification merely describes an association relationship for describing associated objects, and indicates that three relationships may exist. For example, A and/or B may indicate the following three cases: Only A exists, both A and B exist, and only B exists. In addition, in the descriptions of the embodiments of this application, “a plurality of” means two or more.

The terms “first” and “second” mentioned below are merely intended for description, and shall not be understood as an indication or implication of relative importance or implicit indication of a quantity of indicated technical features. Therefore, a feature limited by “first” or “second” may explicitly or implicitly include one or more features. In the descriptions of the embodiments of this application, unless otherwise specified, “a plurality of” means two or more.

The following first describes an electronic device in the embodiments of this application. A type of the described electronic device is not specifically limited in this application. The electronic device may be a portable electronic device such as a mobile phone, a tablet computer, a personal digital assistant (personal digital assistant, PDA), a wearable device, or a laptop (laptop). An example embodiment of the portable electronic device includes but is not limited to a portable electronic device using iOS, Android, Microsoft, or another operating system. The portable electronic device may alternatively be another portable electronic device, for example, a laptop (laptop) with a touch-sensitive surface (for example, a touch panel). It should be further understood that, in some other embodiments of this application, the electronic device may alternatively be not a portable electronic device, but a desktop computer with a touch-sensitive surface (for example, a touch panel) or a smart television.

In this application, a display is disposed on the electronic device, and may be configured to display interface content currently output by a system of the electronic device. The interface content may include an interface of a running application, a system-level menu, and the like, and may specifically include the following interface elements: input interface elements, for example, a button (button), a text (text) input box, a scroll bar (scroll Bar), a menu (menu), and the like, and output interface elements, for example, a window (window) and a label (label).

In this application, the display may be configured to display both a first user interface and a floating window.

In a possible implementation, the floating window is stacked on the first user interface. Herein, when the display displays the first user interface and the floating window in a stacked manner, the floating window may be transparent. To be specific, a user may see some content in the first user interface in an area in which the floating window is located. The floating window may alternatively be opaque. To be specific, the user cannot see content in the first user interface in the area in which the floating window is located.

In another possible implementation, when the display displays the first user interface, an area in which the floating window is located on the display is not used to display the first user interface, but is used to display the floating window. In this implementation, when the display displays the floating window, the display may display a scaled-down first user interface, and the floating window does not block the first user interface.

In this application, a touch panel is disposed on the display of the electronic device. In other words, the display is a touchscreen, and may be configured to receive a touch operation of the user. The touch operation is an operation that the user directly contacts the display by using a body part or a stylus. In some optional embodiments, the touchscreen may be further configured to receive a floating touch operation of the user. The floating touch operation is an operation that a hand of the user is floated above the display and is not in contact with the display.

In some optional embodiments of this application, the touchscreen of the electronic device may receive a user operation used to trigger the electronic device to hide the floating window.

In some optional embodiments of this application, the touchscreen of the electronic device may further receive a user operation used to trigger the electronic device to invoke the hidden floating window.

In some optional embodiments of this application, the touchscreen of the electronic device may further receive a user operation used to trigger the electronic device to invoke the hidden floating window and display, in full screen mode, an application interface corresponding to the floating window.

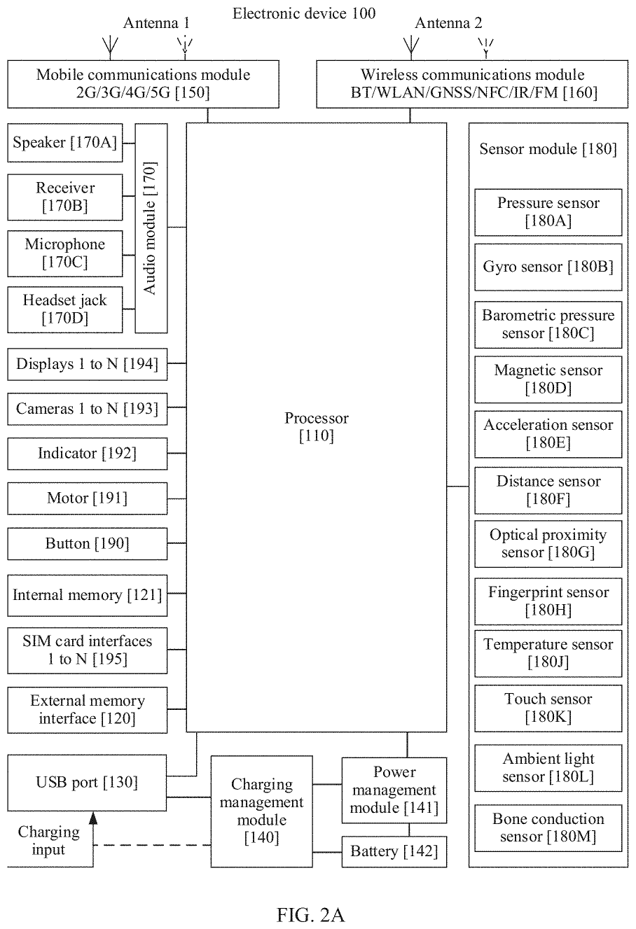

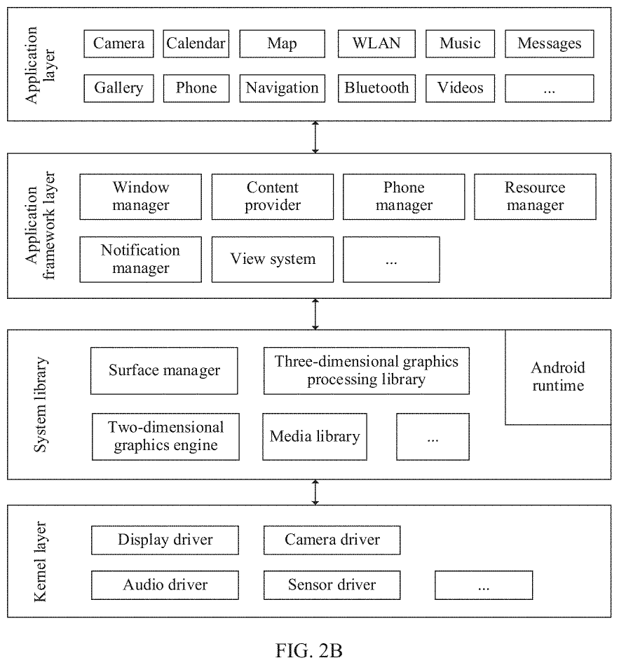

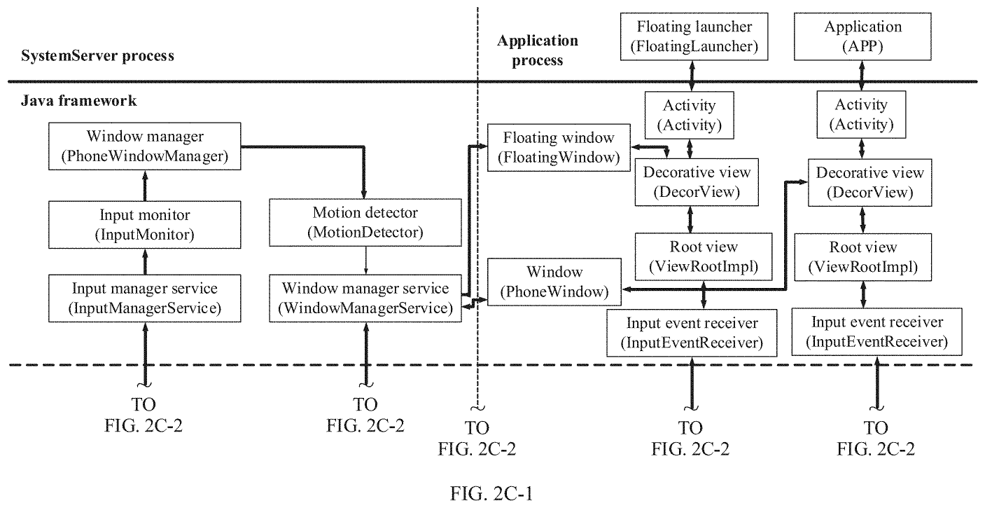

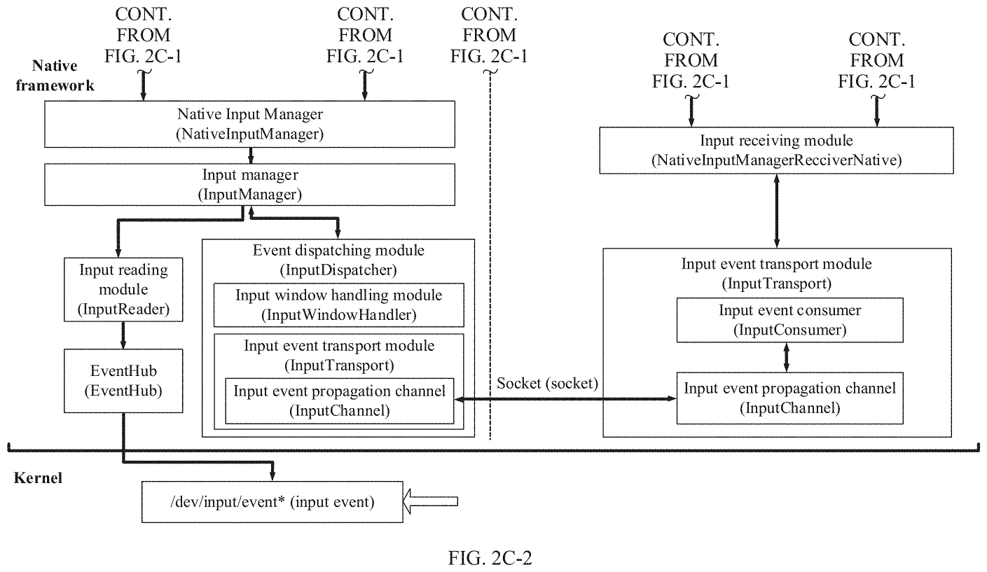

FIG. 2A is a schematic diagram of a structure of an example electronic device 100 according to an embodiment of this application.

The electronic device 100 may include a processor 110, an external memory interface 120, an internal memory 121, a universal serial bus (universal serial bus, USB) port 130, a charging management module 140, a power management module 141, a battery 142, an antenna 1, an antenna 2, a mobile communications module 150, a wireless communications module 160, an audio module 170, a speaker 170A, a receiver 170B, a microphone 170C, a headset jack 170D, a sensor module 180, a button 190, a motor 191, an indicator 192, a camera 193, a display 194, a subscriber identification module (subscriber identification module, SIM) card interface 195, and the like. The sensor module 180 may include a pressure sensor 180A, a gyro sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that the structure shown in this embodiment of this application does not constitute a specific limitation on the electronic device 100. In some other embodiments of this application, the electronic device 100 may include more or fewer components than those shown in the figure, or combine some components, or split some components, or may have different component arrangements. The components shown in the figure may be implemented by using hardware, software, or a combination of software and hardware.

The processor 110 may include one or more processing units. For example, the processor 110 may include an application processor (application processor, AP), a modem processor, a graphics processing unit (graphics processing unit, GPU), an image signal processor (image signal processor, ISP), a controller, a memory, a video codec, a digital signal processor (digital signal processor, DSP), a baseband processor, and/or a neural-network processing unit (neural-network processing unit, NPU). Different processing units may be independent devices, or may be integrated into one or more processors.

The controller may be a nerve center and a command center of the electronic device 100. The controller may generate an operation control signal based on an instruction operation code and a time sequence signal, to complete control of instruction fetching and instruction execution.

A memory may be further disposed in the processor 110, and is configured to store instructions and data. In some embodiments, the memory in the processor 110 is a cache. The memory may store instructions or data just used or cyclically used by the processor 110. If the processor 110 needs to use the instructions or the data again, the processor 110 may directly invoke the instructions or the data from the memory. This avoids repeated access and reduces a waiting time of the processor 110, so that system efficiency is improved.

In some embodiments, the processor 110 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identification module (subscriber identification module, SIM) interface, a universal serial bus (universal serial bus, USB) port, and/or the like.

The I2C interface is a two-way synchronization serial bus, and includes a serial data line (serial data line, SDA) and a serial clock line (serial clock line, SCL). In some embodiments, the processor 110 may include a plurality of groups of I2S buses. The processor 110 may be separately coupled to the touch sensor 180K, a charger, a flashlight, the camera 193, and the like through different I2C bus interfaces. For example, the processor 110 may be coupled to the touch sensor 180K through the I2C interface, so that the processor 110 communicates with the touch sensor 180K through the I2C bus interface, to implement a touch function of the electronic device 100.

The I2S interface may be configured to perform audio communication. In some embodiments, the processor 110 may include a plurality of groups of I2S buses. The processor 110 may be coupled to the audio module 170 through the I2S bus, to implement communication between the processor 110 and the audio module 170. In some embodiments, the audio module 170 may transmit an audio signal to the wireless communications module 160 through the I2S interface, to implement a function of answering a call by using a Bluetooth headset.

The PCM interface may also be configured to: perform audio communication, and sample, quantize, and code an analog signal. In some embodiments, the audio module 170 may be coupled to the wireless communications module 160 through a PCM bus interface. In some embodiments, the audio module 170 may alternatively transmit an audio signal to the wireless communications module 160 through the PCM interface, to implement a function of answering a call by using a Bluetooth headset. Both the I2S interface and the PCM interface may be configured to perform audio communication.

The UART interface is a universal serial data bus, and is configured to perform asynchronous communication. The bus may be a two-way communications bus, the bus converts to-be-transmitted data between serial communication and parallel communication. In some embodiments, the UART interface is usually configured to connect the processor 110 to the wireless communications module 160. For example, the processor 110 communicates with a Bluetooth module in the wireless communications module 160 through the UART interface, to implement a Bluetooth function. In some embodiments, the audio module 170 may transmit an audio signal to the wireless communications module 160 through the UART interface, to implement a function of playing music by using a Bluetooth headset.

The MIPI interface may be configured to connect the processor 110 to a peripheral component such as the display 194 or the camera 193. The MIPI interface includes a camera serial interface (camera serial interface. CSI), a display serial interface (display serial interface, DSI), and the like. In some embodiments, the processor 110 communicates with the camera 193 through the CSI interface, to implement a photographing function of the electronic device 100. The processor 110 communicates with the display 194 through the DSI interface, to implement a display function of the electronic device 100.

The GPIO interface may be configured by using software. The GPIO interface may be configured as a control signal or a data signal. In some embodiments, the GPIO interface may be configured to connect the processor 110 to the camera 193, the display 194, the wireless communications module 160, the audio module 170, the sensor module 180, or the like. The GPIO interface may alternatively be configured as an I2C interface, an I2S interface, a UART interface, an MIPI interface, or the like.

The USB port 130 is a port that conforms to a USB standard specification, and may be specifically a mini USB port, a micro USB port, a USB Type-C port, or the like. The USB port 130 may be configured to connect to a charger for charging the electronic device 100, may be configured to transmit data between the electronic device 100 and a peripheral device, or may be configured to connect to a headset for playing audio through the headset. Alternatively, the port may be configured to connect to another electronic device, for example, an AR device.

It can be understood that an interface connection relationship between the modules in this embodiment of this application is merely an example for description, and does not constitute a limitation on the structure of the electronic device 100. In some other embodiments of this application, the electronic device 100 may alternatively use an interface connection manner different from an interface connection manner in this embodiment, or a combination of a plurality of interface connection manners.

The charging management module 140 is configured to receive a charging input from the charger. The charger may be a wireless charger or a wired charger. In some embodiments in which wired charging is used, the charging management module 140 may receive a charging input from the wired charger through the USB port 130. In some embodiments in which wireless charging is used, the charging management module 140 may receive a wireless charging input through a wireless charging coil of the electronic device 100. The charging management module 140 may further supply power to the electronic device by using the power management module 141 when the battery 142 is charged.

The power management module 141 is configured to connect the battery 142 and the charging management module 140 to the processor 110. The power management module 141 receives an input of the battery 142 and/or the charging management module 140, and supplies power to the processor 110, the internal memory 121, an external memory, the display 194, the camera 193, the wireless communications module 160, and the like. The power management module 141 may be further configured to monitor parameters such as a battery capacity, a battery cycle count, and a battery health status (electric leakage or impedance). In some other embodiments, the power management module 141 may alternatively be disposed in the processor 110. In some other embodiments, the power management module 141 and the charging management module 140 may alternatively be disposed in a same device.

A wireless communication function of the electronic device 100 may be implemented through the antenna 1, the antenna 2, the mobile communications module 150, the wireless communications module 160, the modem processor, the baseband processor, and the like.

The antenna 1 and the antenna 2 are configured to: transmit and receive electromagnetic wave signals. Each antenna in the electronic device 100 may be configured to cover one or more communication frequency bands. Different antennas may be further multiplexed, to improve antenna utilization. For example, the antenna 1 may be multiplexed as a diversity antenna in a wireless local area network. In some other embodiments, the antenna may be used in combination with a tuning switch.

The mobile communications module 150 may provide a wireless communication solution that includes 2G/3G/4G/5G or the like and that is applied to the electronic device 100. The mobile communications module 150 may include at least one filter, a switch, a power amplifier, a low noise amplifier (low noise amplifier. LNA), and the like. The mobile communications module 150 may receive an electromagnetic wave through the antenna 1, perform processing such as filtering or amplification on the received electromagnetic wave, and transmit a processed electromagnetic wave to the modem processor for demodulation. The mobile communications module 150 may further amplify a signal modulated by the modem processor, and convert the signal into an electromagnetic wave through the antenna 1 for radiation. In some embodiments, at least some functional modules in the mobile communications module 150 may be disposed in the processor 110. In some embodiments, at least some functional modules in the mobile communications module 150 may be disposed in a same device as at least some modules in the processor 110.

The modem processor may include a modulator and a demodulator. The modulator is configured to modulate a to-be-sent low-frequency baseband signal into a medium or high-frequency signal. The demodulator is configured to demodulate a received electromagnetic wave signal into a low-frequency baseband signal. Then, the demodulator transfers the low-frequency baseband signal obtained through demodulation to the baseband processor for processing. The baseband processor processes the low-frequency baseband signal, and then transfers a processed signal to the application processor. The application processor outputs a sound signal by using an audio device (which is not limited to the speaker 170A, the receiver 170B, or the like), or displays an image or a video through the display 194. In some embodiments, the modem processor may be an independent device. In some other embodiments, the modem processor may be independent of the processor 110, and is disposed in a same device as the mobile communications module 150 or another functional module.

The wireless communications module 160 may provide a wireless communication solution that includes a wireless local area network (wireless local area network, WLAN) (for example, a wireless fidelity (wireless fidelity, Wi-Fi) network), Bluetooth (Bluetooth, BT), a global navigation satellite system (global navigation satellite system. GNSS), frequency modulation (frequency modulation, FM), near field communication (near field communication, NFC), an infrared (infrared, IR) technology, or the like and that is applied to the electronic device 100. The wireless communications module 160 may be one or more devices that integrate at least one communications processor module. The wireless communications module 160 receives an electromagnetic wave through the antenna 2, performs frequency modulation and filtering processing on the electromagnetic wave signal, and sends a processed signal to the processor 110. The wireless communications module 160 may further receive a to-be-sent signal from the processor 110, perform frequency modulation and amplification on the signal, and convert a processed signal into an electromagnetic wave through the antenna 2 for radiation.

In some embodiments, the antenna 1 and the mobile communications module 150 in the electronic device 100 are coupled, and the antenna 2 and the wireless communications module 160 in the electronic device 100 are coupled, so that the electronic device 100 can communicate with a network and another device by using a wireless communications technology. The wireless communications technology may include a global system for mobile communications (global system for mobile communications, GSM), a general packet radio service (general packet radio service, GPRS), code division multiple access (code division multiple access, CDMA), wideband code division multiple access (wideband code division multiple access, WCDMA), time-division code division multiple access (time-division code division multiple access, TD-CDMA), long term evolution (long term evolution, LTE), BT, a GNSS, a WLAN, NFC, FM, an IR technology, and/or the like. The GNSS may include a global positioning system (global positioning system, GPS), a global navigation satellite system (global navigation satellite system. GLONASS), a BeiDou navigation satellite system (BeiDou navigation satellite system, BDS), a quasi-zenith satellite system (quasi-zenith satellite system, QZSS), and/or satellite based augmentation systems (satellite based augmentation systems, SBAS).

The electronic device 100 implements a display function by using the GPU, the display 194, the application processor, and the like. The GPU is a microprocessor for image processing, and connects the display 194 to the application processor. The GPU is configured to: perform mathematical and geometric calculation, and render an image. The processor 110 may include one or more GPUs that execute program instructions to generate or change display information.

The display 194 is configured to display an image, a video, and the like. The display 194 includes a display panel. The display panel may be a liquid crystal display (liquid crystal display, LCD), an organic light-emitting diode (organic light-emitting diode, OLED), an active-matrix organic light emitting diode (active-matrix organic light emitting diode, AMOLED), a flexible light-emitting diode (flexible light-emitting diode, FLED), a mini-LED, a micro-LED, a micro-OLED, quantum dot light emitting diodes (quantum dot light emitting diodes, QLED), or the like. In some embodiments, the electronic device 100 may include one or N displays 194, where N is a positive integer greater than 1.

In some embodiments of this application, the display 194 displays interface content currently output by a system. For example, the interface content is an interface provided by an instant messaging application.

The electronic device 100 may implement a photographing function through the ISP, the camera 193, the video codec, the GPU, the display 194, the application processor, and the like.

The ISP is configured to process data fed back by the camera 193. For example, during photographing, a shutter is pressed, light is transmitted to a photosensitive element of the camera through a lens, an optical signal is converted into an electrical signal, and the photosensitive element of the camera transmits the electrical signal to the ISP for processing, to convert the electrical signal into a visible image. The ISP may further perform algorithm optimization on noise, brightness, and complexion of the image. The ISP may further optimize parameters such as exposure and a color temperature of a photographing scenario. In some embodiments, the ISP may be disposed in the camera 193.

The camera 193 is configured to capture a static image or a video. An optical image of an object is generated through the lens, and is projected onto the photosensitive element. The photosensitive element may be a charge coupled device (charge coupled device, CCD) or a complementary metal-oxide-semiconductor (complementary metal-oxide-semiconductor, CMOS) phototransistor. The photosensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format such as an RGB format or a YUV format. In some embodiments, the electronic device 100 may include one or N cameras 193, where N is a positive integer greater than 1.

The digital signal processor is configured to process a digital signal, and may process another digital signal in addition to the digital image signal. For example, when the electronic device 100 selects a frequency, the digital signal processor is configured to perform Fourier transform on frequency energy and the like.

The video codec is configured to: compress or decompress a digital video. The electronic device 100 may support one or more video codecs. Therefore, the electronic device 100 may play or record videos in a plurality of coding formats, for example, moving picture experts group (moving picture experts group, MPEG)-1, MPEG-2, MPEG-3, and MPEG-4.

The NPU is a neural-network (neural-network, NN) computing processor. The NPU quickly processes input information by referring to a structure of a biological neural network, for example, a transfer mode between human brain neurons, and may further continuously perform self-learning. The NPU can implement applications such as intelligent cognition of the electronic device 100, such as image recognition, facial recognition, speech recognition, and text understanding.

The external memory interface 120 may be configured to connect to an external storage card, for example, a micro SD card, to extend a storage capability of the electronic device 100. The external storage card communicates with the processor 110 through the external memory interface 120, to implement a data storage function. For example, files such as music and a video are stored in the external storage card.

The internal memory 121 may be configured to store computer-executable program code. The executable program code includes instructions. The processor 110 runs the instructions stored in the internal memory 121, to perform various function applications of the electronic device 100 and data processing. The internal memory 121 may include a program storage area and a data storage area. The program storage area may store an operating system, an application required by at least one function (for example, a voice playing function or an image playing function), and the like. The data storage area may store data (for example, audio data and an address book) created in a process of using the electronic device 100, and the like. In addition, the internal memory 121 may include a high-speed random access memory, or may include a nonvolatile memory, for example, at least one magnetic disk storage device, a flash memory, or a universal flash storage (universal flash storage, UFS).

The electronic device 100 may implement audio functions, for example, music playing and recording, by using the audio module 170, the speaker 170A, the receiver 170B, the microphone 170C, the headset jack 170D, the application processor, and the like.

The audio module 170 is configured to convert digital audio information into an analog audio signal output, and is also configured to convert an analog audio input into a digital audio signal. The audio module 170 may be further configured to: code and decode an audio signal. In some embodiments, the audio module 170 may be disposed in the processor 110, or some functional modules of the audio module 170 are disposed in the processor 110.

The speaker 170A, also referred to as a “horn”, is configured to convert an audio electrical signal into a sound signal. The electronic device 100 may be configured to listen to music or answer a call in a hands-free mode over the speaker 170A.

The receiver 170B, also referred to as an “earpiece”, is configured to convert an electrical audio signal into a sound signal. When a call is answered or audio information is listened to by using the electronic device 100, the receiver 170B may be put close to a human ear to listen to a voice.

The microphone 170C, also referred to as a “mike” or a “microphone”, is configured to convert a sound signal into an electrical signal. When making a call or sending voice information, a user may make a sound by moving a human mouth close to the microphone 170C to input a sound signal to the microphone 170C. At least one microphone 170C may be disposed in the electronic device 100. In some other embodiments, two microphones 170C may be disposed in the electronic device 100, to collect a sound signal and implement a noise reduction function. In some other embodiments, three, four, or more microphones 170C may alternatively be disposed in the electronic device 100, to collect a sound signal, implement noise reduction, and identify a sound source, so as to implement a directional recording function and the like.

The headset jack 170D is configured to connect to a wired headset. The headset jack 170D may be the USB port 130, or may be a 3.5 mm open mobile terminal platform (open mobile terminal platform, OMTP) standard interface or a cellular telecommunications industry association of the USA (cellular telecommunications industry association of the USA, CTIA) standard interface.

The pressure sensor 180A is configured to sense a pressure signal, and can convert the pressure signal into an electrical signal. In some embodiments, the pressure sensor 180A may be disposed on the display 194. In some optional embodiments of this application, the pressure sensor 180A may be configured to: capture a pressure value generated when a finger part of the user contacts the display, and transmit the pressure value to the processor, so that the processor identifies a finger part through which the user enters the user operation.

There are a plurality of types of pressure sensors 180A, for example, a resistive pressure sensor, an inductive pressure sensor, a capacitive pressure sensor. The capacitive pressure sensor may include at least two parallel plates made of conductive materials. When a force is applied to the pressure sensor 180A, capacitance between electrodes changes. The electronic device 100 determines pressure intensity based on a capacitance change. When a touch operation is performed on the display 194, the electronic device 100 detects intensity of the touch operation by using the pressure sensor 180A. The electronic device 100 may calculate a touch location based on a detection signal of the pressure sensor 180A. In some embodiments, touch operations that are performed at a same touch location but have different touch operation intensity may correspond to different operation instructions. For example, when a touch operation whose touch operation intensity is less than a first pressure threshold is performed on a Messages icon, an instruction for viewing an SMS message is executed. When a touch operation whose touch operation intensity is greater than or equal to the first pressure threshold is performed on a Messages icon, an instruction for creating an SMS message is executed. In some optional embodiments of this application, the pressure sensor 180A may transmit a detected capacitance value to the processor, so that the processor identifies a finger part (a knuckle, a finger pad, or the like) through which the user enters a user operation. In some optional embodiments of this application, the pressure sensor 180A may further calculate a quantity of touch points based on a detected signal, and transmit a calculated value to the processor, so that the processor identifies that the user enters a user operation through a single finger or a plurality of fingers.

The gyro sensor 180B may be configured to determine a motion posture of the electronic device 100. In some embodiments, an angular velocity of the electronic device 100 around three axes (namely, axes X, Y. and Z) may be determined by using the gyro sensor 180B. The gyro sensor 180B may be configured to perform image stabilization during photographing. For example, when a shutter is pressed, the gyro sensor 180B detects an angle at which the electronic device 100 jitters, calculates, based on the angle, a distance for which a lens module needs to compensate, and allows the lens to cancel the jitter of the electronic device 100 through reverse motion, to implement image stabilization. The gyro sensor 180B may be further used in a navigation scenario and a motion-sensing game scenario.

The barometric pressure sensor 180C is configured to measure barometric pressure. In some embodiments, the electronic device 100 calculates an altitude based on a value of the barometric pressure measured by the barometric pressure sensor 180C, to assist in positioning and navigation.

The magnetic sensor 180D includes a Hall effect sensor. The electronic device 100 may detect opening and closing of a flip cover or a leather case by using the magnetic sensor 180D. In some embodiments, when the electronic device 100 is a clamshell phone, the electronic device 100 may detect opening and closing of a flip cover by using the magnetic sensor 180D. Further, a feature such as automatic unlocking upon opening of the flip cover is set based on a detected opening or closing state of the leather case or a detected opening or closing state of the flip cover.

The acceleration sensor 180E may detect accelerations in various directions (usually on three axes) of the electronic device 100, and may detect magnitude and a direction of gravity when the electronic device 100 is still. The acceleration sensor 180E may be further configured to identify a posture of the electronic device, and is used in an application such as switching between landscape mode and portrait mode or a pedometer. In some optional embodiments of this application, the acceleration sensor 180E may be configured to: capture an acceleration value generated when a finger part of the user contacts the display, and transmit the acceleration value to the processor, so that the processor identifies a finger part through which the user enters the user operation.

The distance sensor 180F is configured to measure a distance. The electronic device 100 may measure the distance in an infrared manner or a laser manner. In some embodiments, in a photographing scenario, the electronic device 100 may measure a distance by using the distance sensor 180F to implement quick focusing.

The optical proximity sensor 180G may include, for example, a light-emitting diode (LED) and an optical detector such as a photodiode. The light-emitting diode may be an infrared light-emitting diode. The electronic device 100 emits infrared light by using the light-emitting diode. The electronic device 100 detects infrared reflected light from a nearby object by using the photodiode. When sufficient reflected light is detected, the electronic device 100 may determine that there is an object near the electronic device 100. When insufficient reflected light is detected, the electronic device 100 may determine that there is no object near the electronic device 100. The electronic device 100 may detect, by using the optical proximity sensor, that the user holds the electronic device 100 close to an ear to make a call, to automatically perform screen-off for power saving. The optical proximity sensor 180G may also be used in a leather case mode or a pocket mode to automatically unlock or lock a screen.

The ambient light sensor 180L is configured to sense ambient light brightness. The electronic device 100 may adaptively adjust brightness of the display 194 based on the sensed ambient light brightness. The ambient light sensor 180L may also be configured to automatically adjust a white balance during photographing. The ambient light sensor 180L may further cooperate with the optical proximity sensor 180G to detect whether the electronic device 100 is in a pocket, to prevent an accidental touch.

The fingerprint sensor 180H is configured to collect a fingerprint. The electronic device 100 may use a feature of the collected fingerprint to implement fingerprint-based unlocking, application lock access, fingerprint-based photographing, fingerprint-based call answering, and the like.

The temperature sensor 180J is configured to detect a temperature. In some embodiments, the electronic device 100 executes a temperature processing policy based on the temperature detected by the temperature sensor 180J. For example, when the temperature reported by the temperature sensor 1803 exceeds a threshold, the electronic device 100 lowers performance of a processor located near the temperature sensor 180J, to reduce power consumption to implement thermal protection. In some other embodiments, when the temperature is less than another threshold, the electronic device 100 heats the battery 142 to prevent the electronic device 100 from being shut down abnormally due to a low temperature. In some other embodiments, when the temperature is less than still another threshold, the electronic device 100 boosts an output voltage of the battery 142, to avoid abnormal shutdown due to a low temperature.

The touch sensor 180K is also referred to as a “touch panel”. The touch sensor 180K may be disposed on the display 194, and the touch sensor 180K and the display 194 form a touchscreen, which is also referred to as a “touchscreen”. The touch sensor 180K is configured to detect a touch operation performed on or near the touch sensor 180K. The touch operation is an operation that the user contacts the display 194 by using a hand, an elbow, a stylus, or the like. The touch sensor may transfer the detected touch operation to the application processor, to determine a type of a touch event. The display 194 may provide a visual output related to the touch operation. In some other embodiments, the touch sensor 180K may alternatively be disposed on a surface of the electronic device 100 at a location different from a location of the display 194.

The bone conduction sensor 180M may obtain a vibration signal. In some embodiments, the bone conduction sensor 180M may obtain a vibration signal of a vibration bone of a human vocal part. The bone conduction sensor 180M may also be in contact with a human pulse, to receive a blood pressure beating signal. In some embodiments, the bone conduction sensor 180M may also be disposed in the headset, to obtain a bone conduction headset. The audio module 170 may obtain a voice signal through parsing based on the vibration signal that is of the vibration bone of the vocal part and that is obtained by the bone conduction sensor 180M, to implement a voice function. The application processor may parse heart rate information based on the blood pressure beating signal obtained by the bone conduction sensor 180M, to implement a heart rate detection function.

The button 190 includes a power button, a volume button, and the like. The button 190 may be a mechanical button, or may be a touch button. The electronic device 100 may receive a key input, and generate a key signal input related to a user setting and function control of the electronic device 100.

The motor 191 may generate a vibration prompt. The motor 191 may be configured to produce an incoming call vibration prompt and a touch vibration feedback. For example, touch operations performed on different applications (for example, photographing and audio playing) may correspond to different vibration feedback effects. The motor 191 may also correspond to different vibration feedback effects for touch operations performed on different areas of the display 194. Different application scenarios (for example, a time reminder scenario, an information receiving scenario, an alarm clock scenario, and a game scenario) may also correspond to different vibration feedback effects. A touch vibration feedback effect may be further customized.

The indicator 192 may be an indicator light, and may be configured to indicate a charging status and a power change, or may be configured to indicate a message, a missed call, a notification, and the like.

The SIM card interface 195 is configured to connect to a SIM card. The SIM card may be inserted into the SIM card interface 195 or removed from the SIM card interface 195, to implement contact with or separation from the electronic device 100. The electronic device 100 may support one or N SIM card interfaces, where N is a positive integer greater than 1. The SIM card interface 195 may support a nano-SIM card, a micro-SIM card, a SIM card, and the like. A plurality of cards may be simultaneously inserted into a same SIM card interface 195. The plurality of cards may be of a same type or of different types. The SIM card interface 195 may be compatible with different types of SIM cards. The SIM card interface 195 may also be compatible with an external storage card. The electronic device 100 interacts with a network through the SIM card, to implement functions such as calling and data communication. In some embodiments, the electronic device 100 uses an eSIM, namely, an embedded SIM card. The eSIM card may be embedded into the electronic device 100 and cannot be separated from the electronic device 100.

A software system of the electronic device 100 may use a layered architecture, an event-driven architecture, a microkernel architecture, a micro service architecture, or a cloud architecture. In an embodiment of this application, an Android system with a layered architecture is used as an example to describe a software structure of the electronic device 100.

FIG. 2B is a block diagram of the software structure of the electronic device 100 according to an embodiment of this application.

In the layered architecture, software is divided into several layers, and each layer has a clear role and task. The layers communicate with each other through a software interface. In some embodiments, the Android system is divided into four layers, that is, an application layer, an application framework layer, an Android runtime (Android runtime) and system library, and a kernel layer from top to bottom.

The application layer may include a series of application packages.

As shown in FIG. 2B, the application package may include applications such as Camera, Gallery, Calendar, Phone, Map. Navigation, WLAN, Bluetooth, Music, Videos, and Messages.

In this application, a floating launcher (floating launcher) may be further added to the application layer, is used as a default display application in the foregoing floating window, and is provided for the user to enter another application.

The application framework layer provides an application programming interface (application programming interface, API) and a programming framework for an application at the application layer. The application framework layer includes some predefined functions.

As shown in FIG. 2B, the application framework layer may include a window manager (window manager), a content provider, a view system, a phone manager, a resource manager, a notification manager, an activity manager (activity manager), and the like.

The window manager is configured to manage a window program. The window manager may obtain a size of the display, determine whether there is a status bar, lock the display, take a screenshot of the display, and the like. In this application, FloatingWindow may be extended based on native PhoneWindow of Android, and is dedicated to displaying the foregoing floating window, so as to distinguish the floating window from a common window. The window has an attribute of being displayed on a top layer of a series of windows in a floating manner. In some optional embodiments, a proper value of a size of the window may be given based on an actual size of a screen according to an optimal display algorithm. In some possible embodiments, an aspect ratio of the window may be considered as an aspect ratio of a screen of a conventional mainstream mobile phone by default. In addition, to help the user close and hide the floating window, an extra close button and an extra minimize button may be drawn in an upper right corner.

The content provider is configured to: store and obtain data, and enable the data to be accessed by an application. The data may include a video, an image, audio, calls that are made and received, a browsing history and bookmarks, an address book, and the like.

The view system includes visual controls, such as a control for displaying a text and a control for displaying a picture. The view system may be configured to construct an application. A display interface may include one or more views. For example, a display interface including an SMS message notification icon may include a text display view and a picture display view. In this application, a key view used for operations such as closing and minimization may be correspondingly added to the floating window, and bound to FloatingWindow in the window manager.

The phone manager is configured to provide a communication function of the electronic device 100, for example, management of a call status (including answering or declining a call).

The resource manager provides various resources for an application, such as a localized character string, an icon, a picture, a layout file, and a video file.

The notification manager enables an application to display notification information in a status bar 207, and may be configured to convey a notification message. The notification message may automatically disappear after a short pause without user interaction. For example, the notification manager is configured to provide notifications of download completing, a message prompt, and the like. The notification manager may alternatively be a notification that appears in a top status bar of the system in a form of a graph or a scroll bar text, for example, a notification of an application running in the background, or may be a notification that appears on the display in a form of a dialog window. For example, text information is displayed in the status bar, an alert sound is played, the electronic device vibrates, or the indicator light blinks.

The activity manager is configured to manage activities that are running in the system, including a process (process), an application, a service (service), task (task) information, and the like. In this application, an activity task stack dedicated to managing an activity of an application displayed in the floating window may be newly added to the activity manager module, to ensure that the activity and a task of the application in the floating window do not conflict with an application displayed on the screen in full screen mode.

In this application, a motion detector (motion detector) may be further added to the application framework layer, to perform logical determining on an obtained input event and identify a type of the input event. For example, the motion detector determines, based on information such as touch coordinates and a timestamp of a touch operation included in the input event, that the input event is a knuckle touch event, a finger pad touch event, or the like. In addition, the motion detector may further record a track of the input event, determine a gesture rule of the input event, and respond to different operations based on different gestures.

The Android runtime includes a core library and a virtual machine. The Android runtime is responsible for scheduling and management of the Android system.

The core library includes two parts: a function that needs to be invoked in Java language and a core library of Android.

The application layer and the application framework layer run on the virtual machine. The virtual machine executes Java files at the application layer and the application framework layer as binary files. The virtual machine is configured to implement functions such as object lifecycle management, stack management, thread management, security and exception management, and garbage collection.

The system library may include a plurality of functional modules, for example, an input manager (input manager), an input dispatcher (input dispatcher), a surface manager (surface manager), a media library (Media Library), a three-dimensional graphics processing library (for example, OpenGL ES), and a 2D graphics engine (for example, SGL).

The input manager is responsible for obtaining event data from an underlying input driver, parsing and encapsulating the event data, and sending the event data to the input dispatcher.

The input dispatcher is configured to store window information. After receiving an input event from the input manager, the input dispatcher searches windows stored by the input dispatcher for a proper window, and dispatches the event to the window.

The surface manager is configured to: manage a display subsystem and provide fusion of 2D and 3D layers for a plurality of applications.

The media library supports playing and recording of a plurality of frequently used audio and video formats, static image files, and the like. The media library may support a plurality of audio and video coding formats, for example, MPEG-4, H.264, MP3, AAC, AMR. JPG, and PNG.

The three-dimensional graphics processing library is configured to implement three-dimensional graphics drawing, image rendering, composition, layer processing, and the like.

The 2D graphics engine is a drawing engine for 2D drawing.

The kernel layer is a layer between hardware and software. The kernel layer includes at least a display driver, a camera driver, an audio driver, and a sensor driver.

The following describes examples of working procedures of software and hardware of the electronic device 100 with reference to a photographing scenario.

When the touch sensor 180K receives a touch operation, a corresponding hardware interruption is sent to the kernel layer. The kernel layer processes the touch operation into an original input event (including information such as touch coordinates and a timestamp of the touch operation). The original input event is stored at the kernel layer. The application framework layer obtains the original input event from the kernel layer, and identifies a control corresponding to the input event. For example, the touch operation is a single-tap touch operation and a control corresponding to the single-tap operation is a control of a camera application icon. A camera application invokes an interface at the application framework layer, so that the camera application is opened. Then, a camera driver is started by invoking the kernel layer, and a static image or a video is captured by using the camera 193.

The following describes examples of working procedures of software and hardware of the electronic device 100 with reference to a floating window management method in this application.

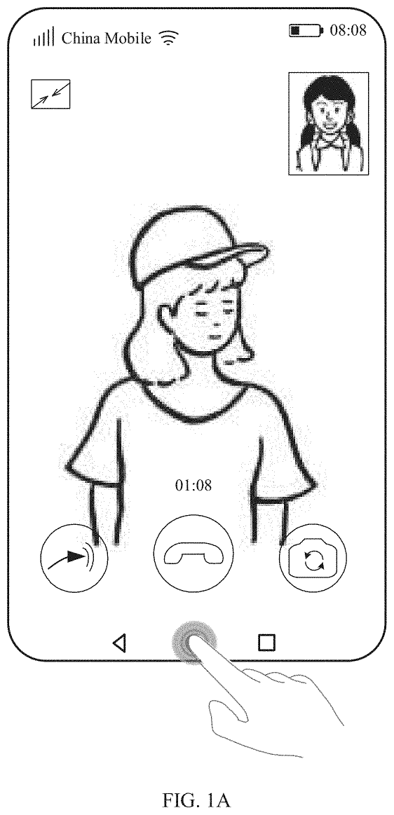

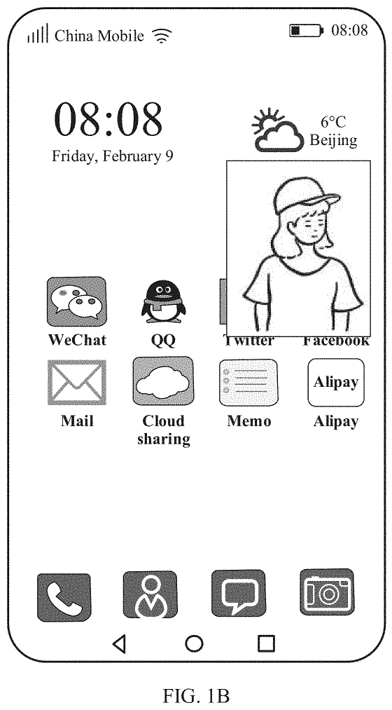

Refer to FIG. 2C-1 and FIG. 2C-2. A kernel, a Native framework, a Java framework, a SystemServer process, and an application process in FIG. 2C-1 and FIG. 2C-2 respectively correspond to the kernel layer, the system library, the application framework layer, and the application layer in FIG. 2B.

When the touch sensor 180K receives a touch operation, a corresponding hardware interruption is sent to the kernel layer. The kernel layer processes the touch operation into an original input event, that is, /dev/input/event* in FIG. 2C-2. The original input time includes information such as touch coordinates and a timestamp of the touch operation.

The original input event is stored at the kernel layer. The input manager (input manager) of the system library obtains an original input event from the kernel layer, parses and encapsulates the original input event, and sends the original input event to the input dispatcher (input dispatcher). After receiving an input event from the input manager, the input dispatcher dispatches the input event to a proper window.

The motion detector (motion detector) at the application framework layer obtains the encapsulated input event from the input manager and performs logical determining on the event. For example, the touch operation received by the touch sensor 180K is that a finger of the user slides on the display to drag the floating window to an area in which the status bar is located. The motion detector may determine, based on a pressure value of the display, a capacitance value, touch coordinates, a location of the floating window, and the like in the input event, that the input event is that the user drags the floating window to the area in which the status bar is located. If a logical determining result conforms to a gesture of hiding the floating window, a launcher of hiding the floating window is invoked to stop displaying the floating window on interface content currently output on the display.

A video call scenario is used as an example. The following first describes some user interfaces in a video call scenario implemented on the electronic device 100 according to an embodiment of this application.

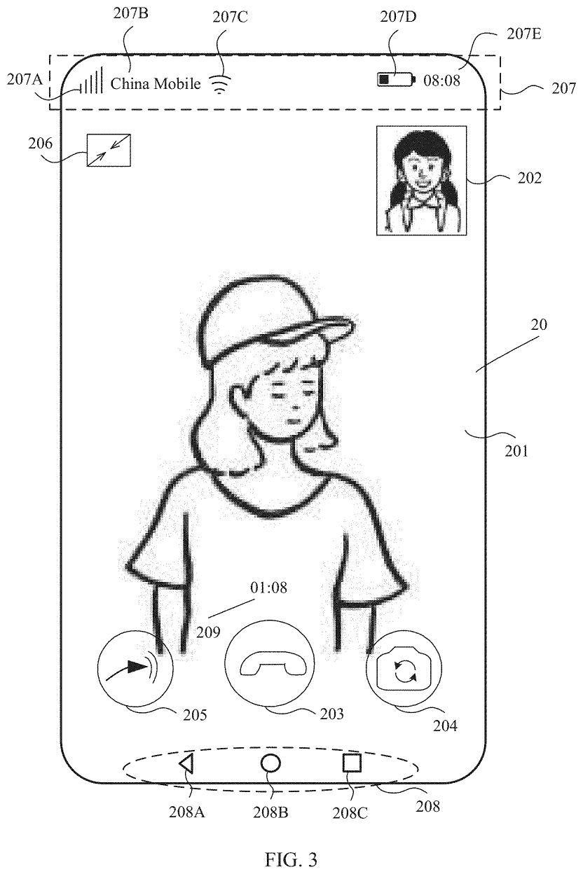

For example, as shown in FIG. 3, the display 194 of the electronic device 100 displays interface content 20 currently output by the system, and the interface content 20 is a video call interface. In this application, a touch panel is disposed on the display 194, and may be configured to receive a touch operation of the user. The touch operation is an operation that the user contacts the display 194 by using a hand, an elbow, a stylus, or the like.

FIG. 3 shows a user interface used for a video call. The user interface is a video call interface provided by WeChat. In addition, the user interface may alternatively be an interface provided by another application for a video call, and the another application may be, for example, instant messaging software such as QQ, FaceTime of Apple, or MSN.

As shown in FIG. 3, a user interface 20 used for a video call may include a video display area 201, a window switching control 202, a hang-up control 203, a camera switching control 204, a voice switching control 205, a window scale-down control 206, a status bar 207, a navigation bar 208, and a call duration indicator 209. An electronic device used by a local user is the electronic device 100.

The video display area 201 is configured to display an image collected by a camera of an electronic device (or the electronic device 100) of a video contact.

The window switching control 202 is configured to display an image collected by a camera of the electronic device 100 (or the electronic device of the video contact), and may also be configured to switch a video window. When the electronic device 100 may detect a touch operation performed on the window switching control 202 (for example, a tap operation on the window switching control 202), in response to the operation, the electronic device 100 may switch an image displayed in the video display area 201 and an image displayed in the window switching control 202.

For example, if the video display area 201 displays the image collected by the camera of the electronic device of the video contact, the window switching control 202 displays the image collected by the camera 193 of the electronic device 100. After the electronic device 100 detects the touch operation performed on the window switching control 202, in response to the operation, the electronic device 100 switches content displayed in the video display area 201 to the image collected by the camera 193 of the electronic device 100, and simultaneously switches content displayed in the window switching control 202 to the image collected by the camera of the electronic device of the video contact.

Conversely, if the video display area 201 displays the image collected by the camera 193 of the electronic device 100, the window switching control 202 displays the image collected by the camera of the electronic device of the video contact. After the electronic device 100 detects the touch operation performed on the window switching control 202, in response to the operation, the electronic device 100 switches content displayed in the video display area 201 to the image collected by the camera of the electronic device of the video contact, and simultaneously switches content displayed in the window switching control 202 to the image collected by the camera 193 of the electronic device 100.

The hang-up control 203 is configured to disconnect the video call. When the electronic device 100 may detect a touch operation performed on the hang-up control 203 (for example, a tap operation on the hang-up control 203), the electronic device 100 may disconnect the video call in response to the operation.

The camera switching control 204 is configured to switch between cameras. When the electronic device 100 may detect a touch operation performed on the camera switching control 204 (for example, a tap operation on the camera switching control 204), the electronic device 100 may switch between cameras in response to the operation. For example, the camera of the electronic device 100 is switched from a front-facing camera to a rear-facing camera, or the camera of the electronic device 100 is switched from a rear-facing camera to a front-facing camera.

The voice switching control 205 is configured to switch the video call to a voice call. When the electronic device 100 may detect a touch operation performed on the voice switching control 205 (for example, a tap operation on the voice switching control 205), in response to the operation, the electronic device 100 may switch the video call to a voice call, and turn off the camera 193.

The window scale-down control 206 is configured to scale down a window. When the electronic device 100 may detect a touch operation performed on the window scale-down control 206 (for example, a tap operation on the window scale-down control 206), in response to the operation, the electronic device 100 may scale down a current video window to obtain a floating window, display the floating window at a preset location on the display, and display, in the scaled-down window, the image collected by the camera of the electronic device of the video contact.

The floating window is used to display the image collected by the camera of the electronic device 100 (and/or the electronic device of the video contact), and may also be used to switch a current user interface to a video call interface. When the electronic device 100 may detect a touch operation performed on the floating window (for example, a tap operation on the floating window), in response to the operation, the electronic device 100 may scale up the floating window to obtain the video call interface.

The status bar 207 may include one or more signal strength indicators 207A of a mobile communications signal (also referred to as a cellular signal), an operator name (for example, “China Mobile”) 207B, one or more signal strength indicators 207C of a wireless fidelity (wireless fidelity, Wi-Fi) signal, a battery status indicator 207D, and a time indicator 207E.

The navigation bar 208 may include system navigation buttons such as a return button 208A, a home screen (Home screen) button 208B, and a historical call-out task button 208C. A home screen is an interface displayed by the electronic device 100 after a user operation performed on the home screen button 208B is detected in any user interface. When the electronic device 100 detects a touch operation performed on the return button 208A, the electronic device 100 may display a previous user interface of a current user interface. When the electronic device 100 detects a touch operation performed on the home screen button 208B, the electronic device 100 may display the home screen. When the electronic device 100 detects a touch operation performed on the historical call-out task button 208C, the electronic device 100 may display a task last opened by the user. Each navigation button may have another name. For example, 208A may be referred to as a back button, 208B may be referred to as a home button, and 208C may be referred to as a menu button. This is not limited in this application. The navigation buttons in the navigation bar 208 are not limited to virtual buttons, and may also be implemented as physical buttons. In some possible embodiments, the system navigation buttons such as the return button 208A, the home screen (Home screen) button 208B, or the historical call-out task button 208C may also be referred to as a second control.

The call duration indicator 209 is used to indicate duration of a current video call.

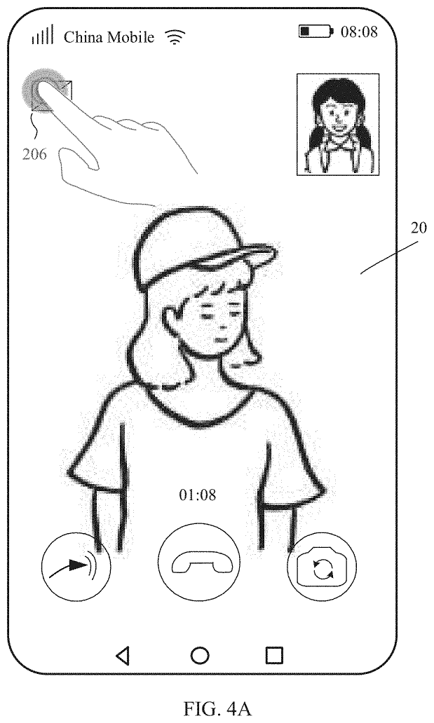

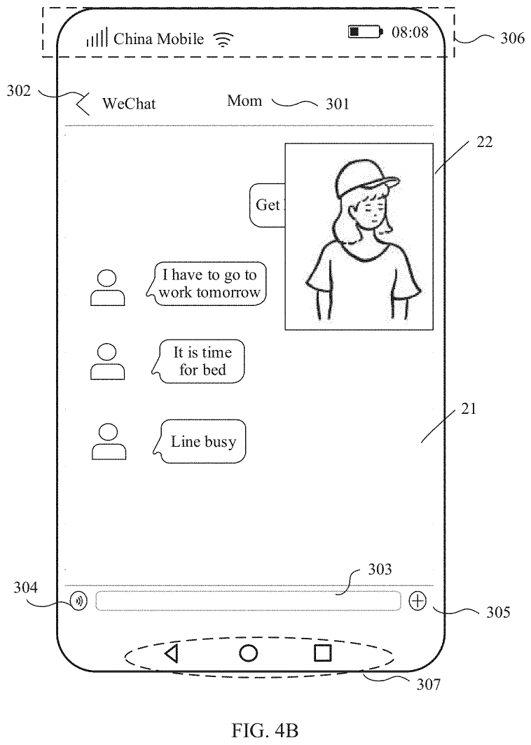

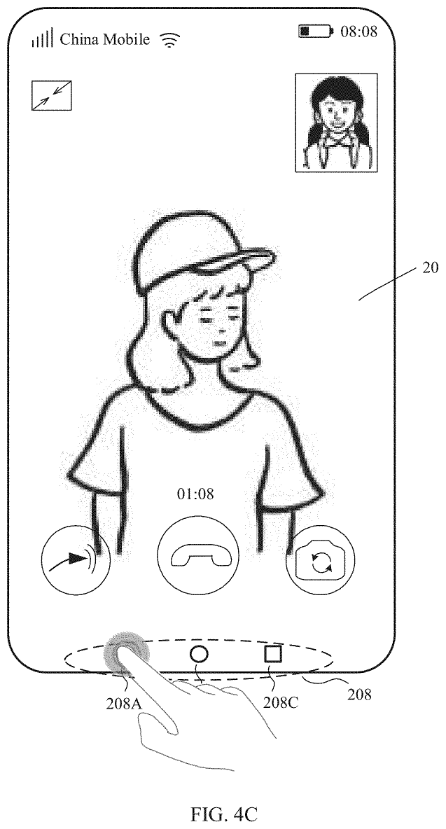

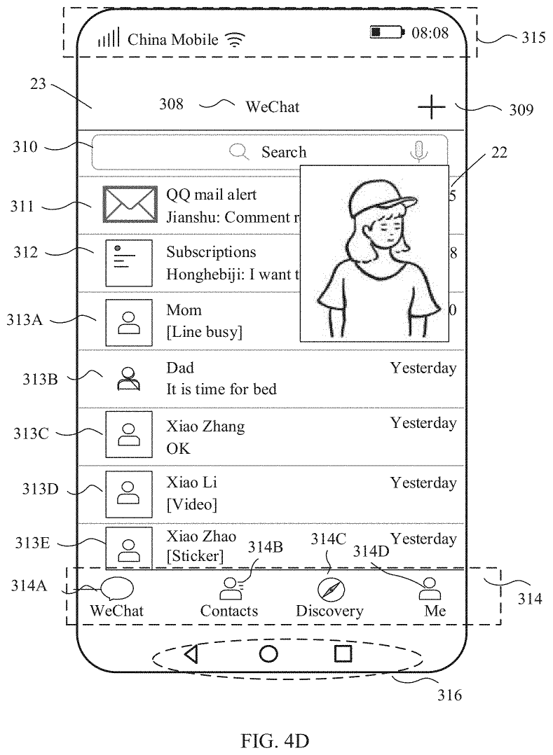

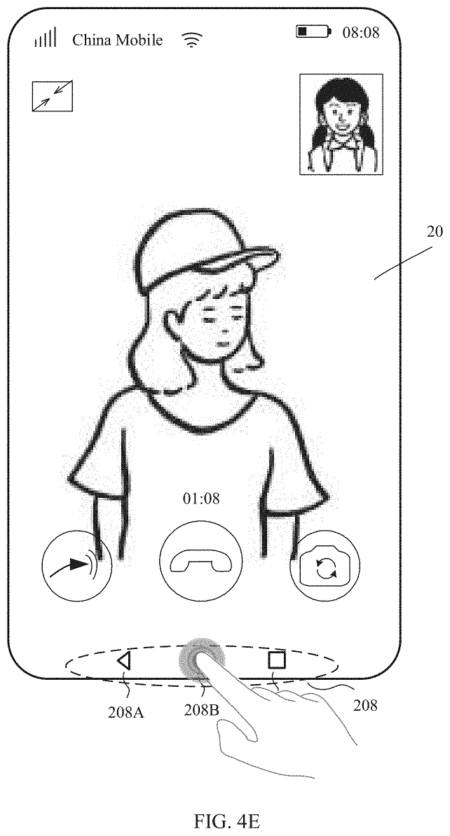

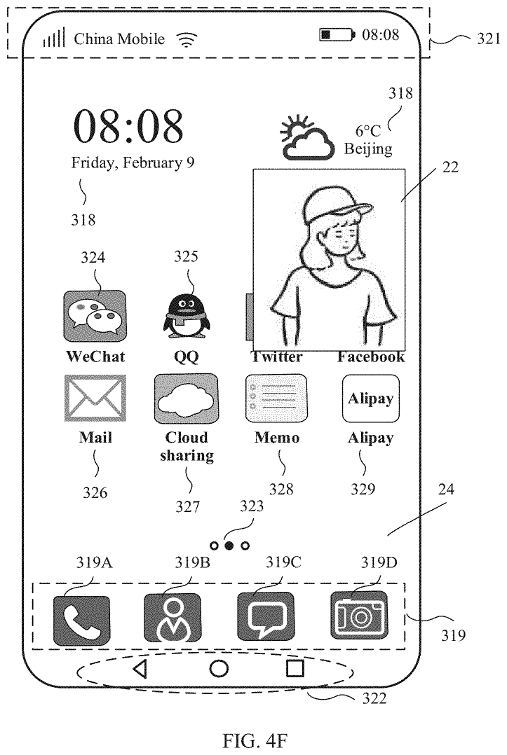

For example, as shown in FIG. 4A and FIG. 4B, when the electronic device 100 detects a tap operation performed on the window scale-down control 206, in response to the operation, the electronic device 100 displays both a chat interface 21 of a video contact and a floating window 22 on the display. The floating window 22 is displayed in the chat interface 21 of the video contact in a floating manner, and the floating window 22 displays an image collected by a camera of an electronic device of the video contact.

As shown in FIG. 4B, the chat interface 21 of the video contact may include a contact identifier 301, an exit control 302, an input box 303, a voice trigger control 304, an add control 305, a status bar 306, and a navigation bar 307.

The contact identifier 301 is used to indicate an identity of a current call object.

The exit control 302 may be configured to exit a current user interface. When the electronic device 100 may detect a touch operation performed on the exit control 302 (for example, a tap operation on the exit control 302), the electronic device 100 may exit the current user interface in response to the operation.

The input box 303 may be configured to input chat content, where the chat content may include a text, an emoticon, a picture, and the like. When the electronic device 100 may detect a touch operation performed on the input box 303 (for example, a tap operation on the input box 303), the electronic device 100 may display an input keyboard in response to the operation.

The voice trigger control 304 may be configured to invoke a voice input control. When the electronic device 100 may detect a touch operation performed on the voice trigger control 304 (for example, a tap operation on the voice trigger control 304), the electronic device 100 may display the voice input control in response to the operation. The user can tap (or touch and hold) the voice input control to input and send a voice.

The add control 305 may be configured to invoke an add menu. When the electronic device 100 may detect a touch operation performed on the add control 305 (for example, a tap operation on the add control 305), the electronic device 100 may display the add menu in response to the operation. The add menu may include the following icons: Album, Camera, Video call, Location, Red packet, Transfer, and Voice input.

The status bar 306 is the same as the status bar 207 in the user interface 20. Details are not described herein.

The navigation bar 307 is the same as the status bar 207 in the user interface 20. Details are not described herein.

For example, as shown in FIG. 4C and FIG. 4D, the current user interface is a user interface 23 used for a video call. When the electronic device 100 detects a tap operation performed on the return button 208A, in response to the operation, the electronic device 100 displays a previous user interface of the user interface 20, that is, a contact list interface 23, displays a floating window 22 at a preset location on the display, and displays a video image in the video display area 201 in the floating window 22, that is, the image collected by the camera of the electronic device of the video contact.

As shown in FIG. 4D, the electronic device 100 may display the user interface 23 on the display in full screen mode. The user interface 51 may include an application title bar 308, a control 309, a search box 310, a QQ mail alert 311, subscriptions 312, one or more contact chat bars such as 313A to 313E, a menu 314, a status bar 315, and a navigation bar 316.

The application title bar 502 may be used to indicate that a current page is used to display related interface information of the WeChat application.

The control 309 may receive a user operation (for example, a touch operation). In response to the detected user operation, the electronic device 100 may display other controls, for example, Add contacts and New chat.

The one or more contact chat bars are used to display one or more chat records of one or more contacts. For example, the chat bar 313A may receive a user operation (for example, a touch operation). In response to the detected user operation, the electronic device 100 may display a chat interface of a contact corresponding to the chat bar 313A. A latest chat time point is displayed on the chat bar 313A.

The menu 314 includes a control 314A, a control 3114B, a control 314C, and a control 314D. Content displayed in the contact list interface 23 is related to a currently selected control in the menu 314. As shown in FIG. 4D, in the current menu 314, if the control 314A is selected, the user interface 51 is configured to display the one or more chat records of the one or more contacts; if the control 314B is selected, that is, when the control 314B receives a user operation (for example, a touch operation), the electronic device 100 may display a WeChat friend list in response to the detected user operation; and if the control 314C is selected, that is, when the control 314C receives a user operation (for example, a touch operation), the electronic device 100 may display controls such as Moments and Scan in response to the detected user operation. If the control 314D is selected, that is, when the control 314D receives a user operation (for example, a touch operation), the electronic device 100 may display account information of the user in response to the detected user operation.

The status bar 315 is the same as the status bar 207 in the user interface 20. Details are not described herein.

The navigation bar 316 is the same as the navigation bar 208 in the user interface 20. Details are not described herein.

For example, as shown in FIG. 4E and FIG. 4F, the current user interface is the user interface 20 used for a video call. When the electronic device 100 detects a tap operation performed on the home screen button 208B, in response to the operation, the electronic device 100 displays a home screen 24, displays a floating window 22 on the home screen 24, and displays a video image in the video display area 201 in the floating window 22, that is, the image collected by the camera of the electronic device of the video contact.

As shown in FIG. 4F, the home screen 24 may further include a calendar indicator 317, a weather indicator 318, a tray 319 having frequently used application icons, a page indicator 320, a status bar 321, and a navigation bar 322.

The calendar indicator 317 may be used to indicate current time, for example, a date, a day of a week, and hour-minute information.

The weather indicator 318 may be used to indicate a weather type, for example, Clouds Early/Clearing Late or Light Rain, and may be further used to indicate information such as a temperature.

The tray 319 having the frequently used application icons may display a Phone icon 319A, a Contacts icon 319B, a Messages icon 319C, and a Camera icon 319D.

For example, other application icons may include a WeChat (WeChat) icon 323, a QQ icon 324, a Mail icon 325, a Cloud sharing icon 326, a Memo icon 327, and an Alipay icon 328. The home screen 24 may further include a page indicator 329. The other application icons may be distributed on a plurality of pages, and the page indicator 213 may be used to indicate a specific page on which an application is currently browsed by the user. The user may swipe left or right in an area of other application icons to browse application icons on other pages.

The status bar 321 is the same as the status bar 321 in the user interface 20. Details are not described herein.

The navigation bar 322 is the same as the navigation bar 208 in the user interface 20. Details are not described herein.

According to the floating window management method provided in this application, a currently displayed floating window may be hidden, and the hidden floating window may be re-invoked.

A video call scenario is used as an example. The following describes a video call scenario and an embodiment of a user interface in the video call scenario in the embodiments of this application.

As shown in FIG. 3, in the specific application scenario, when making a video call, the user may tap the window scale-down control 206, the return button 208A, or the home screen button 208B in the video call interface 20, so that the electronic device 100 exits the current video call interface 20, displays the floating window 22 on the display 194, and displays, in the floating window, the image collected by the camera of the electronic device (or the electronic device 100) of the video contact. From a perspective of a display effect, the electronic device 100 scales down a video call window to obtain the floating window 22 used for the video call. Based on a requirement of the user, in this embodiment of this application, the floating window 22 may be hidden, to prevent the floating window 22 from blocking other interface content, so as to prevent the floating window 22 from affecting a user operation on the other interface content. In addition, the user expects the floating window 22 to keep running in the background, so that the user can re-invoke the floating window 22.

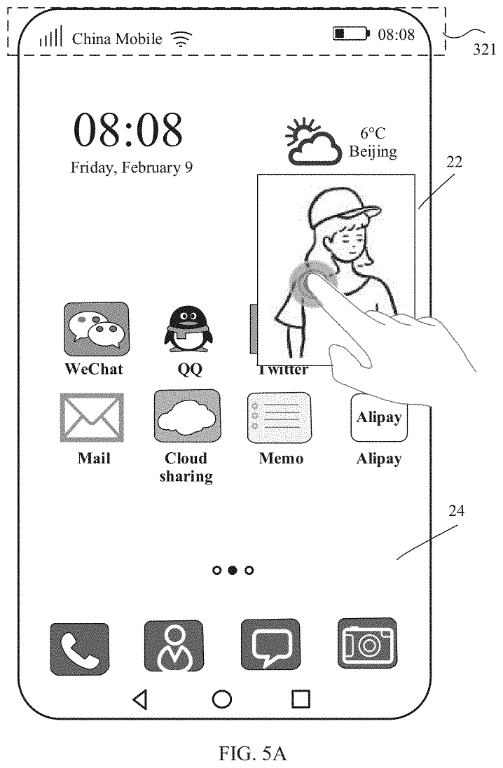

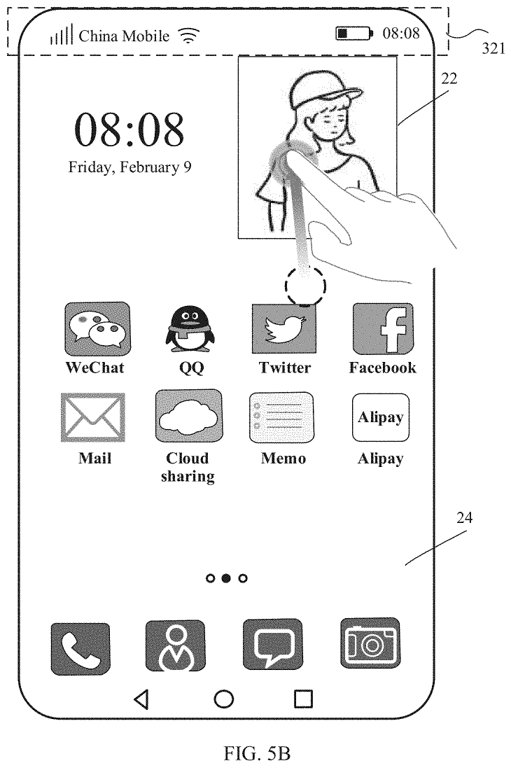

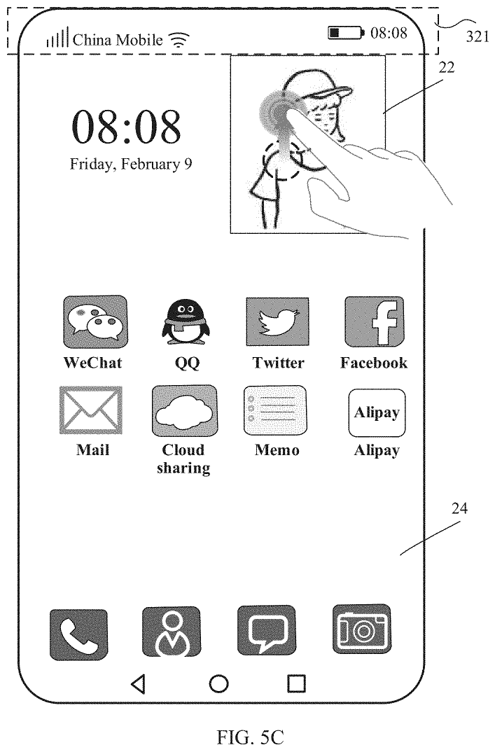

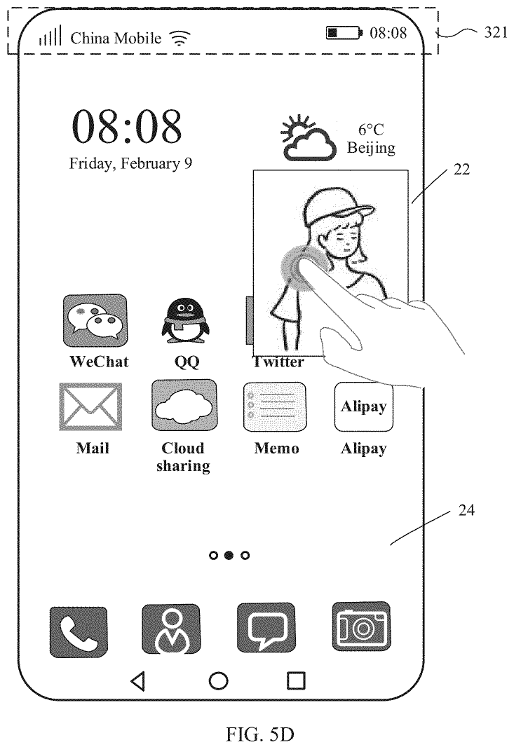

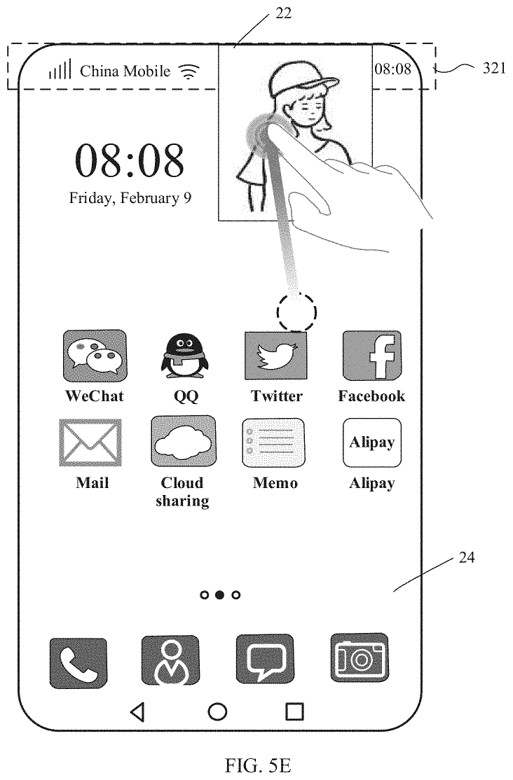

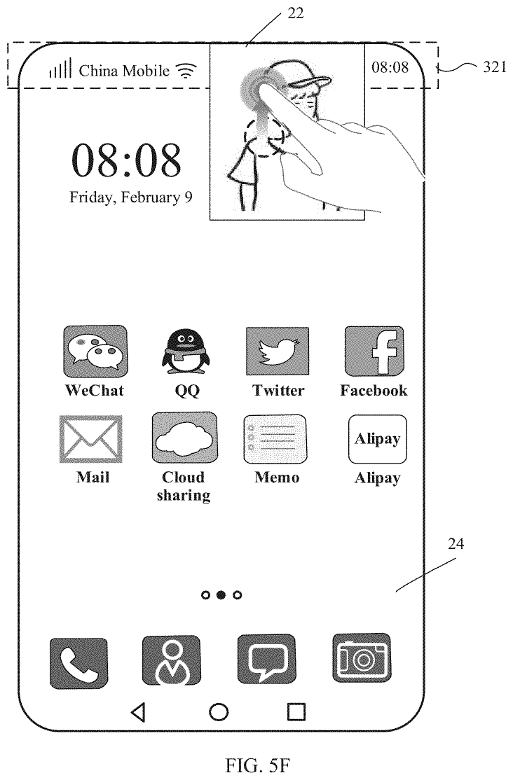

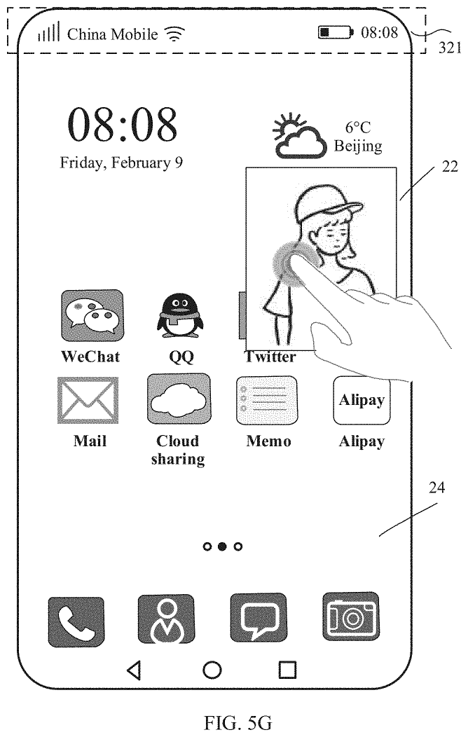

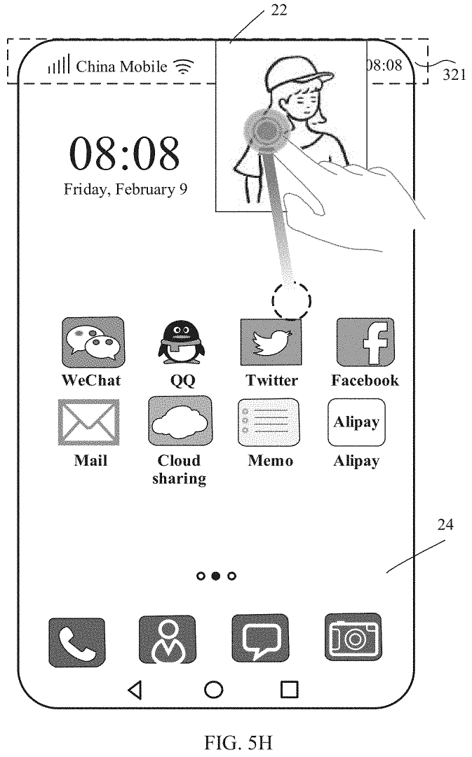

In this application, the floating window 22 is movable. When the electronic device 100 detects a drag operation performed on the floating window 22, the electronic device 100 moves a location of the floating window 22 on the display 194 in response to the operation. The drag operation may be that a finger of the user slides on the display 194, and a sliding start point is in the floating window 22. As shown in FIG. 5A and FIG. 5B, in a movement process of the floating window 22, a relative location between a finger of the user and the floating window remains unchanged.

In this application, movement of the floating window 22 on the home screen 24 includes the following two cases.

Case 1: The floating window and the status bar on the display 194 of the electronic device 100 cannot be displayed in an overlapping manner. As shown in FIG. 5A, FIG. 5B, and FIG. 5C, the finger of the user slides on the display 194 to drag the floating window 22 to move upward. When an upper edge of the floating window 22 coincides with a lower edge of the status bar 321, if the finger of the user continues to slide upward on the display 194, the floating window 22 cannot continue to move upward, that is, a vertical location of the floating window 22 remains unchanged. In this application, that the upper edge of the floating window 22 coincides with the lower edge of the status bar 321 means that a distance between the upper edge of the floating window 22 and the lower edge of the status bar 321 is 0, or means that a distance between the upper edge of the floating window 22 and the lower edge of the status bar 321 is less than or equal to a minimum. For example, the minimum is equal to 0.1 mm.

Case 2: The floating window and the status bar on the display 194 of the electronic device 100 may be displayed in an overlapping manner, and after an upper edge of the floating window 22 coincides with an upper edge of the status bar 321, the floating window 22 cannot continue to move upward. As shown in FIG. 5D, FIG. 5E, and FIG. 5F, the finger of the user slides on the display 194 to drag the floating window 22 to move upward. When the upper edge of the floating window 22 coincides with the lower edge of the status bar 321, if the finger of the user continues to slide upward on the display 194, the floating window 22 continues to move upward. After the upper edge of the floating window 22 coincides with an upper edge of the home screen 24, if the finger of the user continues to slide upward on the display 194, the floating window 22 cannot continue to move upward, that is, a vertical location of the floating window 22 remains unchanged, and a relative location between the finger of the user and the floating window changes. In this application, that the upper edge of the floating window 22 coincides with the upper edge of the status bar 321 means that a distance between the upper edge of the floating window 22 and the upper edge of the status bar 321 is 0, or means that a distance between the upper edge of the floating window 22 and the upper edge of the status bar 321 is less than or equal to a minimum. For example, the minimum is equal to 0.1 mm.

Case 3: The floating window and the status bar on the display 194 of the electronic device 100 may be displayed in an overlapping manner, and after an upper edge of the floating window 22 coincides with an upper edge of the status bar 321, the floating window 22 may continue to move upward. As shown in FIG. 5G, FIG. 5H, and FIG. 5I, the finger of the user slides on the display 194 to drag the floating window 22 to move upward. When the upper edge of the floating window 22 coincides with the upper edge of the status bar 321, if the finger of the user continues to slide upward on the display 194, the floating window 22 continues to move upward, and a relative location between the finger of the user and the floating window remains unchanged.

In addition to the foregoing three cases, the movement process of the floating window 22 on the home screen 24 may further include another case. For example, after an upper edge of the floating window 22 coincides with a lower edge of the status bar 321, if the finger of the user continues to slide upward on the display 194, a form of a contact edge between the floating window 22 and the status bar 321 may be changed. A process of changing the form may be presented in a form of various animation effects. This is not specifically limited herein.

Detailed descriptions are provided below from the following two aspects.

Aspect 1: How to hide the floating window 22.

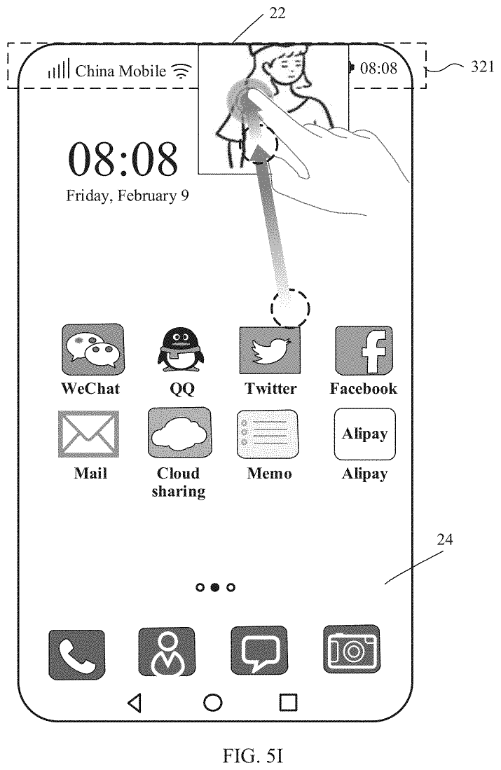

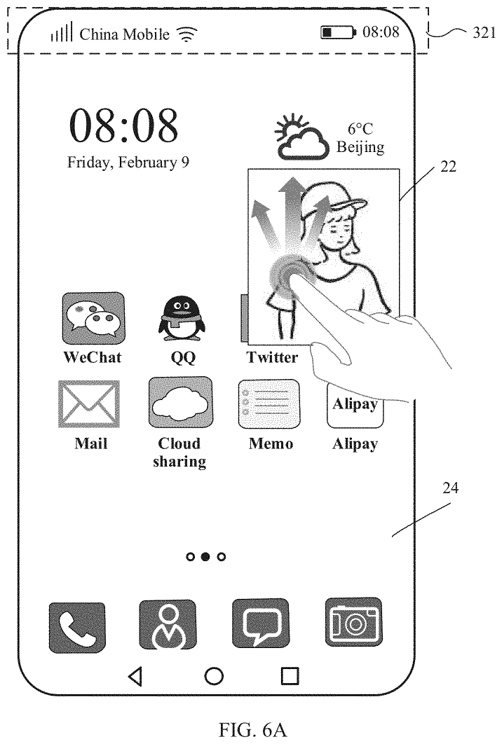

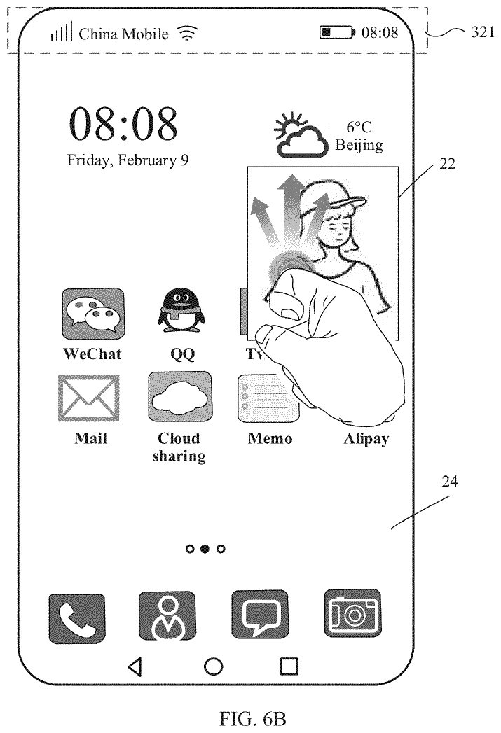

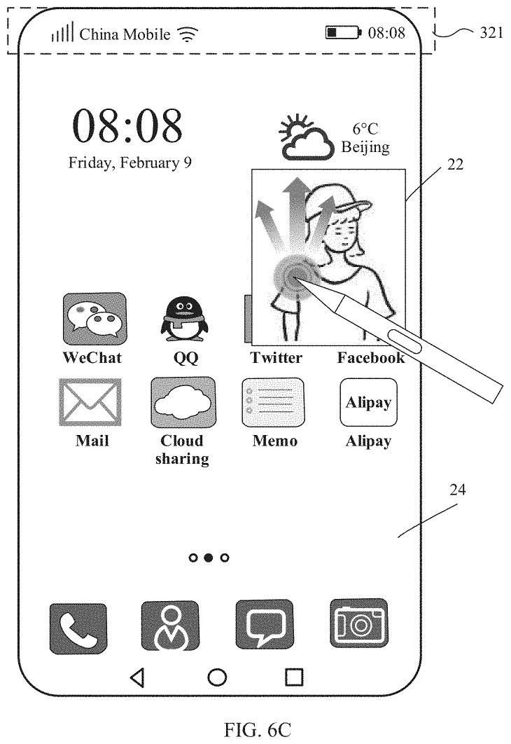

The floating window 22 in FIG. 4F is used as an example. An operation used to hide the floating window 22 may be referred to as a first user operation. When the user expects to hide the floating window 22, the user performs the first user operation. In response to the first user operation, the electronic device 100 stops displaying the floating window 22, and keeps the floating window 22 running in the background. The first user operation may be that the finger of the user slides on the display 194, to drag the floating window 22 to an area in which the status bar 321 is located. As shown in FIG. 6A, a sliding start point of the finger of the user in the first user operation is in an area in which the floating window 22 is located, and a sliding trend of the finger of the user in the first user operation is toward the top of the home screen 24.

A finger pad of the finger of the user slides on the display 194, to drag the floating window 22 to the area in which the status bar 321 is located. In addition, in some embodiments of this application, the user may further slide on the display 194 by using another body part or a tool, to drag the floating window 22 to the area in which the status bar 321 is located. For example, the user may drag the floating window 22 by using a fingertip, a finger pad, an elbow, a stylus, or the like. This is not limited herein. For example, as shown in FIG. 6B, the user may slide on the display 194 by using a knuckle, to drag the floating window 22 to the area in which the status bar 321 is located. For example, as shown in FIG. 6C, the user may further slide on the display 194 by using a stylus, to drag the floating window 22 to the area in which the status bar 321 is located.

In a specific implementation, when the finger of the user contacts the display 194 of the electronic device 100, different finger parts such as a finger pad, a fingertip, and a knuckle may generate different vibration and/or acoustic effects, and generate corresponding signals (including a pressure value generated by the contact operation on the display 194, a capacitance value, an acceleration value generated for the electronic device, and the like). The signals generated by the different finger parts may be captured by using a sensor (for example, a capacitive touchscreen, a pressure touchscreen, an acceleration sensor, an impact sensor, a vibration sensor, an acoustic sensor, a displacement sensor, or a speed sensor) of the electronic device 100. Therefore, the electronic device 100 may identify, by using the captured signals, a finger part used by the user to touch the display 194. Further, the electronic device 100 may detect touch point coordinates of a location at which the finger of the user touches the display 194 in real time in the sliding process and a location of the floating window, and identify an input touch operation based on changes of the touch point coordinates in the sliding process and the location of the floating window.

In this application, a user operation used to trigger the electronic device 100 to hide the floating window 22 may be preset by a system of the electronic device 100, or may be set by the user based on an operation habit of the user.

For Case 1 and Case 2, the following separately describes the embodiment of the user interface in which the floating window 22 is hidden.

Based on Case 1, details are as follows:

The floating window and the status bar on the display 194 of the electronic device 100 cannot be displayed in an overlapping manner. The first user operation may be that the finger of the user slides on the display 194, to drag the floating window 22 upward to the status bar 321, and a first preset condition is met.

In some embodiments of this application, the first preset condition is that the upper edge of the floating window 22 coincides with the lower edge of the status bar 321. The electronic device 100 hides the floating window 22 after the electronic device 100 detects that the upper edge of the floating window 22 coincides with the lower edge of the status bar 321.

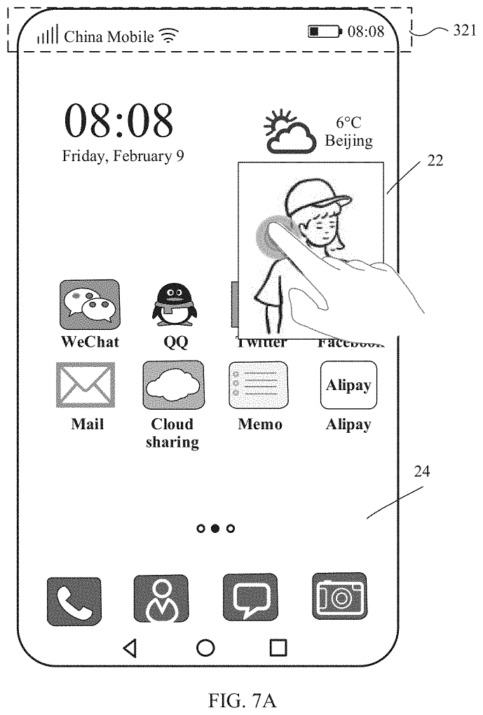

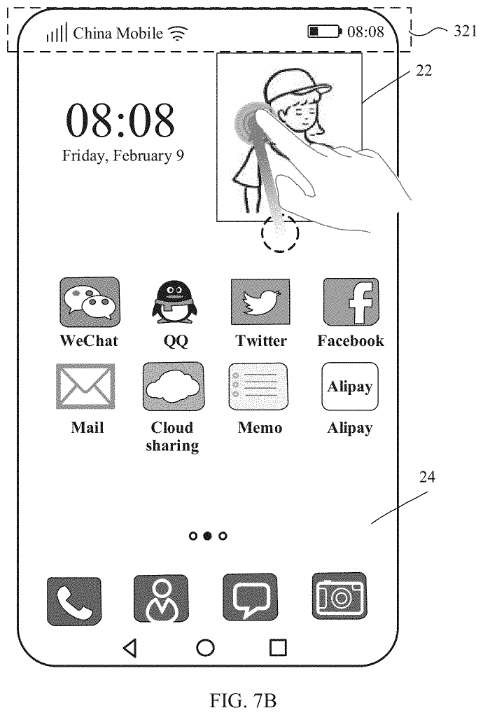

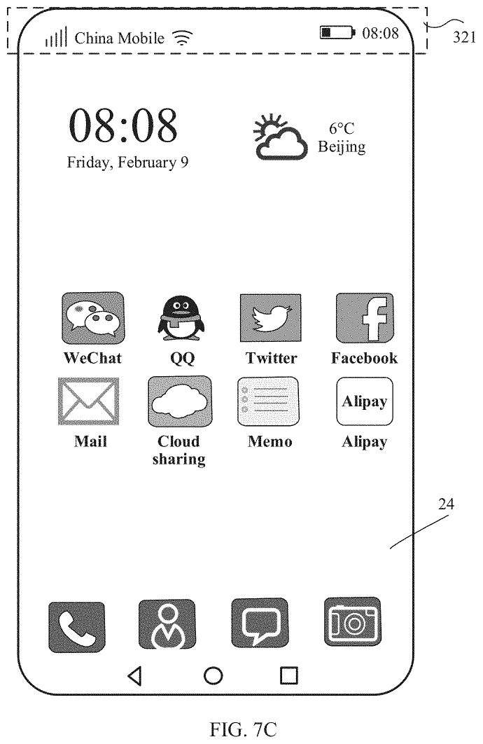

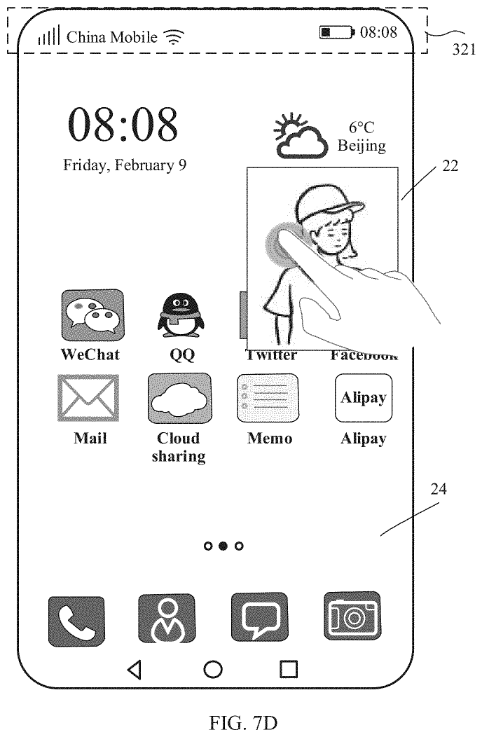

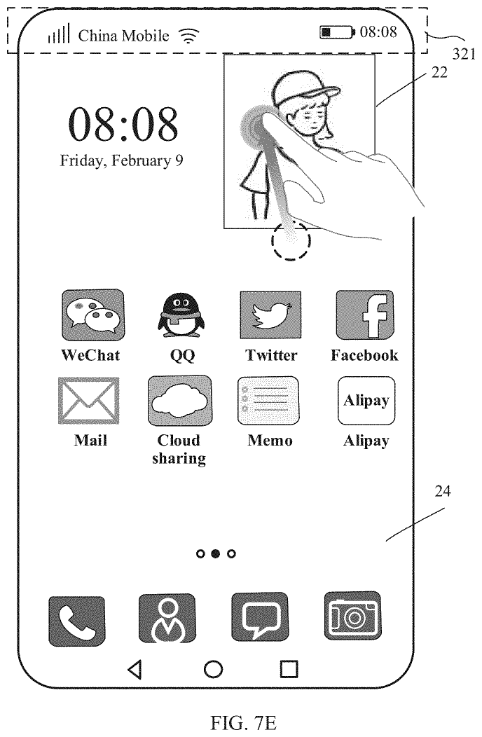

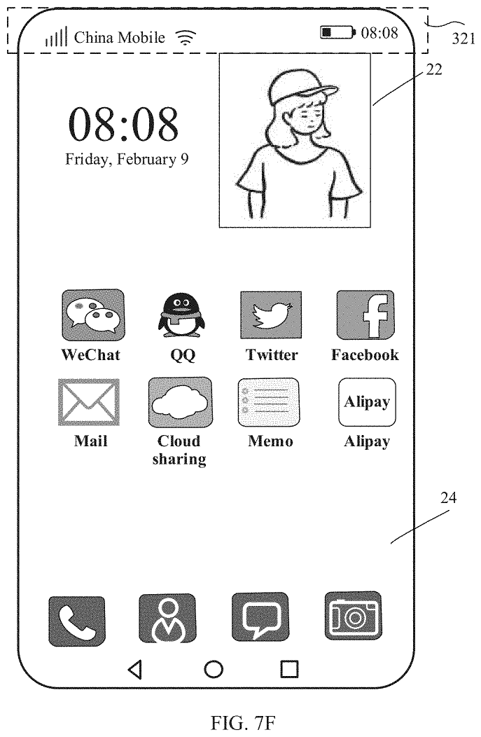

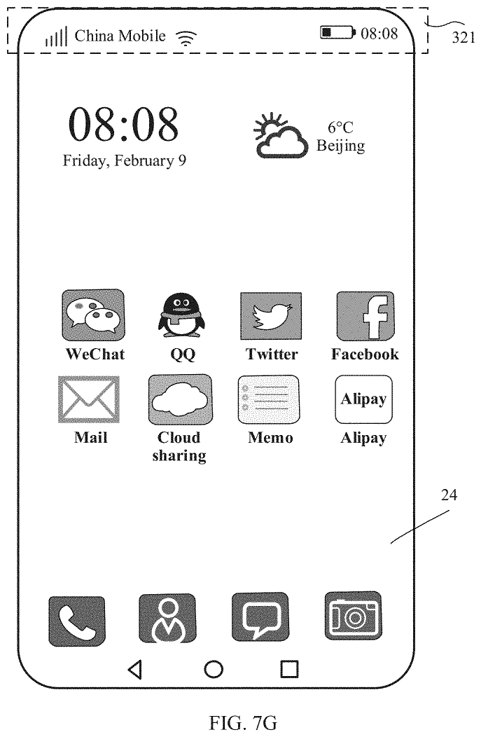

For example, as shown in FIG. 7A and FIG. 7B, the finger of the user slides on the display 194, to drag the floating window 30 to move on the home screen 24, until the upper edge of the floating window 22 coincides with the lower edge of the status bar 321. A sliding start point of the finger of the user is in the area in which the floating window 22 is located. As shown in FIG. 7C, when the electronic device 100 detects the user operation, in response to the user operation, the electronic device 100 stops displaying the floating window 22, and the electronic device 100 keeps the floating window 22 running in the background. It may be understood that regardless of whether the user continues to touch the area in which the floating window 22 is located on the display 194, the electronic device 100 may hide the floating window 22 provided that the electronic device 100 detects that the upper edge of the floating window 22 coincides with the lower edge of the status bar 321.

In some embodiments of this application, the first preset condition is that the upper edge of the floating window 22 coincides with the lower edge of the status bar 321, and the finger of the user stops sliding and stops touching the area in which the floating window 22 is located on the display 194.

For example, as shown in FIG. 7D and FIG. 7E, the finger of the user slides on the display 194, to drag the floating window 30 to move on the home screen 24, until the upper edge of the floating window 22 coincides with the lower edge of the status bar 321. A sliding start point of the finger of the user is in the area in which the floating window 22 is located. As shown in FIG. 7F, the finger of the user stops sliding and stops touching the area in which the floating window 22 is located on the display 194. As shown in FIG. 7G, when the electronic device 100 detects the user operation, in response to the user operation, the electronic device 100 stops displaying the floating window 22, and the electronic device 100 keeps the floating window 22 running in the background.

In some embodiments of this application, the user operation that the finger of the user drags the floating window 22 to the area in which the status bar 321 is located may have the following two user intents:

User intent 1: The user performs a first user operation used to hide the floating window 22. The first user operation is that the finger of the user drags the floating window 22 to the area in which the status bar 321 is located, so that the upper edge of the floating window 22 coincides with the lower edge of the status bar 321.

User intent 2: The user intends to change a location of the floating window 30 on the display 194, so that the upper edge of the floating window 22 coincides with the lower edge of the status bar 321, and the user does not expect to hide the floating window 30.

In some embodiments of this application, different user operations are used to distinguish between the foregoing two user intents. In this application, a user operation used to implement the user intent 2 is referred to as a seventh user operation.

In some optional embodiments, the first preset condition of the first user operation may be that after the upper edge of the floating window 22 coincides with the lower edge of the status bar 321, the finger of the user continues to slide upward until a distance by which the finger of the user continues to slide upward reaches a first distance threshold. The first preset condition of the first user operation may alternatively be that after the upper edge of the floating window 22 coincides with the lower edge of the status bar 321, the finger of the user continues to slide upward, and when a distance by which the finger of the user continues to slide is greater than or equal to a first distance threshold, the finger of the user stops sliding and stops touching the display 194. The electronic device 100 detects the first user operation, and the electronic device 100 determines that the first user operation is used to implement the user intent 1. In response to the first user operation, the electronic device 100 stops displaying the floating window 22, and keeps the floating window 22 running in the background. The seventh user operation may be that the finger of the user drags the floating window 22 to the area in which the status bar 321 is located. After the upper edge of the floating window 22 coincides with the lower edge of the status bar 321, the finger of the user continues to slide upward, and when a distance by which the finger of the user continues to slide is less than a first distance threshold, the finger of the user stops sliding and stops touching the display 194. The electronic device 100 detects the seventh user operation, and the electronic device 100 determines that the user operation is used to implement the user intent 2. Therefore, the electronic device 100 continues to display the floating window 22. It may be understood that, in the seventh user operation, after the finger of the user drags the floating window 22 to the area in which the status bar 321 is located, the distance by which the finger of the user continues to slide upward may be equal to 0.

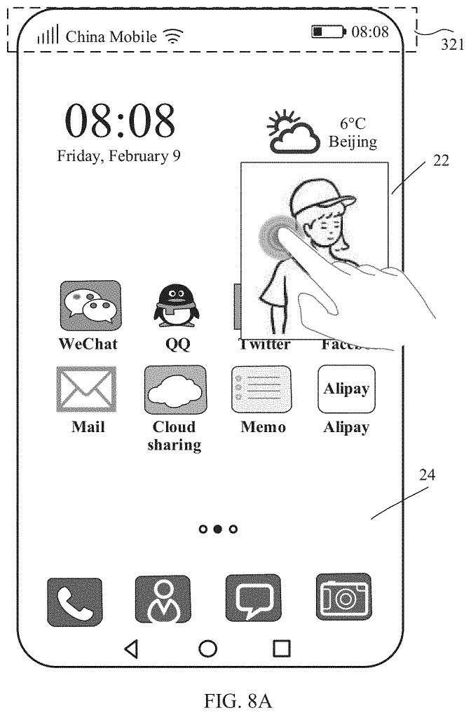

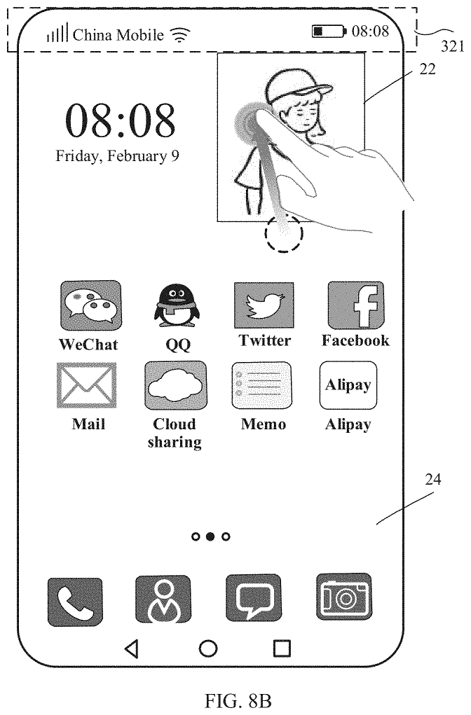

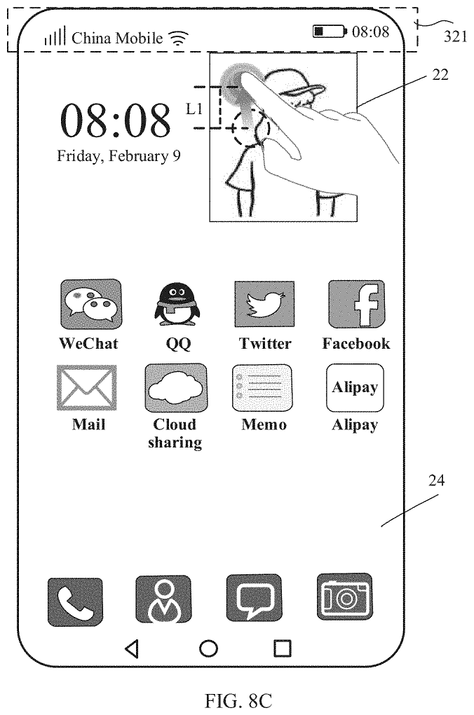

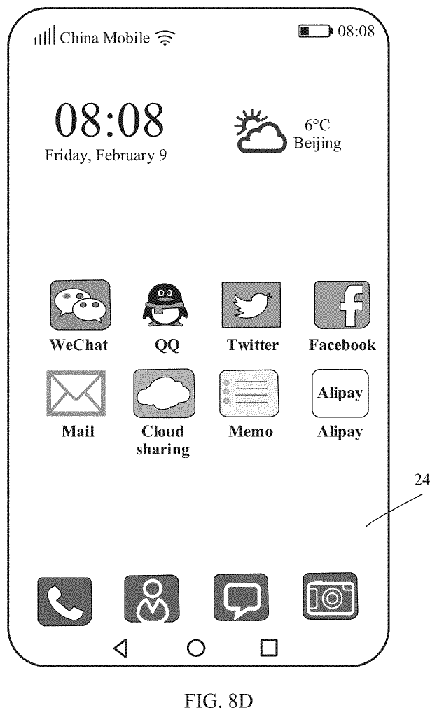

For example, the first distance threshold is equal to L1. As shown in FIG. 8A and FIG. 8B, the finger of the user slides on the display 194, a sliding start point is in the floating window 22, a sliding trend is sliding toward the top of the home screen, and the floating window 22 moves toward the status bar 321 as the finger of the user slides. As shown in FIG. 8C, after the upper edge of the floating window 22 coincides with the lower edge of the status bar 321, the finger of the user continues to slide upward. As shown in FIG. 8C and FIG. 8D, after the electronic device 100 detects that the distance by which the finger of the user continues to slide upward reaches L1, the electronic device 100 stops displaying the floating window 22, and keeps the floating window 22 running in the background.

In some optional embodiments, the first preset condition of the first user operation may be that after the upper edge of the floating window 22 coincides with the lower edge of the status bar 321, the finger of the user continues to touch the area in which the floating window 22 is located on the display 194 until a time period for which the finger of the user continues to touch the area reaches a first time threshold. The first preset condition of the first user operation may alternatively be that after the upper edge of the floating window 22 coincides with the lower edge of the status bar 321, the finger of the user continues to touch the area in which the floating window 22 is located on the display 194, and when a time period for which the finger of the user continues to touch the area is greater than or equal to a first time threshold, the finger of the user stops touching the area in which the floating window 22 is located on the display 194. In the first user operation, in a period for which the finger of the user continues to touch the area in which the floating window 22 is located on the display 194, a sliding trend of the finger of the user may be sliding stop, sliding upward, sliding leftward, or sliding rightward. The seventh user operation is that the finger of the user drags the floating window 22 to the area in which the status bar 321 is located. After the upper edge of the floating window 22 coincides with the lower edge of the status bar 321, the finger of the user continues to touch the area in which the floating window 22 is located on the display 194, and when a time period for which the finger of the user continues to touch the area is less than or equal to a first time threshold, the finger of the user stops touching the area in which the floating window 22 is located on the display 194. In the seventh user operation, in a period for which the finger of the user continues to touch the area in which the floating window 22 is located on the display 194, a sliding trend of the finger of the user may be sliding stop, sliding upward, sliding leftward, or sliding rightward. It may be understood that, in the seventh user operation, after the upper edge of the floating window 22 coincides with the lower edge of the status bar 321, a time period for which the finger of the user stops sliding and continues to touch the area in which the floating window 22 is located on the display 194 may be equal to 0.

Based on Case 2, details are as follows:

The floating window and the status bar on the display 194 of the electronic device 100 may be displayed in an overlapping manner, and after the upper edge of the floating window 22 coincides with the upper edge of the status bar 321, the floating window 22 cannot continue to move upward. The first user operation is that the finger of the user slides on the display 194, to drag the floating window 22 upward to the status bar 321, and a second preset condition is met.

In this application, the width of the status bar is a first width value.

In some embodiments of this application, the second preset condition may be that a distance between the upper edge of the floating window 22 and the upper edge of the status bar 321 is less than the first width value. It may be understood that the finger of the user drags the floating window 22 upward. After the upper edge of the floating window 22 coincides with a lower edge of the status bar 321, if the electronic device 100 detects that a distance by which the floating window 22 moves upward is greater than 0, the electronic device 100 hides the floating window 22.

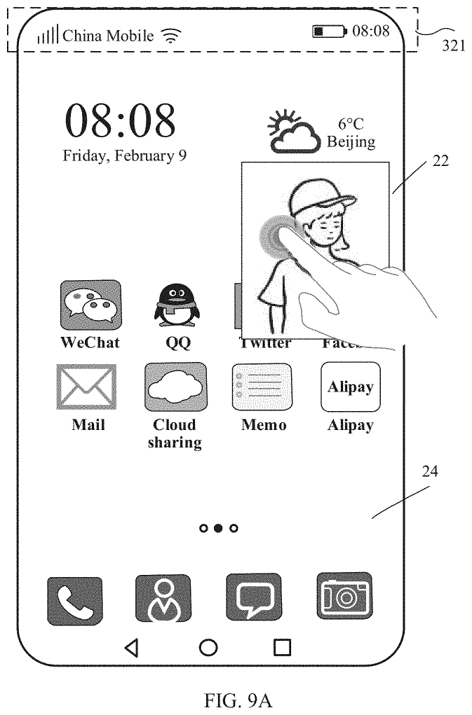

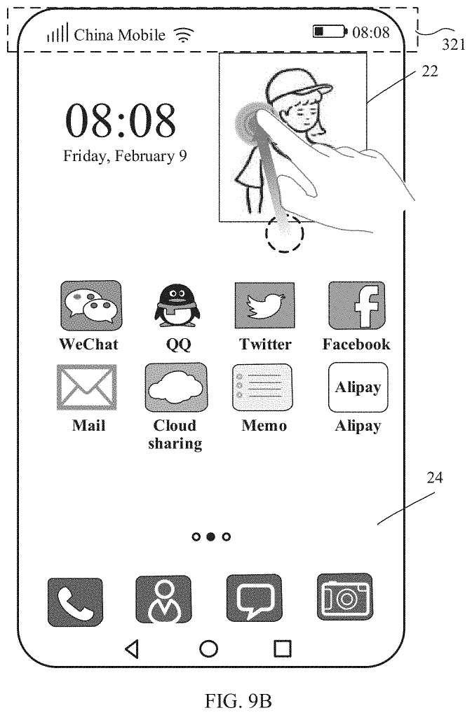

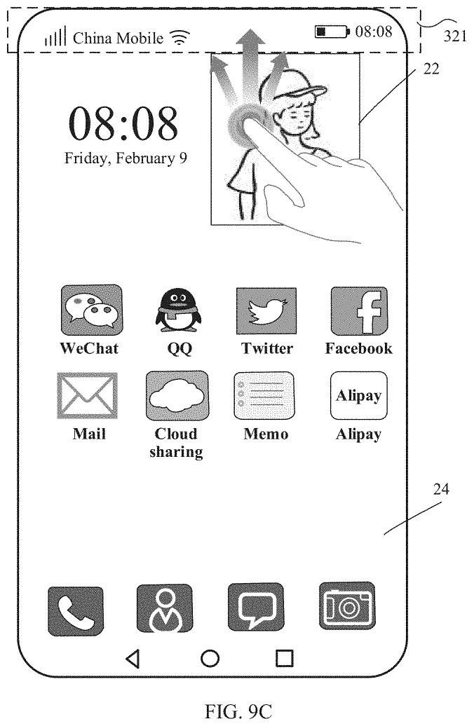

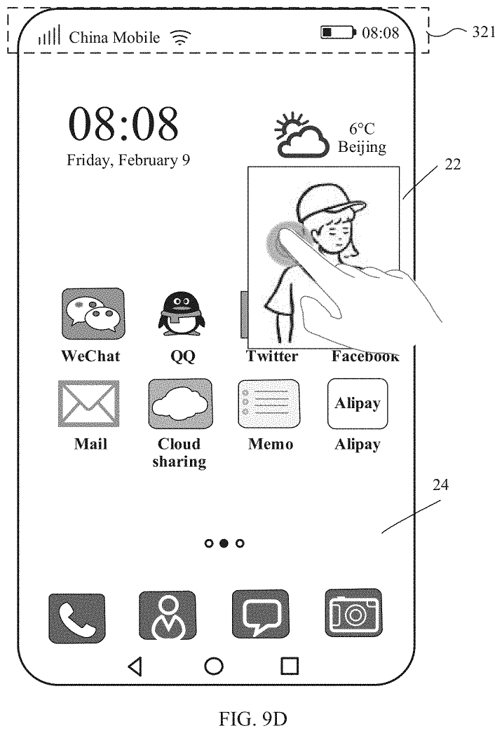

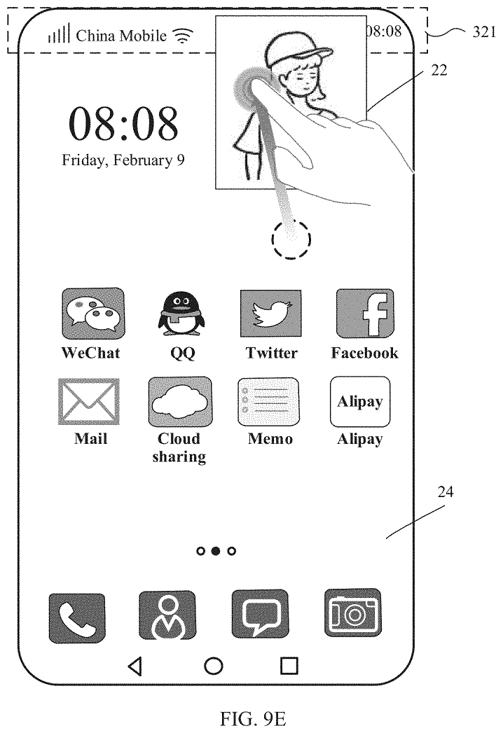

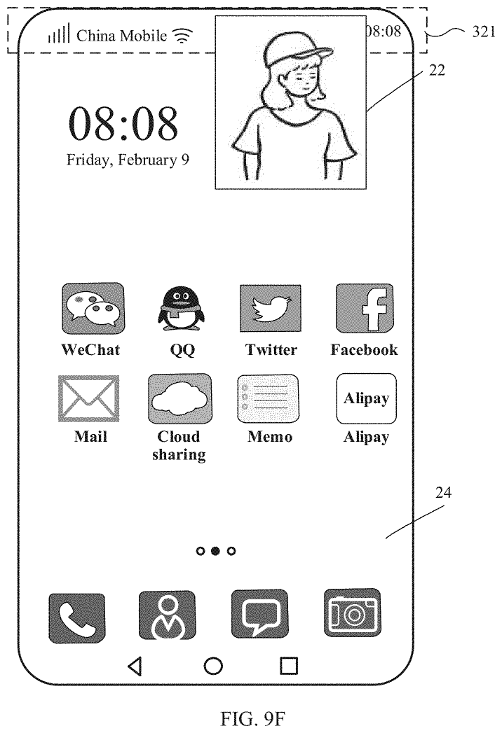

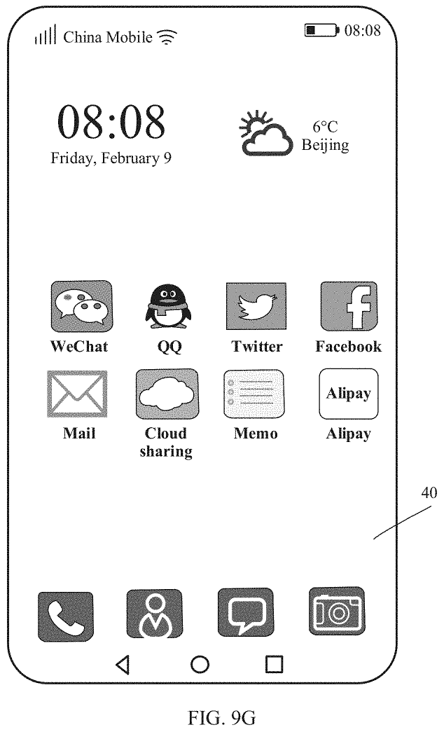

For example, as shown in FIG. 9A and FIG. 9B, the finger of the user slides on the display 194, to drag the floating window 30 to move on the home screen 24. A sliding start point of the finger of the user is in the area in which the floating window 22 is located. As shown in FIG. 9C, after the upper edge of the floating window 22 coincides with the lower edge of the status bar 321, the finger of the user continues to drag the floating window 22 upward, and the floating window continues to move upward as the finger of the user slides. If the electronic device 100 detects that the distance by which the floating window 22 continues to move upward is greater than 0, in response to the user operation, the electronic device 100 stops displaying the floating window 22, and keeps the floating window 22 running in the background. It may be understood that regardless of whether the user continues to touch the area in which the floating window 22 is located on the display 194, the electronic device 100 hides the floating window 22 provided that the distance between the upper edge of the floating window 22 and the upper edge of the status bar 321 is less than the first width value.

In some embodiments of this application, the second preset condition may be that when the distance between the upper edge of the floating window 22 and the upper edge of the status bar 321 is less than the first width value, the finger of the user stops sliding and stops touching the area in which the floating window 22 is located on the display 194.

For example, as shown in FIG. 9D and FIG. 9E, the finger of the user slides on the display 194, to drag the floating window 22 to move on the home screen 24, until the distance between the upper edge of the floating window 22 and the upper edge of the status bar 321 is less than the first width value. A sliding start point of the finger of the user is in the area in which the floating window 22 is located. As shown in FIG. 9F, the finger of the user stops sliding and stops touching the area in which the floating window 22 is located on the display 194. As shown in FIG. 9G, when the electronic device 100 detects the user operation, in response to the user operation, the electronic device 100 stops displaying the floating window 22, and the electronic device 100 keeps the floating window 22 running in the background.

In some embodiments of this application, based on Case 2, the user operation that the finger of the user drags the floating window 22 to the area in which the status bar 321 is located may alternatively have the following two user intents:

User intent 3: The user performs a first user operation used to hide the floating window 22. The first user operation may be that the finger of the user drags the floating window 22 to the area in which the status bar 321 is located, so that the distance between the upper edge of the floating window 22 and the upper edge of the status bar 321 is less than the first width value.

User intent 4: The user intends to change a location of the floating window 30 in the user interface 50, so that the distance between an upper edge of the floating window 22 and the upper edge of the status bar 321 is less than the first width value, and the user does not expect to hide the floating window 30.

In some embodiments of this application, different user operations are used to distinguish between the foregoing two user intents. In this application, a user operation used to implement the user intent 4 is referred to as an eighth user operation.

In some optional embodiments, the second preset condition of the first user operation may be that when the distance between the upper edge of the floating window 22 and the upper edge of the status bar 321 is less than the first width value, the finger of the user stops sliding and continues to touch the area in which the floating window 22 is located on the display 194 until a time period for which the finger of the user continues to touch the area reaches a second time threshold. The electronic device 100 detects the first user operation, and the electronic device 100 determines that the first user operation is used to implement the user intent 3. In response to the first user operation, the electronic device 100 stops displaying the floating window 22, and keeps the floating window 22 running in the background. The second preset condition of the first user operation may alternatively be that when the distance between the upper edge of the floating window 22 and the upper edge of the status bar 321 is less than the first width value, the finger of the user stops sliding and continues to touch the area in which the floating window 22 is located on the display 194, and when a time period for which the finger of the user continues to touch the area is greater than or equal to a second time threshold, the finger of the user stops touching the area in which the floating window 22 is located on the display 194. The eighth user operation is that the finger of the user drags the floating window 22 to the area in which the status bar 321 is located. When the distance between the upper edge of the floating window 22 and the upper edge of the status bar 321 is less than the first width value, the finger of the user stops sliding and continues to touch the area in which the floating window 22 is located on the display 194, and when a time period for which the finger of the user continues to touch the area is less than a second time threshold, the finger of the user stops touching the area in which the floating window 22 is located on the display 194. The electronic device 100 detects the eighth user operation, and the electronic device 100 determines that the eighth user operation is used to implement the user intent 2. Therefore, the electronic device 100 continues to display the floating window 22. It may be understood that, in the eighth user operation, the time period for which the finger of the user continues to touch the area in which the floating window 22 is located on the display 194 may be equal to 0.

In some embodiments of this application, based on Case 2, the user operation that the finger of the user drags the floating window 22 to the area in which the status bar 321 is located may alternatively have the following two user intents:

User intent 5: The user performs a first user operation used to hide the floating window 22. The first user operation is that the finger of the user drags the floating window 22 to the area in which the status bar 321 is located, so that the upper edge of the floating window 22 coincides with the upper edge of the status bar 321.

User intent 6: The user intends to change a location of the floating window 30 on the display 194, so that the upper edge of the floating window 22 coincides with the upper edge of the status bar 321, and the user does not expect to hide the floating window 30.

In this application, that the upper edge of the floating window 22 coincides with the upper edge of the status bar 321 means that a distance between the upper edge of the floating window 22 and the upper edge of the status bar 321 is 0, or means that a distance between the upper edge of the floating window 22 and the upper edge of the status bar 321 is less than a minimum. For example, the minimum is equal to 0.1 mm.

In some embodiments of this application, different user operations are used to distinguish between the foregoing two user intents. In this application, a user operation used to implement the user intent 6 is referred to as a ninth user operation.

In some optional embodiments, the second preset condition of the first user operation may be that after the upper edge of the floating window 22 coincides with the upper edge of the status bar 321, a distance by which the finger of the user continues to slide upward reaches a second distance threshold. The second preset condition of the first user operation may alternatively be that when the finger of the user drags the floating window 22 to the area in which the status bar 321 is located, after the upper edge of the floating window 22 coincides with the upper edge of the status bar 321, the finger of the user continues to slide upward, and when a distance by which the finger of the user continues to slide upward is greater than or equal to a second distance threshold, the finger of the user stops sliding and stops touching the area in which the floating window 22 is located on the display 194. The electronic device 100 detects the first user operation, and the electronic device 100 determines that the first user operation is used to implement the user intent 5. In response to the first user operation, the electronic device 100 stops displaying the floating window 22, and keeps the floating window 22 running in the background. The ninth user operation is that the finger of the user drags the floating window 22 to the area in which the status bar 321 is located. After the upper edge of the floating window 22 coincides with the upper edge of the status bar 321, the finger of the user continues to slide upward, and when a distance by which the finger of the user continues to slide upward is less than a second distance threshold, the finger of the user stops sliding and stops touching the area in which the floating window 22 is located on the display 194. The electronic device 100 detects the ninth user operation, and the electronic device 100 determines that the ninth user operation is used to implement the user intent 6. Therefore, the electronic device 100 continues to display the floating window 22. It may be understood that, in the ninth user operation, after the upper edge of the floating window 22 coincides with the upper edge of the status bar 321, the distance by which the finger of the user continues to slide upward may be equal to 0.

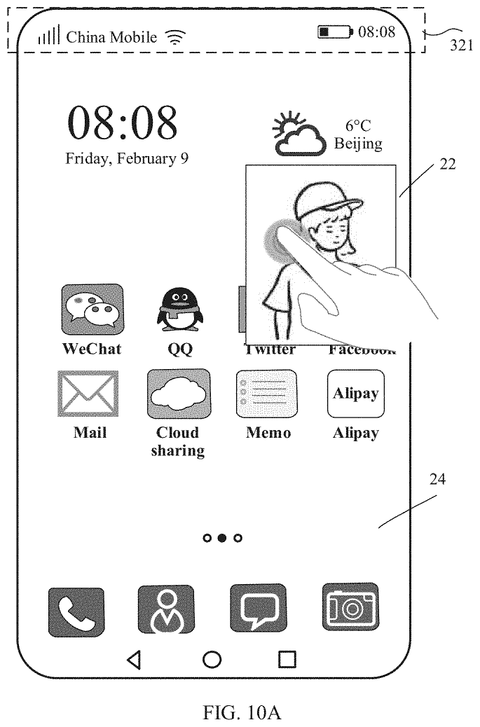

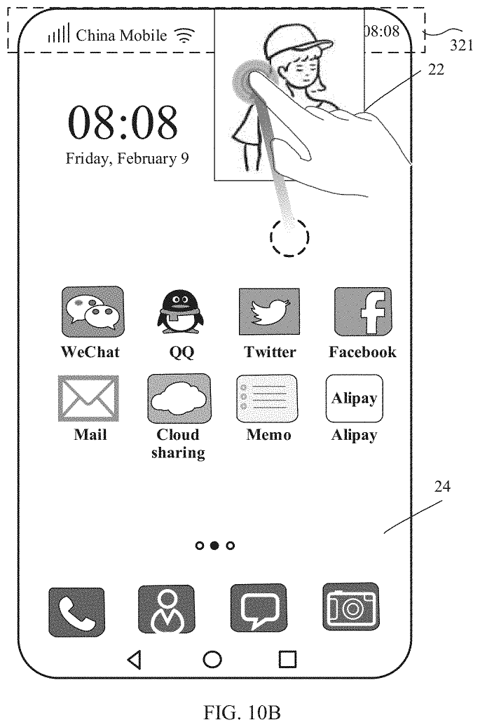

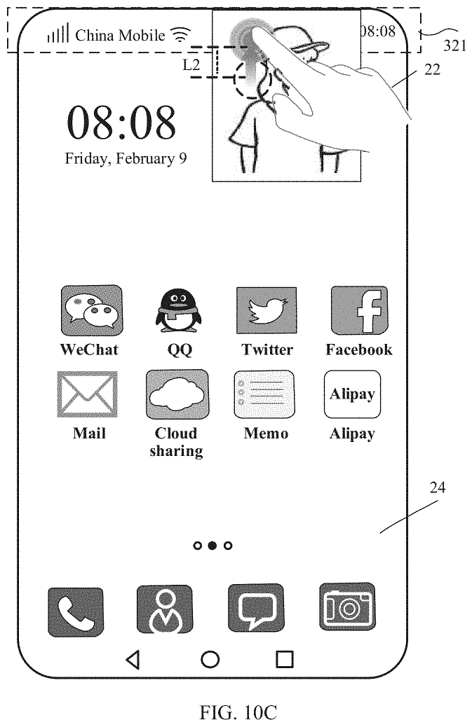

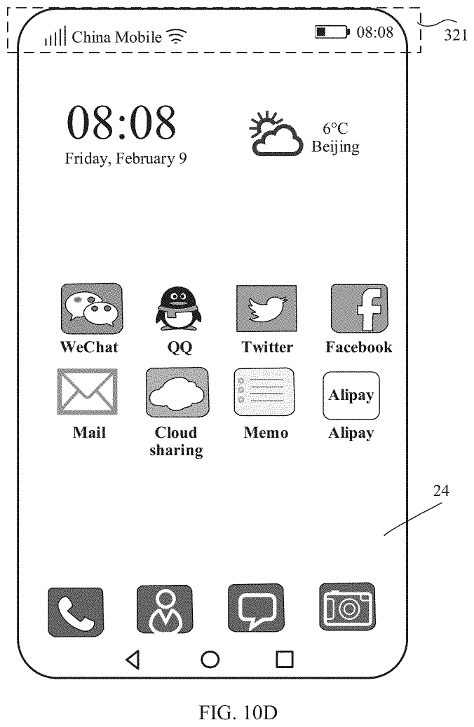

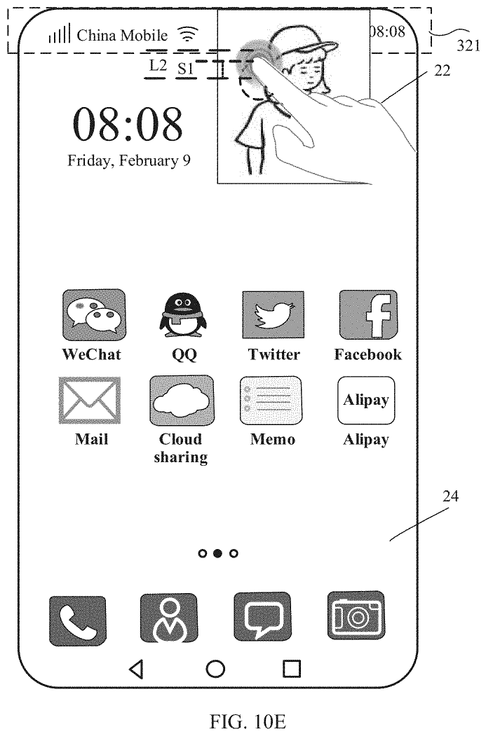

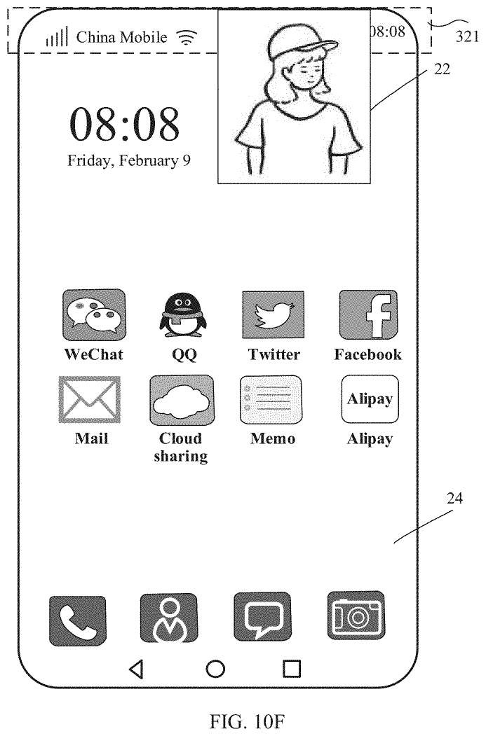

For example, as shown in FIG. 10A and FIG. 10B, the finger of the user slides on the display 194, a sliding start point is in the floating window 22, a sliding trend is sliding toward the top of the home screen, and the floating window 22 moves toward the status bar 321 as the finger of the user slides. The second distance threshold is equal to L2. As shown in FIG. 10C, after the upper edge of the floating window 22 coincides with the upper edge of the status bar 321, the finger of the user continues to slide upward. As shown in FIG. 10D, after the electronic device 100 detects that the distance by which the finger of the user continues to slide upward reaches L2, the electronic device 100 stops displaying the floating window 22, and keeps the floating window 22 running in the background. For example, after the user operation shown in FIG. 9A and FIG. 9B, the finger of the user continues to slide upward. As shown in FIG. 9E and FIG. 9F, after the finger of the user continues to slide upward by S1, the finger of the user stops sliding and stops touching the area in which the floating window 22 is located on the display 194, where S1 is less than the second distance threshold L2. When the electronic device 100 detects the user operation, in response to the user operation, the electronic device 100 continues to display the floating window 22. As shown in FIG. 10E and FIG. 10F, a vertical location of the floating window 22 remains unchanged.

In some optional embodiments, the second preset condition of the first user operation may be that after the upper edge of the floating window 22 coincides with the upper edge of the status bar 321, the finger of the user continues to touch the area in which the floating window 22 is located on the display 194 until a time period for which the finger of the user continues to touch the area reaches a third time threshold. The second preset condition of the first user operation may alternatively be that after the upper edge of the floating window 22 coincides with the upper edge of the status bar 321, the finger of the user continues to touch the area in which the floating window 22 is located on the display 194, and when a time period for which the user continues to touch the area is greater than or equal to a third time threshold, the finger of the user stops touching the area in which the floating window 22 is located on the display 194. In the first user operation, in a period for which the finger of the user continues to touch the area in which the floating window 22 is located on the display 194, a sliding trend of the finger of the user may be sliding stop, sliding upward, sliding leftward, or sliding rightward. The ninth user operation is that the finger of the user drags the floating window 22 to the area in which the status bar 321 is located. After the upper edge of the floating window 22 coincides with the upper edge of the status bar 321, the finger of the user continues to touch the area in which the floating window 22 is located on the display 194, and when a time period for which the user continues to touch the area is less than a third time threshold, the finger of the user stops touching the area in which the floating window 22 is located on the display 194. In the ninth user operation, in a period for which the finger of the user continues to touch the area in which the floating window 22 is located on the display 194, a sliding trend of the finger of the user may be sliding stop, sliding upward, sliding leftward, or sliding rightward. It may be understood that, in the ninth user operation, after the upper edge of the floating window 22 coincides with the upper edge of the status bar 321, the time period for which the finger of the user continues to touch the area in which the floating window 22 is located on the display 194 may be equal to 0.

Based on Case 3, details are as follows:

The floating window and the status bar on the display 194 of the electronic device 100 may be displayed in an overlapping manner, and after the upper edge of the floating window 22 coincides with the upper edge of the status bar 321, the floating window 22 may continue to move upward. The first user operation is that the finger of the user slides on the display 194, to drag the floating window 22 upward to the status bar 321, and a third preset condition is met.

In some embodiments of this application, the current height of the floating window 22 is a first height value. The third preset condition is that a distance between a lower edge of the floating window 22 and the upper edge of the status bar 321 is less than the first height value. It may be understood that the finger of the user drags the floating window 22 upward. After the upper edge of the floating window 22 coincides with the upper edge of the status bar 321, if the electronic device 100 detects that the floating window 22 continues to move upward, the electronic device 100 hides the floating window 22.

In some embodiments of this application, the third preset condition may be that when the distance between the lower edge of the floating window 22 and the upper edge of the status bar 321 is less than the first height value, the finger of the user stops sliding and stops touching the area in which the floating window 22 is located on the display 194.

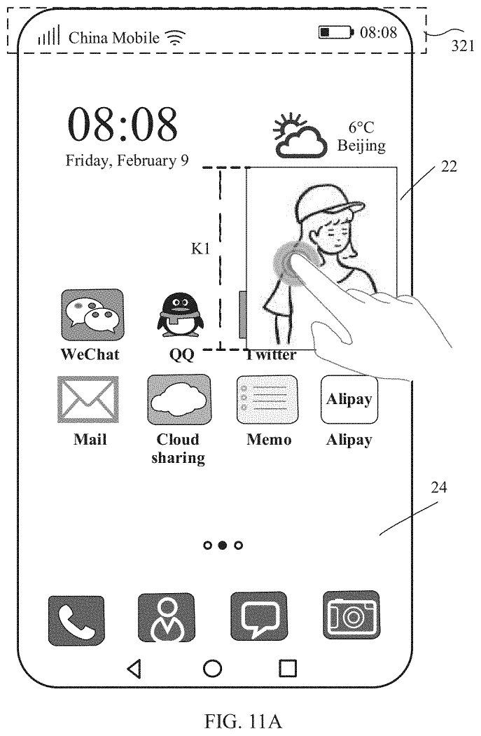

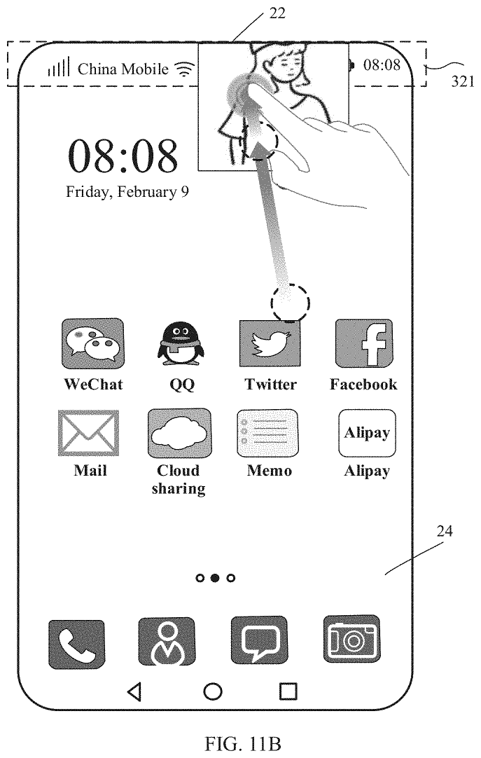

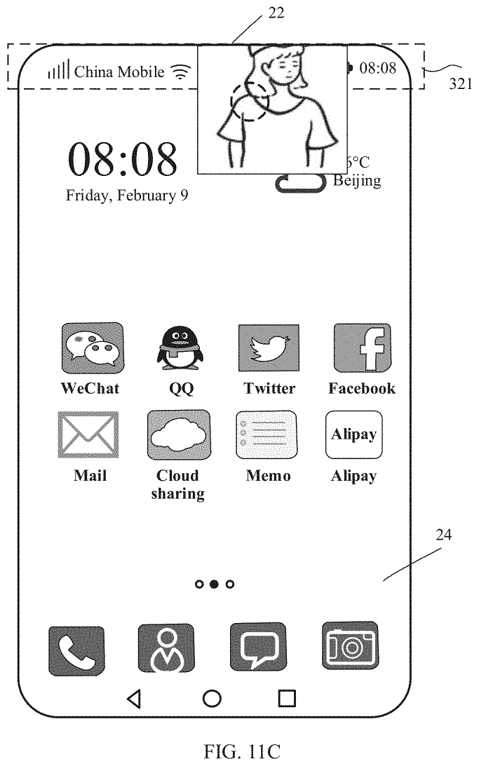

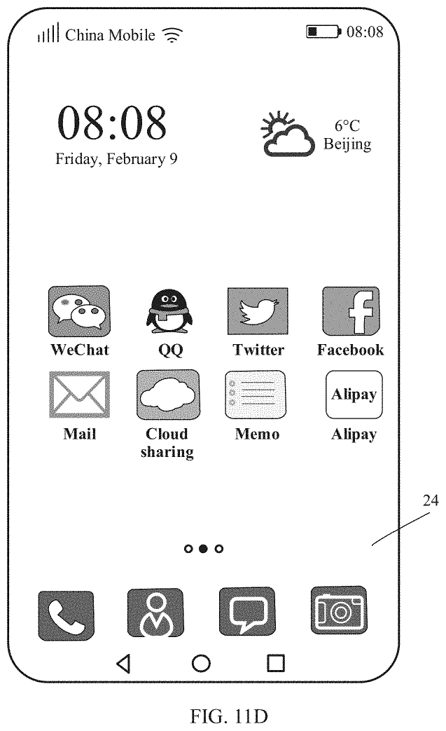

For example, a value of the first height value is K1. As shown in FIG. 11A and FIG. 11B, the finger of the user slides on the display 194, to drag the floating window 22 to move on the home screen 24. As shown in FIG. 11C, when the distance between the lower edge of the floating window 22 and the upper edge of the status bar 321 is less than the first height value, the finger of the user stops sliding and stops touching the area in which the floating window 22 is located on the display 194. As shown in FIG. 11D, when the electronic device 100 detects the user operation, in response to the user operation, the electronic device 100 stops displaying the floating window 22, and the electronic device 100 keeps the floating window 22 running in the background.

In some embodiments of this application, based on Case 3, the user operation that the finger of the user drags the floating window 22 to the area in which the status bar 321 is located may alternatively have the following two user intents:

User intent 7: The user performs a first user operation used to hide the floating window 22. The first user operation is that the finger of the user drags the floating window 22 to the area in which the status bar 321 is located, so that the distance between the lower edge of the floating window 22 and the lower edge of the status bar 321 is less than the first height value.

User intent 8: The user intends to change a location of the floating window 22 on the display 194, so that the distance between the lower edge of the floating window 22 and the lower edge of the status bar 321 is less than the first height value, and the user does not expect to hide the floating window 22.

In some embodiments of this application, different user operations are used to distinguish between the foregoing two user intents. In this application, a user operation used to implement the user intent 8 is referred to as a tenth user operation.

In some optional embodiments, the third preset condition of the first user operation may be that a distance between the lower edge of the floating window 22 and the upper edge of the status bar 321 reaches a third distance threshold, where the third distance threshold is less than the first height value. The third preset condition of the first user operation may alternatively be that when a distance between the lower edge of the floating window 22 and the upper edge of the status bar 321 is less than a third distance threshold, the finger of the user stops sliding and stops touching the area in which the floating window 22 is located on the display 194. The electronic device 100 detects the first user operation, and the electronic device 100 determines that the first user operation is used to implement the user intent 7. In response to the first user operation, the electronic device 100 stops displaying the floating window 22, and keeps the floating window 22 running in the background. The tenth user operation is that the finger of the user drags the floating window 22 to the area in which the status bar 321 is located. When a distance between the lower edge of the floating window 22 and the upper edge of the status bar 321 is less than the first height value and greater than the third distance threshold, the finger of the user stops sliding and stops touching the area in which the floating window 22 is located on the display 194. The electronic device 100 detects the tenth user operation, and the electronic device 100 determines that the tenth user operation is used to implement the user intent 8. Therefore, the electronic device 100 continues to display the floating window 22.

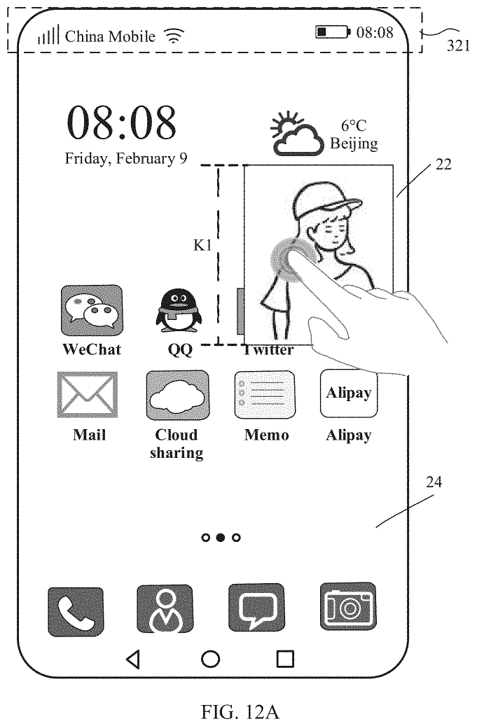

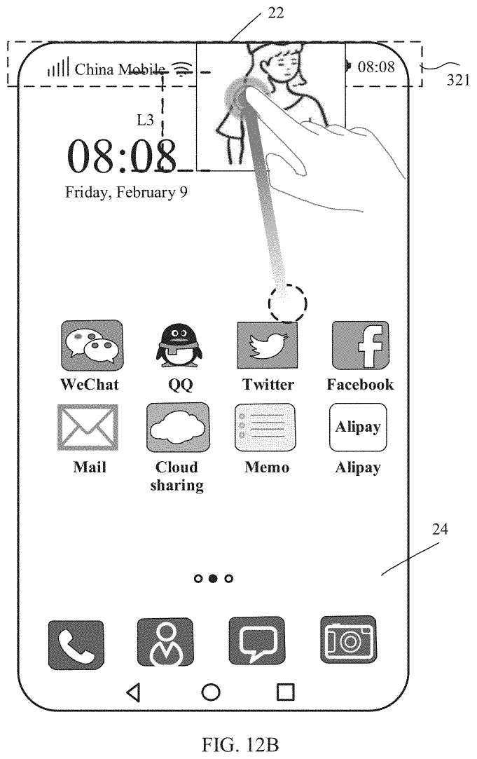

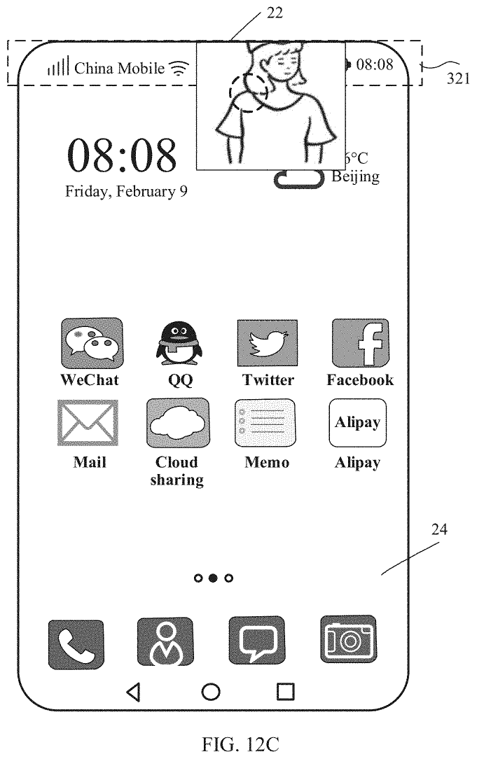

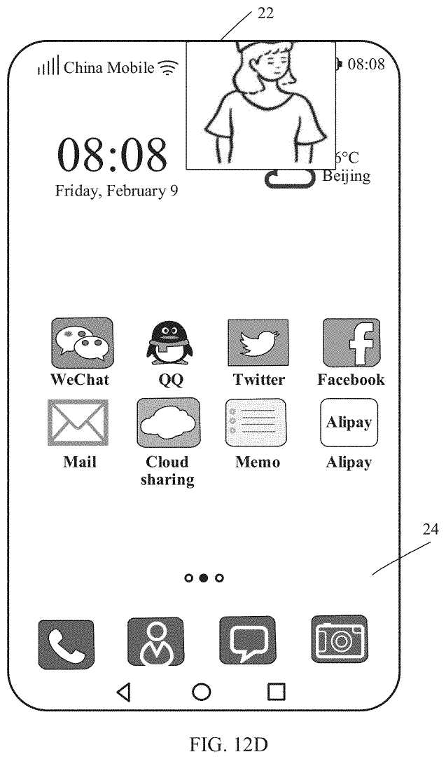

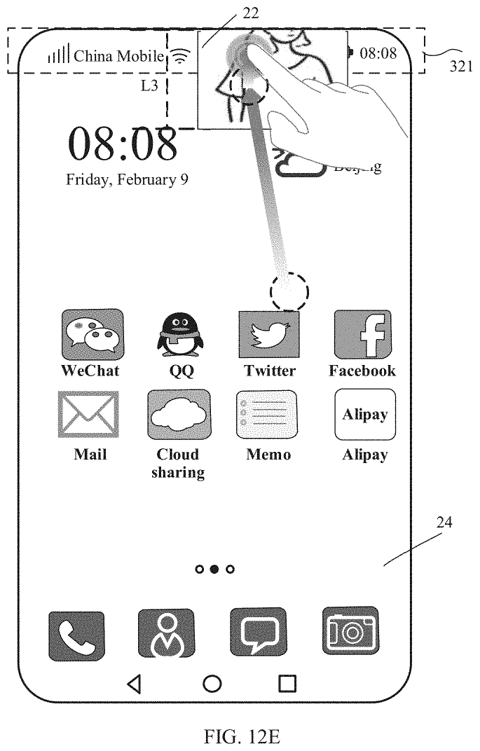

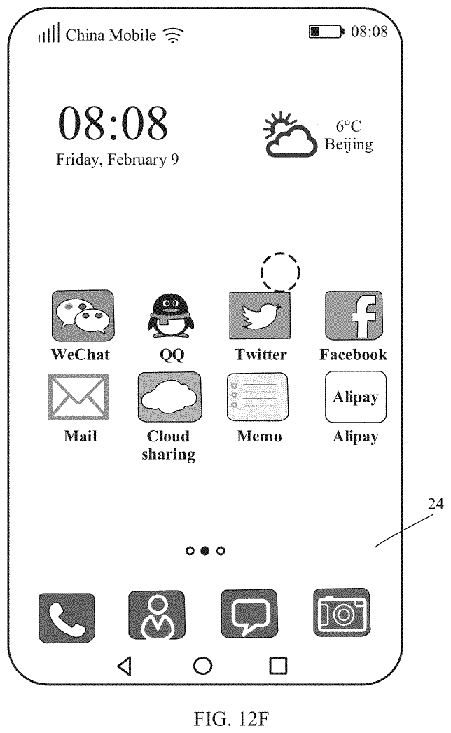

For example, as shown in FIG. 12A, FIG. 12B, and FIG. I2C, the finger of the user slides on the display 194, a sliding start point is in the floating window 22, a sliding trend is sliding toward the top of the home screen, and the floating window 22 moves toward the status bar 321 as the finger of the user slides. When the distance between the lower edge of the floating window 22 and the upper edge of the status bar 321 is less than the first height value and greater than the third distance threshold, the finger of the user stops sliding and stops touching the area in which the floating window 22 is located on the display 194. As shown in FIG. 12D, when the electronic device 100 detects the user operation, the electronic device 100 continues to display the floating window 22. As shown in FIG. 12E and FIG. 12F, after the user operation shown in FIG. 12B, the finger of the user continues to slide on the display 194 until the distance between the lower edge of the floating window 22 and the upper edge of the status bar 321 reaches the third distance threshold. When the electronic device 100 detects the user operation, in response to the user operation, the electronic device 100 stops displaying the floating window 22, and keeps the floating window 22 running in the background. In some embodiments of this application, when the electronic device 100 detects that the user may have an intent to hide the floating window 22, the electronic device 100 displays prompt information on the display 194. The prompt information is used to indicate, to the user, how to hide the floating window, and the prompt information may be presented in a form of an animation, a text, and/or a picture. This is not specifically limited herein. For example, the prompt information may be that a color of the status bar 321 changes, the width of the status bar 321 increases, the status bar 321 blinks by changing brightness, or the like.

In some embodiments of this application, the prompt information may be related to content currently displayed in the floating window. For example, if the content currently displayed in the floating window 22 is an image collected by a camera of the electronic device 100, the prompt information is that the color of the status bar changes to green. If the content currently displayed in the floating window 22 is an image collected by a camera of an electronic device of a contact, the prompt information is that the color of the status bar changes to blue.

For example, when the electronic device 100 detects that the user may have an intent to hide the floating window 22, the electronic device 100 changes the status bar 321 from the first width value to a second width value, to prompt that the user may hide the floating window 22 by using the status bar 321. The second width value is greater than the first width value.

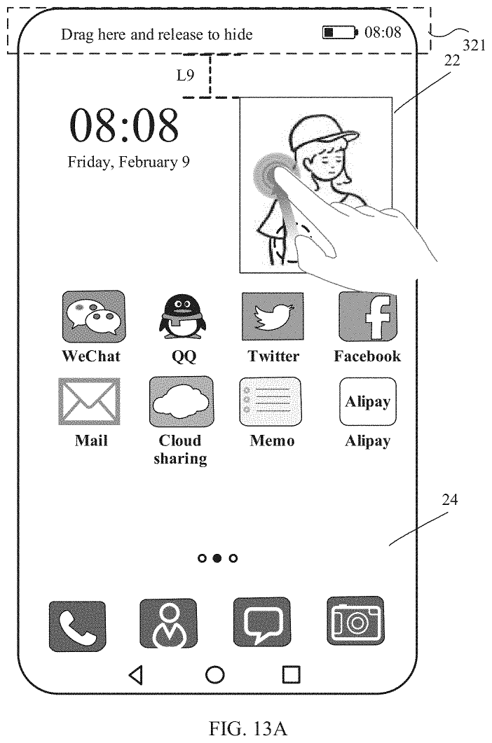

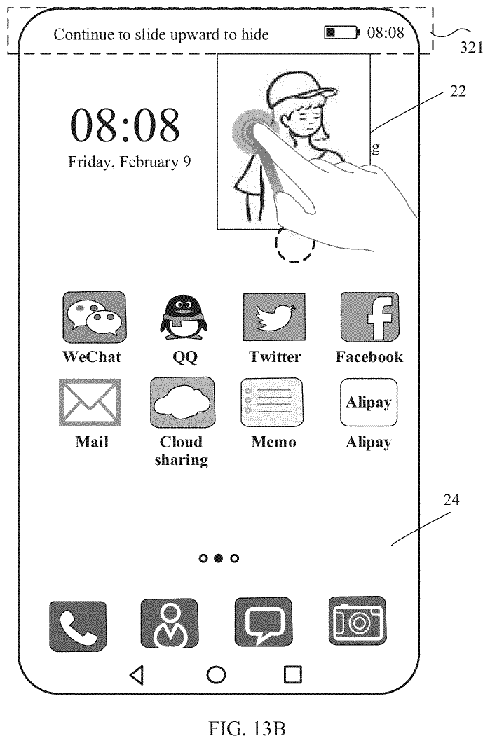

For example, the first user operation is that the finger of the user drags the floating window 22 to the area in which the status bar 321 is located. After the upper edge of the floating window 22 coincides with the upper edge of the status bar 321, the finger of the user stops sliding and stops touching the area in which the floating window 22 is located on the display 194. As shown in FIG. 13A, when the electronic device 100 detects that the distance between the upper edge of the floating window 22 and the lower edge of the status bar 321 is less than or equal to a ninth distance threshold, and there is a sliding trend that a hand of the user continues to drag the floating window 30 upward, the electronic device 100 determines that the user may have an intent to hide the floating window 22. In this case, the electronic device 100 displays prompt information on the status bar 321, where content of the prompt information is “Drag here and release to hide”, and a value of the ninth distance threshold is L9.

For example, the first user operation is that the finger of the user drags the floating window 22 to the area in which the status bar 321 is located. After the upper edge of the floating window 22 coincides with the upper edge of the status bar 321, the finger of the user continues to slide upward until a distance by which the finger of the user continues to slide reaches the second distance threshold. As shown in FIG. 13B, after the upper edge of the floating window 22 coincides with the lower edge of the status bar 321, when the electronic device 100 detects that the finger of the user continues to drag the floating window 30 upward, the electronic device 100 determines that the user may have an intent to hide the floating window 22. In this case, the electronic device 100 displays prompt information on the status bar 321, where content of the prompt information is “Continue to slide upward to hide”.

It may be understood that after the first user operation ends, the electronic device 100 stops displaying the prompt information.

In some embodiments of this application, in addition to the foregoing manner of displaying the prompt information on the display 194, the prompt information may be further played by using a voice. For example, the first user operation is that the finger of the user drags the floating window 22 to the area in which the status bar 321 is located. After the upper edge of the floating window 22 coincides with the lower edge of the area in which the status bar 321 is located, the finger of the user stops sliding and stops touching the area in which the floating window 22 is located on the display 194. When the electronic device 100 detects a sliding trend that the finger of the user drags the floating window 30 upward, the electronic device 100 plays voice prompt information, where voice content is “Drag to the status bar and release to hide the floating window”.

In addition to the foregoing user operation used to hide the floating window 22, in a specific implementation, there may be another user operation to hide the floating window 22.

For example, the user may hide the floating window 22 by drawing an S-shape on the display 194. A drawing start point of the user on the display 194 is in the area in which the floating window is located.

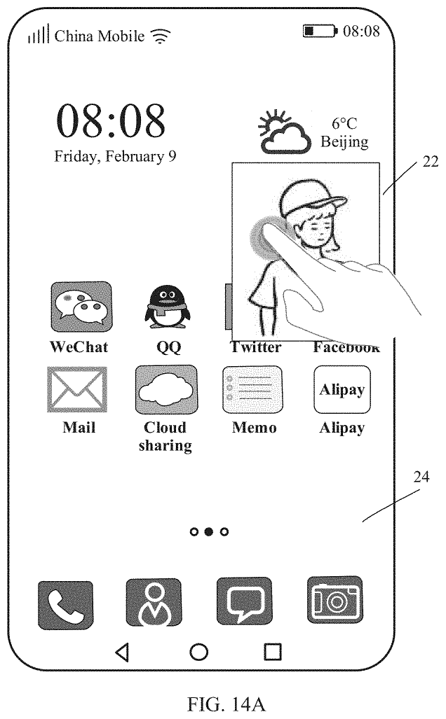

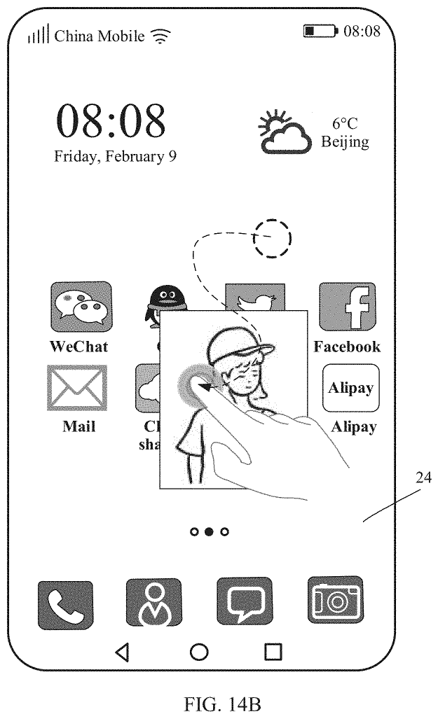

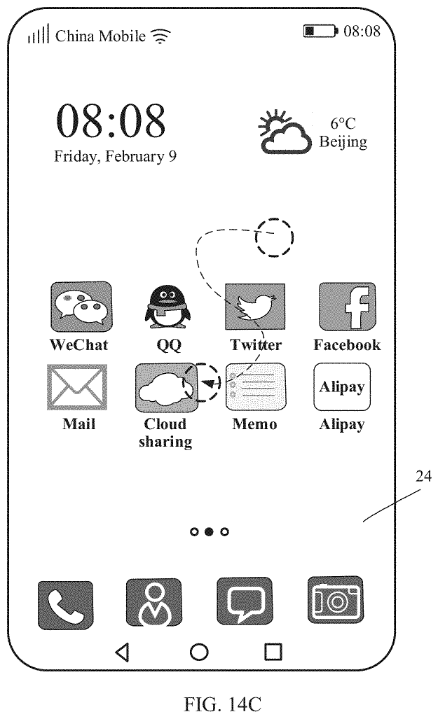

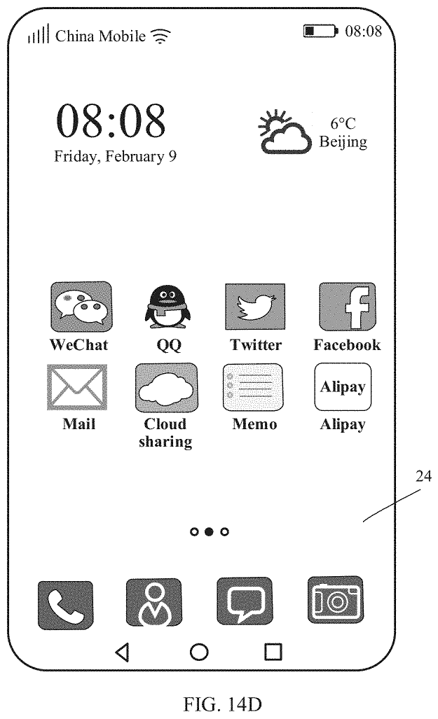

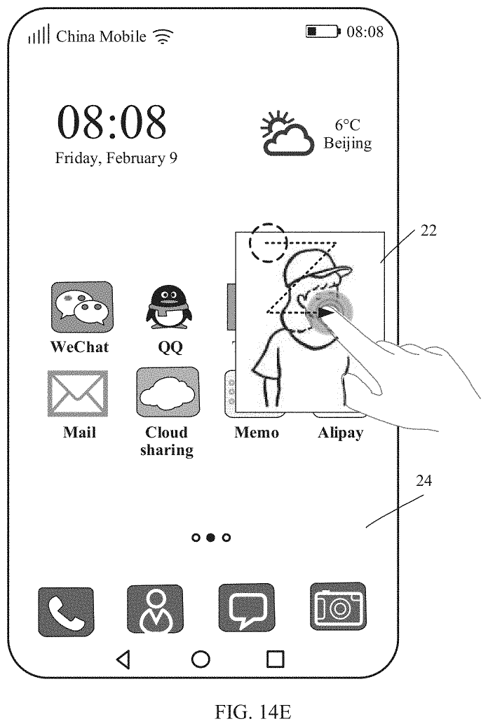

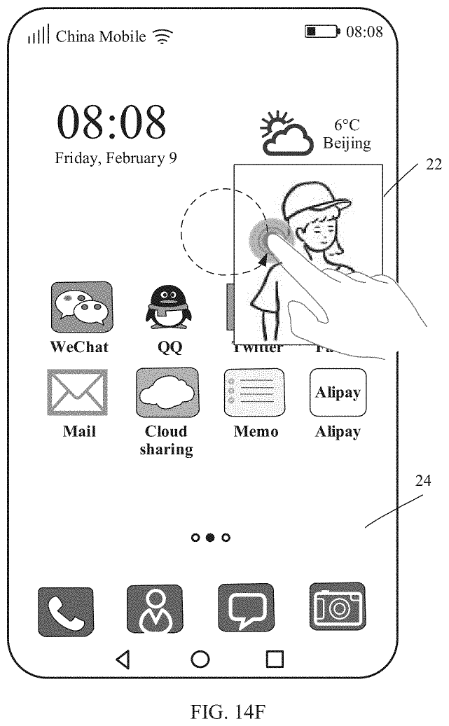

Specifically, as shown in FIG. 14A and FIG. 14B, the first user operation may alternatively be that the finger of the user slides on the display 194 to draw an S-shape, and a drawing start point of the user on the display 194 is in the area in which the floating window is located. As shown in FIG. 14C and FIG. 14D, the user stops sliding and stops touching the area in which the floating window is located on the display. When the electronic device 100 detects the touch operation, in response to the touch operation, the electronic device 100 may hide the floating window 22. In addition to drawing the S-shape on the display 194, as shown in FIG. 14E, the touch operation may be drawing a Z-shape on the display 194 by using the finger, and as shown in FIG. 14F, the touch operation may be drawing a circle in the finger by using the finger or drawing another shape on the display 194 by using the finger. A drawing start point is in the area in which the floating window is located. The first user operation may be distinguished from a touch operation entered by the user in an area outside the floating window on the display 194 by using the finger, so that the electronic device 100 is prevented from mistakenly considering the user operation used to hide the floating window 22 as another user operation entered by the user for an interface element on the display 194, to improve accuracy and efficiency of hiding the floating window 22 by the electronic device 100. The drawn shape (for example, the S-shape, the Z-shape, a rectangle, or the circle) may be a shape that is obtained through a large amount of statistics collection and that best meets a psychological expectation of the user. The user may directly associate the shape with the hidden the floating window 22, to reduce memory load of the user and meet a use habit of the user. The drawn shape may alternatively be pre-recorded by the user. In addition to the S-shape, the Z-shape, the rectangle, and the circle, the shape pre-recorded by the user may be another non-linear track shape.

Specifically, the S-shape drawn by the user on the display 194 may not be a standard shape. A specific error is allowed between the S-shape drawn by the user and a standard S-shape, provided that the shape is similar to the S-shape. The electronic device 100 may compare the S-shape detected in the user interface 20 with the standard S-shape. If a degree of matching between the S-shape detected in the user interface 20 and the standard S-shape exceeds a specific threshold, it may be considered that the detected S-shape is valid, that is, the user operation of drawing the S-shape may be used to enable the first control mode. Allowing a specific error between the S-shape drawn by the user and the standard S-shape can reduce difficulty in drawing the S-shape by the user, so that the user can draw the S-shape more randomly, and user experience is better.

For another example, the user may hide the floating window 22 by pressing the button 190.

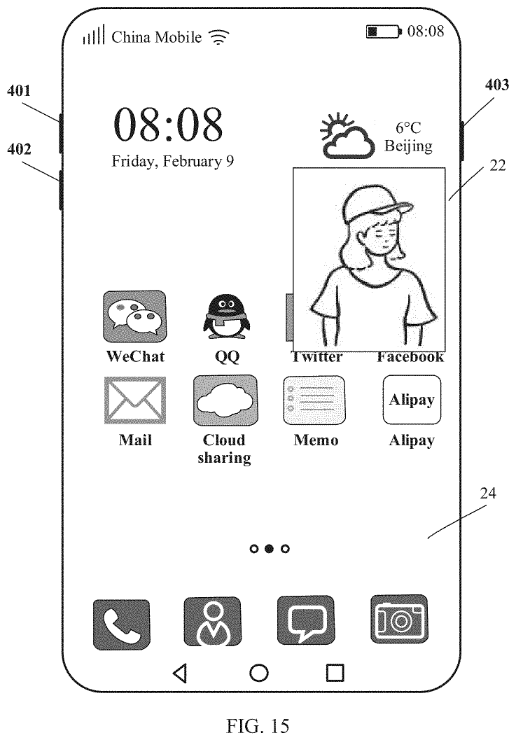

Specifically, as shown in FIG. 15, the button 190 used to hide the floating window 22 may include any one or more of a volume up button 401, a volume down button 402, and a power button 403. The volume up button and the volume down button may be located on one side of the electronic device 100, and the power button may be located on the other side of the electronic device 100. When the button 190 used to hide the floating window 22 is a combination of two buttons, the electronic device 100 may hide the floating window 22 by receiving an operation of simultaneously pressing the two buttons by the user. The operation of simultaneously pressing the two buttons may be distinguished from an operation of pressing a single button, to prevent the electronic device 100 from making an incorrect response. When the button 190 used by the user to hide the floating window 22 is any one of the foregoing buttons, the electronic device 100 may hide the floating window 22 by receiving an operation of consecutively pressing the button twice or more by the user. The operation of consecutively pressing one button twice or more may be distinguished from an operation of pressing the button once, to prevent the electronic device 100 from making an incorrect response.

For another example, the user may hide the floating window 22 by using a gesture.

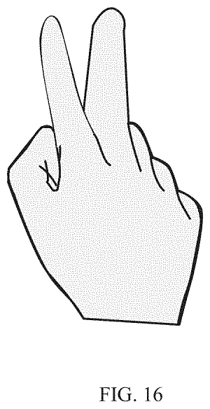

Specifically, the first user operation may alternatively be that the user makes a specific gesture within a collection range of the camera. For example, as shown in FIG. 16, the gesture is “V-shape made by using a hand of the user”. The electronic device 100 may collect, by using the camera, a gesture entered by the user, compare the collected gesture with a pre-stored gesture, and hide the floating window 22 if the collected gesture is the same as the pre-stored gesture. The floating window 22 is hidden by using the gesture. Therefore, the operation is simple and convenient. The gesture (for example, the V-shape or a gesture that five fingers are unbent and folded) may be a gesture that is obtained through a large amount of statistics collection and that best meets a psychological expectation of the user. The user may directly associate the gesture with the hidden the floating window 22, to reduce memory load of the user and meet a use habit of the user.

For another example, the user may hide the floating window 22 by using a voice.

Specifically, the electronic device 100 may collect, by using a microphone, the voice entered by the user, for example, specific content of the voice is “Please hide the floating window”; compare the specific content “Please hide the floating window” of the collected voice with a pre-stored voice keyword “Please hide the floating window”, and compare a voice feature of the collected voice with a pre-stored voice feature of an owner; and hide the floating window 22 if the specific content of the voice is the same as the pre-stored voice keyword and a degree of matching between the voice feature of the collected voice and the voice feature of the owner exceeds a specific threshold. The floating window 22 is hidden by using the voice. Therefore, the operation is simple and convenient. In addition, because another person cannot imitate the voice feature of the owner, the floating window 22 cannot be hidden randomly, and security is high. The user operation used to hide the floating window 22 is not limited in this embodiment of this application.

In some embodiments of this application, after the electronic device 100 hides the floating window 22, the electronic device 100 displays identification information of the hidden floating window 22 in the area in which the status bar 321 is located, where the identification information may indicate, to the user, that a floating window is hidden, that is, a small window runs in the background. The identification information may be presented on the display 194 in a form of a prompt bar, a small window icon, an arrow, a text, or the like. The identification information may also be used as an entrance for re-invoking the floating window 22. For example, when the finger of the user taps the identification information, in response to the user operation, the electronic device 100 redisplays the floating window 22. The identification information is displayed in the area in which the status bar 321 is located, so that the identification information can be prevented from blocking interface content on the home screen 24, to avoid impact on browsing the interface content on the home screen 24 by the user, and avoid impact on a user operation performed by the user on the home screen 24.

In some embodiments of this application, the electronic device 100 uses a color of the status bar 321 as the identification information. After the electronic device 100 hides the floating window 22, the electronic device 100 indicates, to the user by changing the color of the status bar 321, that the floating window is hidden.

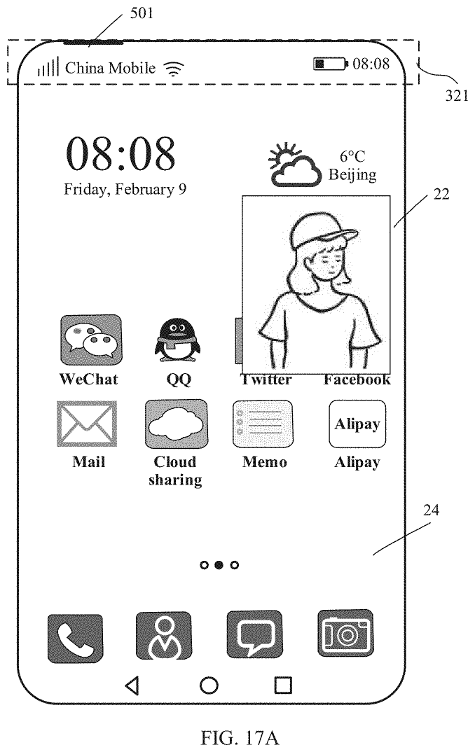

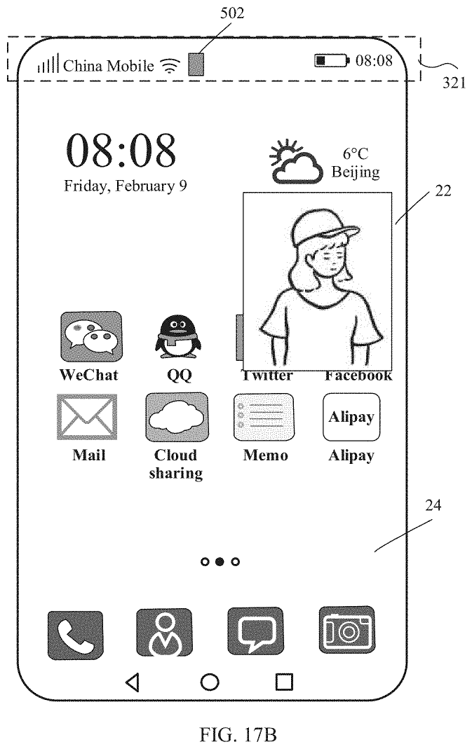

For example, as shown in FIG. 17A, after the floating window 22 is hidden, a black prompt bar 501 may be displayed on an upper left side of the display 194. For example, as shown in FIG. 17B, after the floating window 22 is hidden, a preset icon 502 of the floating window is displayed on the status bar 321.

Aspect 2: How to re-invoke the floating window 22.

It may be understood that after the user hides the floating window 22, the display 194 displays the home screen 24. Before the user re-invokes the floating window, the electronic device 100 may receive one or more user operations of the user. For example, the home screen 24 is switched to a second user interface. In this case, if the electronic device 100 detects a user operation used to re-invoke the floating window, in response to the user operation, the electronic device 100 displays both the second user interface and the floating window 22 on the display 194. The second user interface may be the same as or may be different from the home screen 24. The following further describes, by using an example in which the second user interface is the same as the home screen 24, how to re-invoke the hidden floating window.

In some embodiments of this application, when the electronic device 100 may detect a user operation performed on the home screen 24 (for example, the user single-taps the status bar 321 on the home screen 24), the electronic device 100 may re-invoke the floating window 22 in response to the user operation. In addition to single-tapping the status bar 321 on the home screen 24, the user operation may be double-tapping the status bar 321 on the home screen 24, touching and holding the status bar 321 on the home screen 24, or the like. Herein, the tap operation and the touch and hold operation may be performed by using one or more knuckles, a finger pad, a fingertip, a stylus, or the like.

In this application, an operation used to re-invoke the floating window 22 may be referred to as a second user operation. When the user expects to re-invoke the floating window 22, the user performs the second user operation. When the electronic device 100 detects the second user operation, in response to the second user operation, the electronic device 100 may re-invoke the floating window 22, and display the floating window 22 at a preset location on the display 194.

It may be understood that when the electronic device 100 detects the second user operation, the electronic device 100 determines whether there is a hidden floating window (that is, the floating window running in the background), and if there is the hidden floating window, the electronic device 100 re-invokes the hidden floating window 22 in response to the second user operation.

In this application, the user operation used to trigger the electronic device 100 to re-invoke the floating window may be preset by the system of the electronic device 100, or may be set by the user based on an operation habit of the user.

In some embodiments of this application, the second user operation may be that the finger of the user slides leftward (or rightward) in the area in which the status bar 321 is located on the display 194 by a distance reaching a fourth distance threshold. In response to the user operation, the electronic device 100 displays the floating window 22 at a preset location on the display 194.

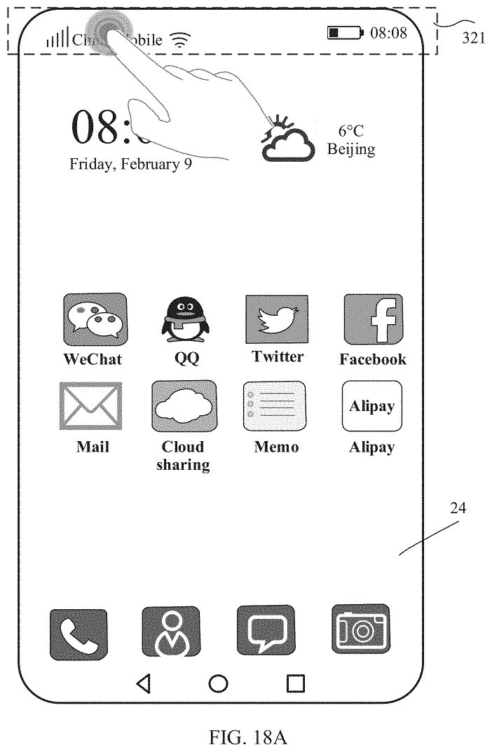

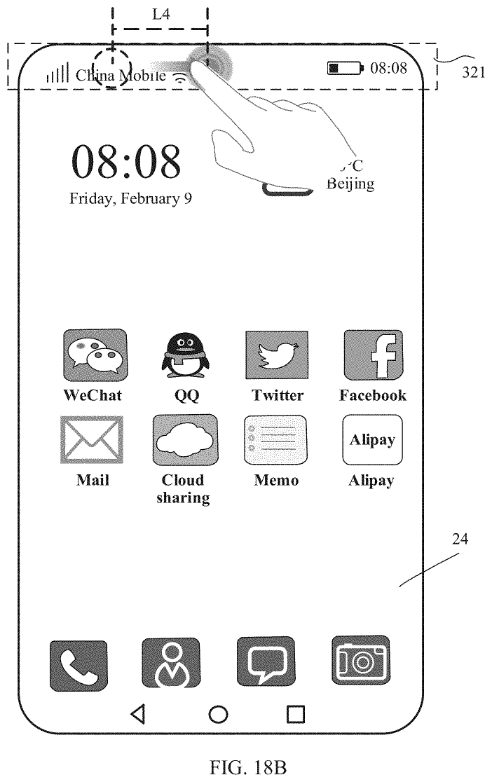

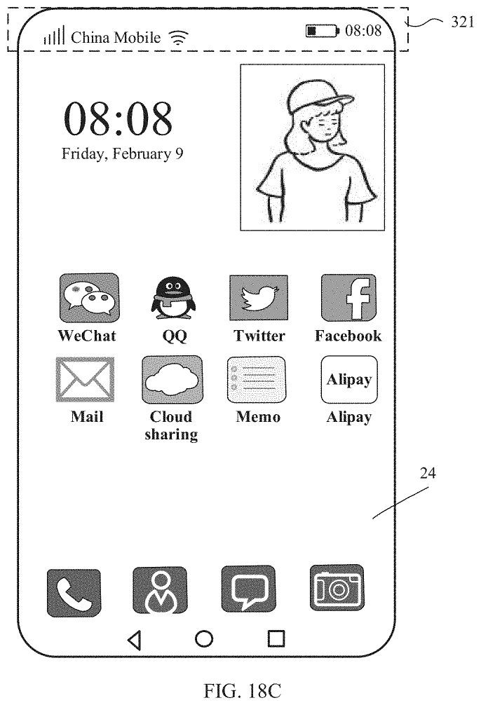

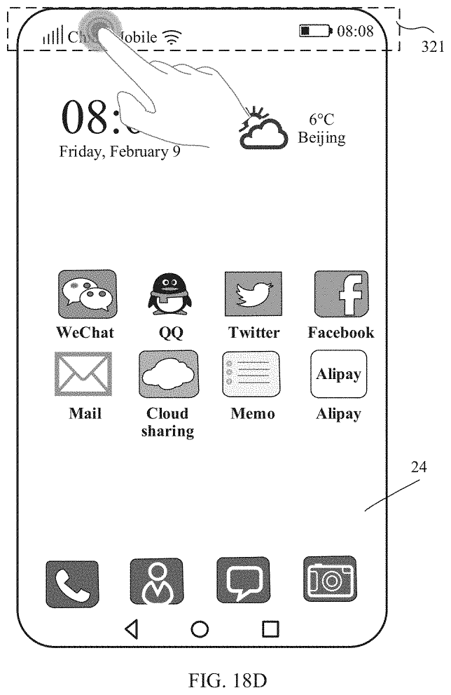

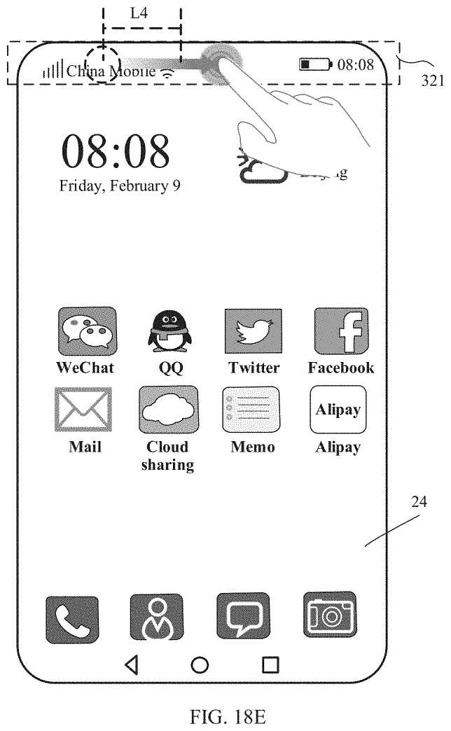

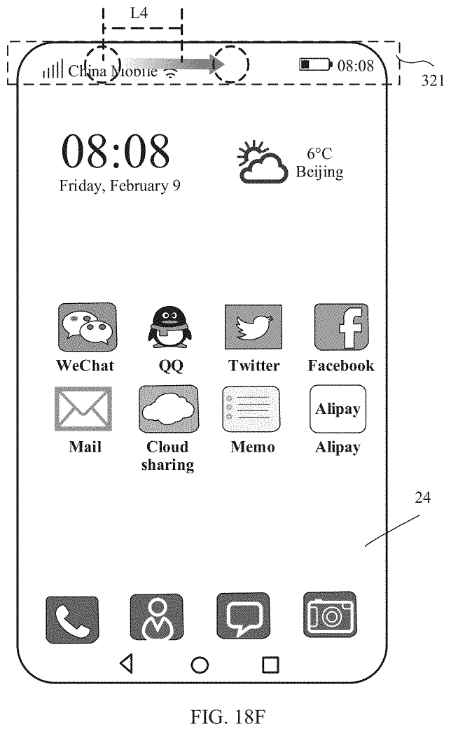

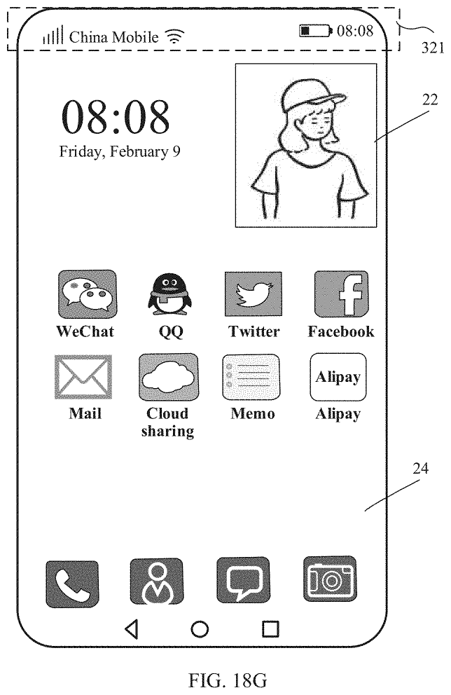

For example, a value of the fourth distance threshold is L4. As shown in FIG. 18A, FIG. 18B, and FIG. 18C, the finger of the user slides in the area in which the status bar 321 is located on the display, and a sliding trend is sliding toward a left edge of the electronic device 100. When the electronic device 100 detects that a distance by which the finger of the user slides leftward in the area in which the status bar 321 is located reaches the fourth distance threshold, the electronic device 100 displays the floating window 22 at a preset location on the display 194.

In some embodiments of this application, the second user operation may be that the finger of the user slides leftward (or rightward) on the status bar 321. When the finger of the user stops sliding and stops touching the area in which the status bar 321 is located on the display, a distance by which the finger of the user slides leftward (or rightward) is greater than or equal to a fourth distance threshold.

For example, as shown in FIG. 18D and FIG. 18E, the finger of the user slides on the area in which the status bar 321 is located on the display 194, and a sliding trend is sliding toward a left edge of the electronic device 100. As shown in FIG. 18F, when the finger of the user stops sliding and stops touching the area in which the status bar 321 is located on the display, a distance by which the finger of the user slides rightward is greater than the fourth threshold. As shown in FIG. 18G, when the electronic device 100 detects the user operation, in response to the user operation, the electronic device 100 displays the floating window 22 at a preset location on the display 194.

In some embodiments of this application, the second user operation may be that the finger of the user slides leftward (or rightward) in the area in which the status bar 321 is located on the display 194 for a time period greater than a fourth time threshold.

In some embodiments of this application, if the user intends to invoke a system notification bar interface 25 on the display 194, the finger of the user slides on the display 194. A sliding start point is the status bar 321 on the home screen 24, and a sliding trend is sliding toward the bottom of the electronic device 100. If a distance by which the finger of the user slides downward is less than a fifth distance threshold, the finger of the user may pull down a system notification bar as the finger of the user slides. When a distance by which the finger of the user slides downward is less than the fifth distance threshold, if the finger of the user stops sliding and stops touching the display 194, the electronic device 100 displays the system notification bar interface 25 in full screen mode. If the user intends to re-invoke the floating window, the second user operation may alternatively be that the finger of the user slides on the display 194, a sliding start point is the status bar 321 in the user interface, a sliding trend is sliding toward the bottom of the electronic device 100, and when a distance by which the finger of the user slides downward is greater than or equal to a fifth distance threshold, the finger of the user stops sliding and stops touching the display 194. The second user operation may alternatively be that the finger of the user slides on the display 194, a sliding start point is the status bar 321 in the user interface, a sliding trend is sliding toward the bottom of the electronic device 100, and a distance by which the finger of the user slides downward reaches a fifth distance threshold.

In this application, the distance by which the finger of the user slides downward is a distance between the lower edge of the status bar 321 and the finger of the user.

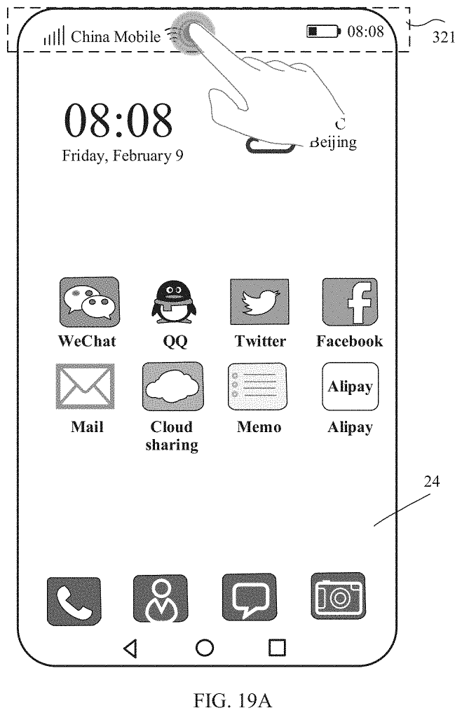

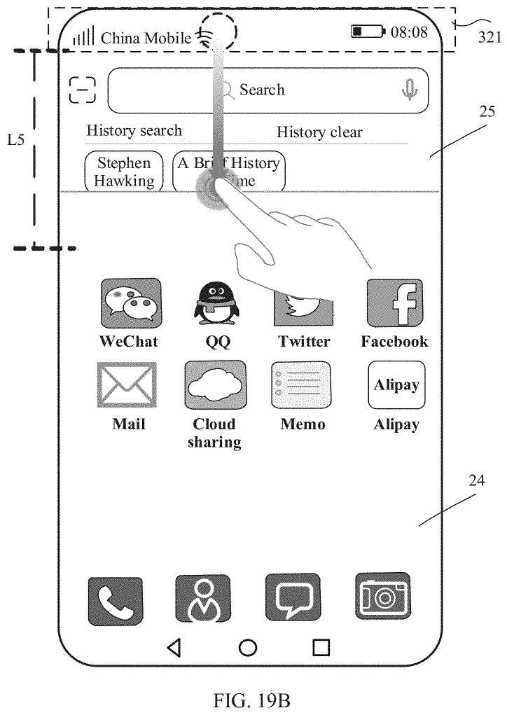

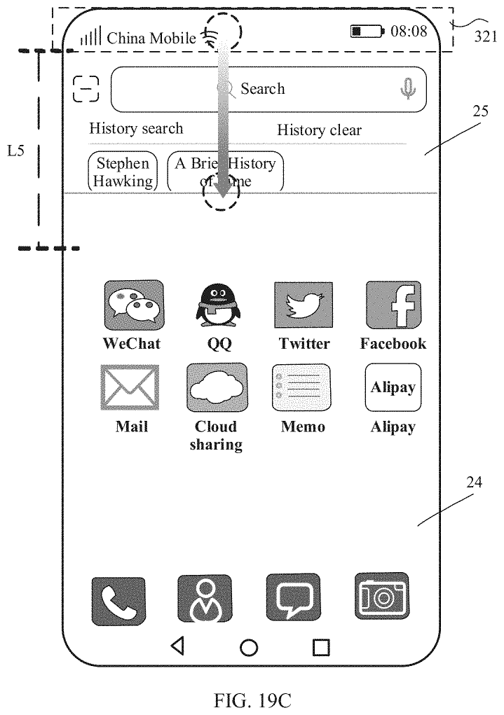

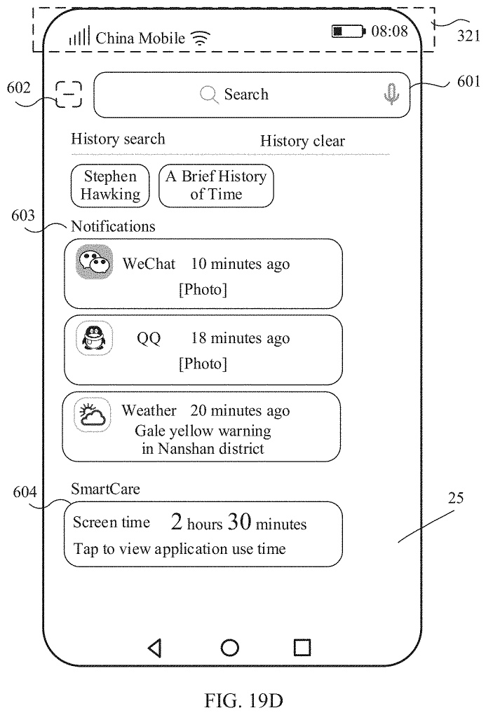

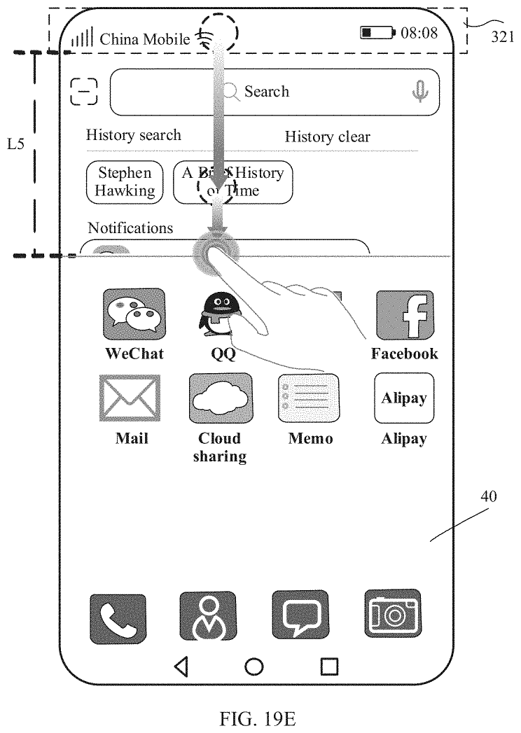

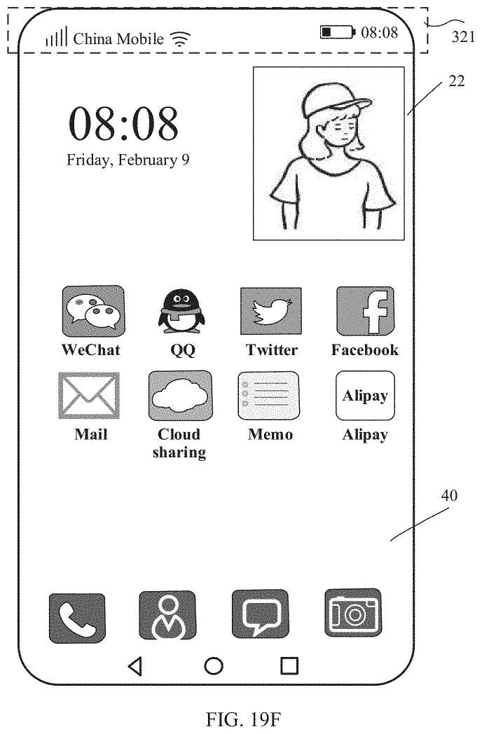

For example, a value of the fifth distance threshold is L5. As shown in FIG. 19A and FIG. 19B, the finger of the user slides downward by using the status bar 321 as a start point. When the electronic device 100 detects the user operation, in response to the user operation, the electronic device 100 displays a part of the system notification bar interface, to present a display effect of pulling down the system notification bar interface 25 by the finger of the user. As shown in FIG. 19C and FIG. 19D, when the finger of the user stops sliding and stops touching the display 194, a distance by which the finger of the user slides downward is less than the fifth distance threshold. When the electronic device 100 detects the user operation, in response to the user operation, the electronic device 100 displays the system notification bar interface 25 in full screen mode. The system notification bar interface 25 may include a search bar 601, a scan icon 602, a notification bar 603, and a SmarCare bar 604. A history search button and a history clear button may be further attached below the search bar 601. In addition to the foregoing controls, the system notification bar interface 25 may further include another control. This is not specifically limited herein. As shown in FIG. 19E, after the user operation shown in FIG. 19C, the finger of the user continues to slide downward, and a distance by which the finger of the user slides downward reaches the fifth distance threshold. As shown in FIG. 19F, when the electronic device 100 detects the user operation, in response to the user operation, the electronic device 100 re-invokes the floating window 22, and displays the floating window 22 at a preset location on the display 194.

In this application, a user operation used to invoke the system notification bar interface 25 and display the system notification bar interface 25 in full screen mode may be referred to as a fifth user operation.

In some embodiments of this application, after hiding the floating window 22, the user expects to continue watching the video image in the floating window 22. Therefore, the user may have the following three user intents:

User intent 9: The user re-invokes the floating window 22, and displays the floating window 22 at a preset location on the display 194.

User intent 10: The user re-invokes the floating window 22, and displays, in full screen mode, the video call interface 20 corresponding to the floating window 22.

User intent 11: The user re-invokes the floating window 22, and displays, in split-screen mode, the video call interface 20 corresponding to the floating window 22. To be specific, the display 194 is divided into a first area and a second area, the first area is used to continue displaying the current user interface, and the second area is used to display the video call interface 20 corresponding to the floating window 22.

In some embodiments of this application, different user operations are used to distinguish between the user intent 9 and the user intent 10. In this application, a user operation used to implement the user intent 10 is referred to as a third user operation. In this application, a user operation used to implement the user intent 11 is referred to as a fourth user operation.

In some embodiments of this application, the third user operation may be that the finger of the user single-taps or double-taps the status bar 321 in the second user interface; the third user operation may be that the finger of the user slides leftward or rightward on the status bar 321 in the second user interface for a time period greater than or equal to a fourth time threshold; the third user operation may be that the finger of the user slides leftward or rightward on the status bar 321 in the second user interface by a distance greater than or equal to a fourth distance threshold; the third user operation may be that the finger of the user touches and holds the status bar 321 in the second user interface for a time period greater than or equal to a fifth time threshold; or the third user operation may be that the finger of the user slides toward the bottom of the electronic device 100 on the display by using the status bar 321 as a start point, and when a distance by which the finger of the user slides downward is greater than or equal to a fifth distance threshold, the finger of the user stops sliding and stops touching the display.

In some embodiments of this application, the fourth user operation may be that the finger of the user single-taps or double-taps the status bar 321 in the second user interface; the fourth user operation may be that the finger of the user slides leftward or rightward on the status bar 321 in the second user interface for a time period greater than or equal to a fourth time threshold; the fourth user operation may be that the finger of the user slides leftward or rightward on the status bar 321 in the second user interface by a distance greater than or equal to a fourth distance threshold; the fourth user operation may be that the finger of the user touches and holds the status bar 321 in the second user interface for a time period greater than or equal to a fifth time threshold; or the fourth user operation may be that the finger of the user slides toward the bottom of the electronic device 100 on the display by using the status bar 321 as a start point, and when a distance by which the finger of the user slides downward is greater than or equal to a fifth distance threshold, the finger of the user stops sliding and stops touching the display.

In some optional embodiments, the second user operation may be that the finger of the user single-taps the status bar 321. The electronic device 100 detects the second user operation, and the electronic device 100 determines that the second user operation is used to implement the user intent 9. In response to the second user operation, the electronic device 100 displays the floating window 22 at a preset location on the display 194. The third user operation may be that the finger of the user touches and holds the status bar 321 for a time period greater than the fifth time threshold. The electronic device 100 detects the third user operation, and the electronic device 100 determines that the third user operation is used to implement the user intent 10. In response to the third user operation, the electronic device 100 displays, in full screen mode, the video call interface 20 corresponding to the floating window 22. The fourth user operation may be that the finger of the user touches and holds the status bar 321 for a time period greater than a sixth time threshold. The electronic device 100 detects the fourth user operation, and the electronic device 100 determines that the fourth user operation is used to implement the user intent 11. In response to the fourth user operation, the electronic device 100 displays, in split-screen mode, the video call interface 20 corresponding to the floating window 22.

In some optional embodiments, the second user operation may be that the finger of the user slides on the area in which the status bar 321 is located on the display 194, a sliding trend is sliding toward a left edge of the electronic device 100, and a distance by which the finger of the user slides leftward reaches the fourth distance threshold. The third user operation may be that the finger of the user slides on the area in which the status bar 321 is located on the display 194, a sliding trend is sliding toward a right edge of the electronic device 100, and a distance by which the finger of the user slides rightward reaches the fourth distance threshold. The fourth user operation may be that the finger of the user slides on the area in which the status bar 321 is located on the display 194, a sliding trend is sliding toward a right edge of the electronic device 100, and when a distance by which the finger of the user slides rightward is greater than the fourth distance threshold, the finger of the user stops sliding and stops touching the display 194.

In some optional embodiments, as shown in FIG. 19A, FIG. 19B, and FIG. 19C, the fifth user operation may be that the finger of the user slides on the display 194, a sliding start point is in the area in which the status bar 321 is located, a sliding trend is sliding toward the bottom of the electronic device 100, and when a distance by which the finger of the user slides downward is less than the fifth distance threshold, the finger of the user stops sliding and stops touching the display 194. The second user operation may be that the finger of the user slides on the display 194, a sliding start point is in the area in which the status bar 321 is located, a sliding trend is sliding toward the bottom of the electronic device 100, and when a distance by which the finger of the user slides downward is greater than or equal to the fifth distance threshold and less than a sixth distance threshold, the finger of the user stops sliding and stops touching the display 194. The third user operation may be that the finger of the user slides on the display 194, a sliding start point is in the area in which the status bar 321 is located, a sliding trend is sliding toward the bottom of the electronic device 100, and when a distance by which the finger of the user slides downward is greater than or equal to the sixth distance threshold and less than a seventh distance threshold, the finger of the user stops sliding and stops touching the display 194. The fourth user operation may be that the finger of the user slides on the display 194, a sliding start point is in the area in which the status bar 321 is located, a sliding trend is sliding toward the bottom of the electronic device 100, and when a distance by which the finger of the user slides downward is greater than or equal to the seventh distance threshold, the finger of the user stops sliding and stops touching the display 194. Alternatively, the fourth user operation may be that the finger of the user slides on the display 194, a sliding start point is in the area in which the status bar 321 is located, and a sliding trend is sliding toward the bottom of the electronic device 100, until a distance by which the finger of the user slides downward reaches the seventh distance threshold.

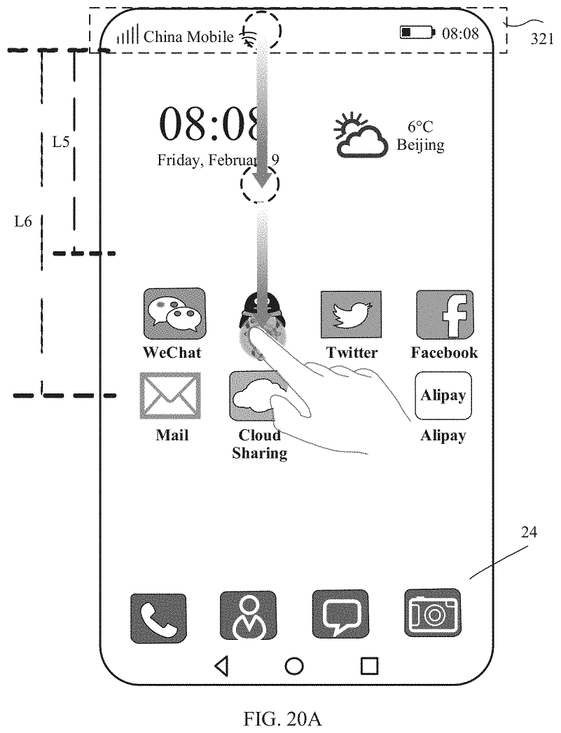

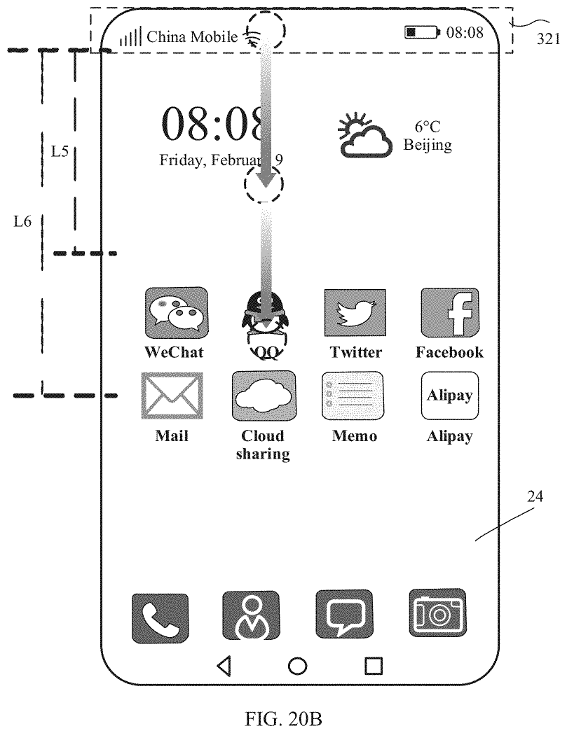

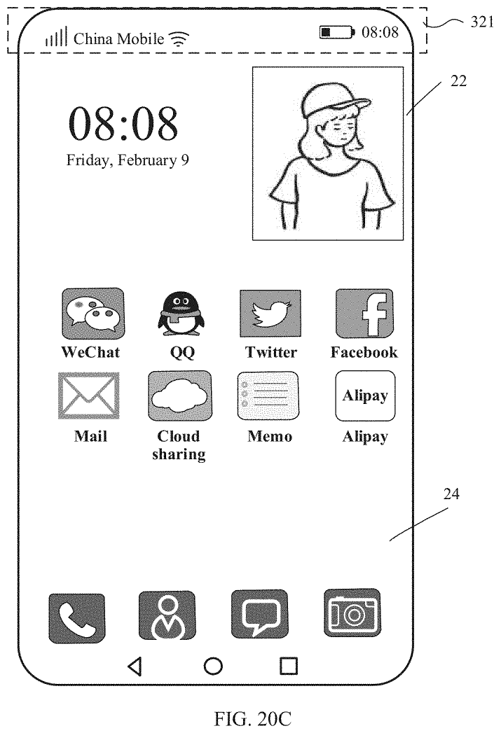

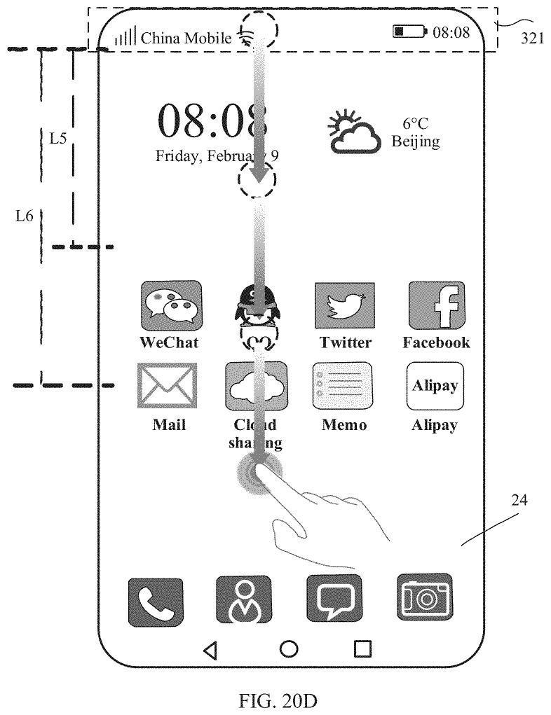

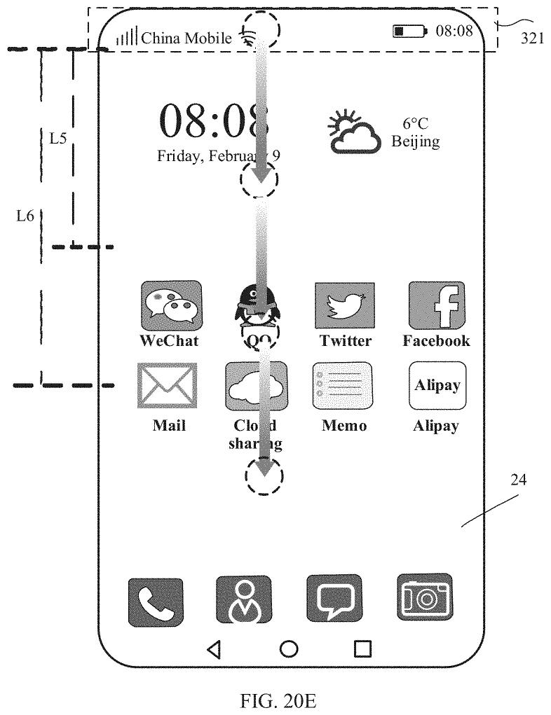

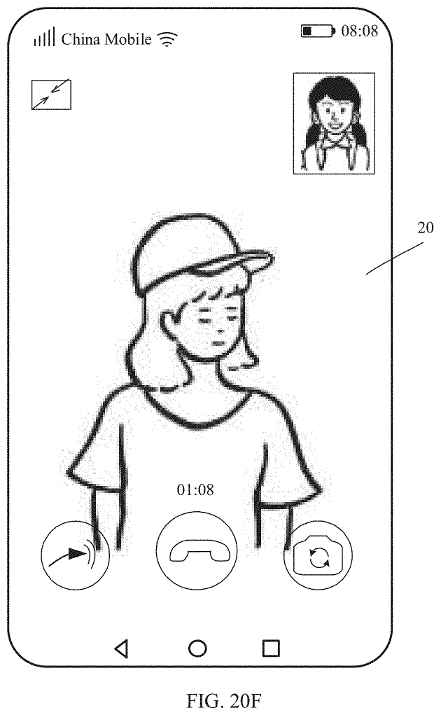

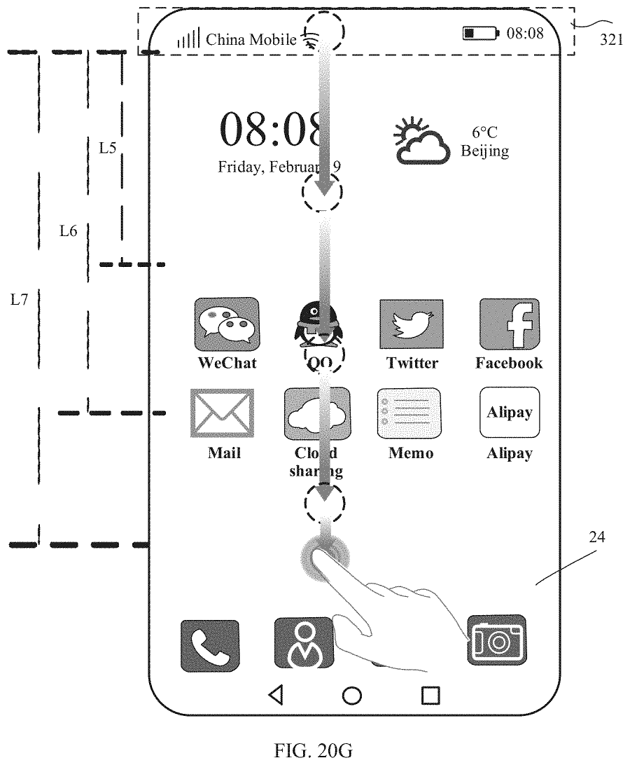

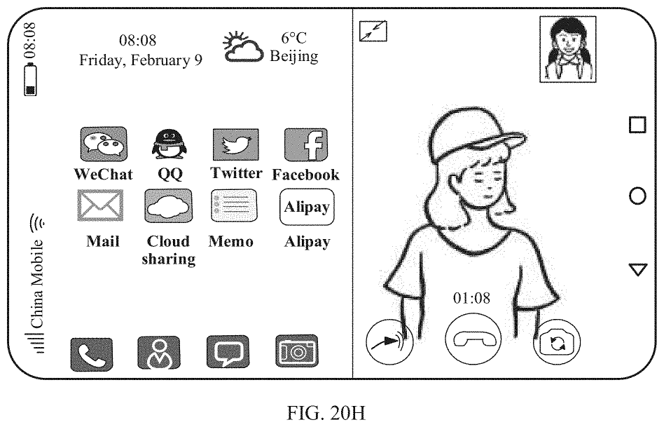

For example, a value of the sixth distance threshold is L6, and a value of the seventh distance threshold is L7. As shown in FIG. 20A and FIG. 20B, after the user operation shown in FIG. 19C, the finger of the user continues to slide downward, and when the finger of the user stops sliding and stops touching the display 194, a distance by which the finger of the user slides downward is greater than the fifth distance threshold and less than the sixth distance threshold. As shown in FIG. 20C, when the electronic device 100 detects the user operation, in response to the user operation, the electronic device 100 re-invokes the floating window 22, and displays the floating window 22 at a preset location on the display 194. As shown in FIG. 20D and FIG. 20E, after the user operation shown in FIG. 20A, the finger of the user continues to slide downward, and when the finger of the user stops sliding and stops touching the display 194, a distance by which the finger of the user slides downward is greater than the sixth distance threshold and less than the seventh distance threshold. As shown in FIG. 20F, when the electronic device 100 detects the user operation, in response to the user operation, the electronic device 100 displays, in full screen mode, the video call interface 20 corresponding to the floating window 22. As shown in FIG. 20G and FIG. 20H, after the user operation shown in FIG. 20D, the finger of the user continues to slide downward. When the electronic device 100 detects that a distance by which the finger of the user slides downward reaches the seventh distance threshold, in response to the user operation, the electronic device 100 displays, in split-screen mode, the video call interface 20 corresponding to the floating window 22.

It should be noted that, in addition to a split-screen interface shown in FIG. 20H, in a specific implementation, there may be another form of split-screen interface. This is not specifically limited herein.

In some embodiments of this application, the status bar 321 in the user interface may be divided into two parts: a first preset area and a second preset area. Widths of the status bar, the first preset area, and the second preset area in the second user interface are the same.

In some optional embodiments, the second user operation may be that the finger of the user slides on the display 194, a sliding start point is in the first preset area in the area in which the status bar 321 is located, a sliding trend is sliding toward the bottom of the electronic device 100, and when a distance by which the finger of the user slides downward is less than an eighth distance threshold, the finger of the user stops sliding and stops touching the display 194. The third user operation may be that the finger of the user slides on the display 194, a sliding start point is in the first preset area in the area in which the status bar 321 is located, a sliding trend is sliding toward the bottom of the electronic device 100, and when a distance by which the finger of the user slides downward is greater than or equal to the eighth distance threshold, the finger of the user stops sliding and stops touching the display 194. Alternatively, the third user operation may be that the finger of the user slides on the display 194, a sliding start point is in the first preset area in the area in which the status bar 321 is located, a sliding trend is sliding toward the bottom of the electronic device 100, and a distance by which the finger of the user slides downward reaches the eighth distance threshold. The fifth user operation may be that the finger of the user slides on the display 194, a sliding start point is in the second preset area in the area in which the status bar 321 is located, a sliding trend is sliding toward the bottom of the electronic device 100, and when a distance by which the finger of the user slides downward is less than the fifth distance threshold, the finger of the user stops sliding and stops touching the display 194. The fourth user operation may be that the finger of the user slides on the display 194, a sliding start point is in the second preset area in the area in which the status bar 321 is located, a sliding trend is sliding toward the bottom of the electronic device 100, and when a distance by which the finger of the user slides downward is greater than or equal to the fifth distance threshold, the finger of the user stops sliding and stops touching the display 194. Alternatively, the fourth user operation may be that the finger of the user slides on the display 194, a sliding start point is in the second preset area in the area in which the status bar 321 is located, a sliding trend is sliding toward the bottom of the electronic device 100, and a distance by which the finger of the user slides downward reaches the fifth distance threshold.

In some embodiments of this application, a notch of a notch screen or a small hole of a hole-punch display is located at a middle location of an upper edge of the display, and the status bar 321 in the second user interface is divided into left and right parts by using the notch or the small hole as a division point; and the first preset area is a left half part of the status bar 321 in the second user interface, and the second preset area is a right half part of the status bar 321 in the second user interface; or the first preset area is a right half part of the status bar 321 in the second user interface, and the second preset area is a left half part of the status bar 321 in the second user interface.

The notch screen refers to a screen design in which a notch is disposed on the display 194, and the notch may be located at a middle location of an upper edge of the touch display 194. In some embodiments of this application, the notch is configured to accommodate at least one front panel component, and the front panel component includes at least one of a camera, an optical proximity sensor, a distance sensor, an earpiece, and an ambient light sensor.

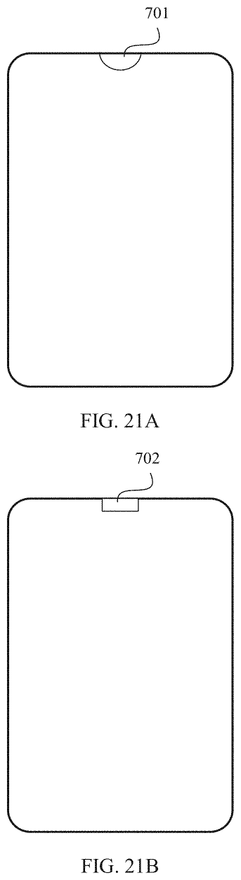

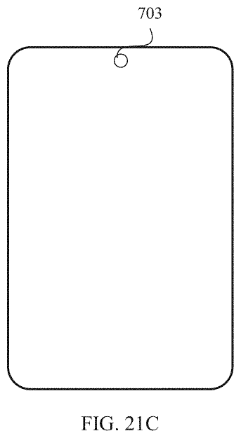

In some embodiments of this application, the notch on the upper edge of the display 194 that is the notch screen may be a semicircular notch, a right-angled rectangular notch, a rounded rectangular notch, or an irregular-shaped notch. For example, as shown in FIG. 21A, the notch screen may refer to a screen design in which a semicircular notch 701 is disposed at a central location of an upper edge of the display 194. For example, as shown in FIG. 21B, the notch screen may refer to a screen design in which a rectangular notch 702 is disposed at a central location of an upper edge of the display 194.

The hole-punch display may refer to a screen design in which at least one small hole 46 is disposed in an upper half part of the display 194, and a location of the small hole 46 is used to accommodate at least one front panel component of a camera, a distance sensor, an earpiece, and an ambient light sensor.

For example, as shown in FIG. 21C, the hole-punch display may refer to a screen design in which a small hole 703 is disposed at a middle location of an upper edge of the display 194. The hole-punch display may also be referred to as a water drop-shaped notch screen or a water drop screen.

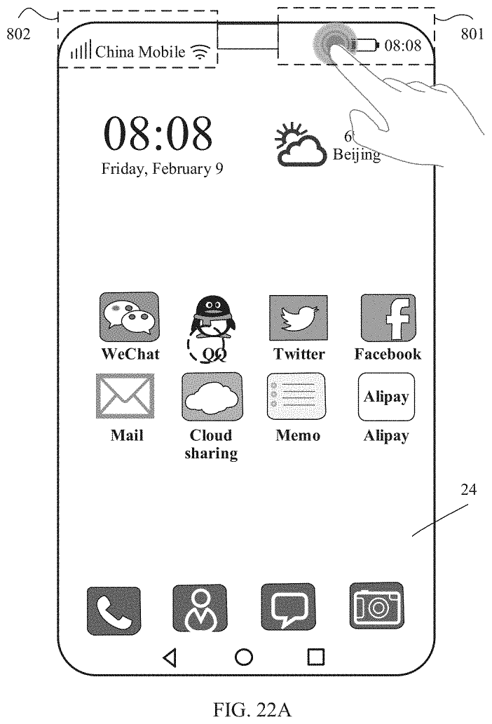

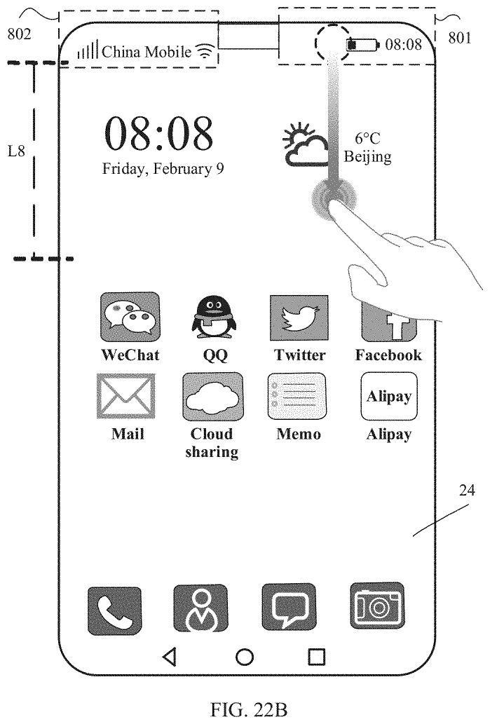

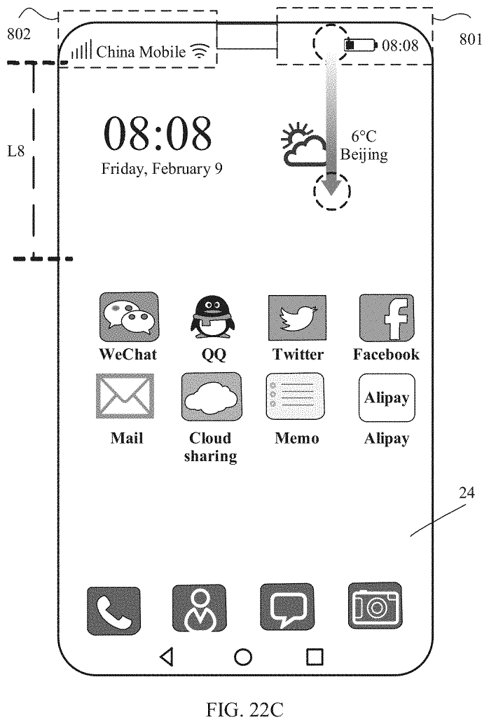

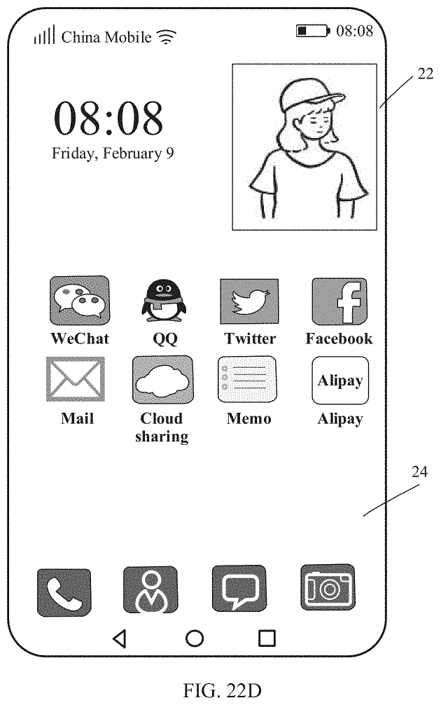

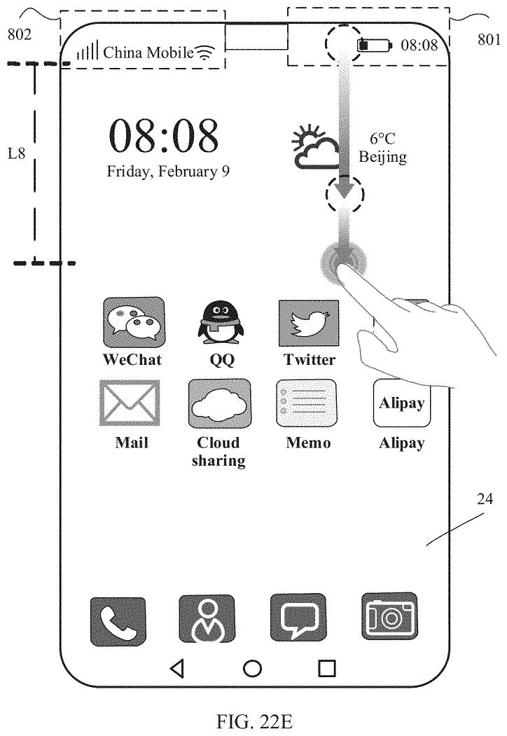

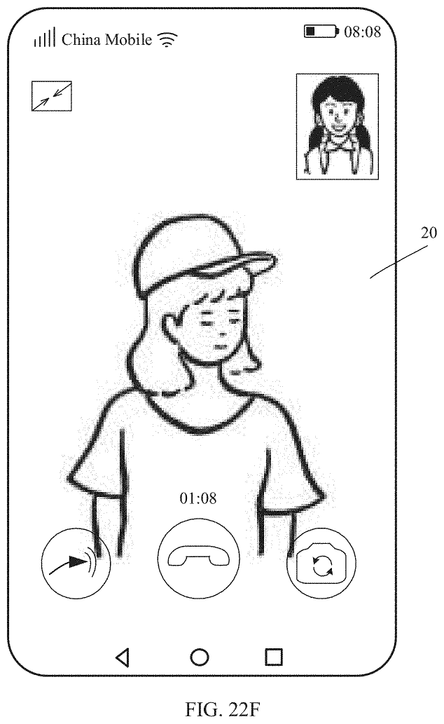

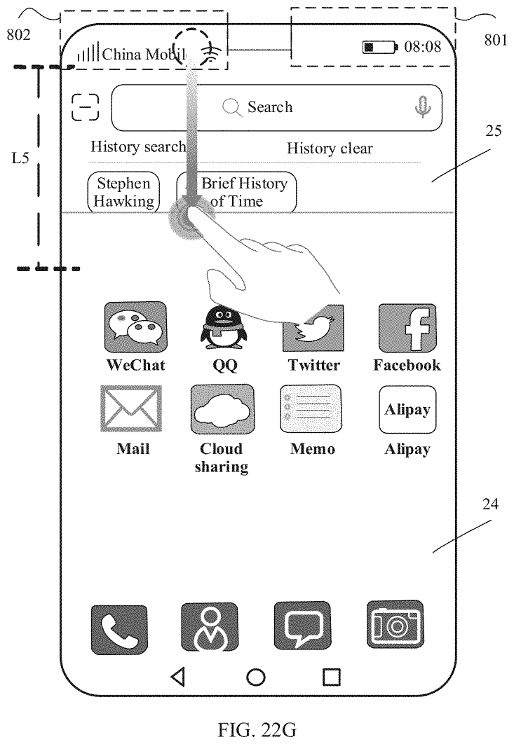

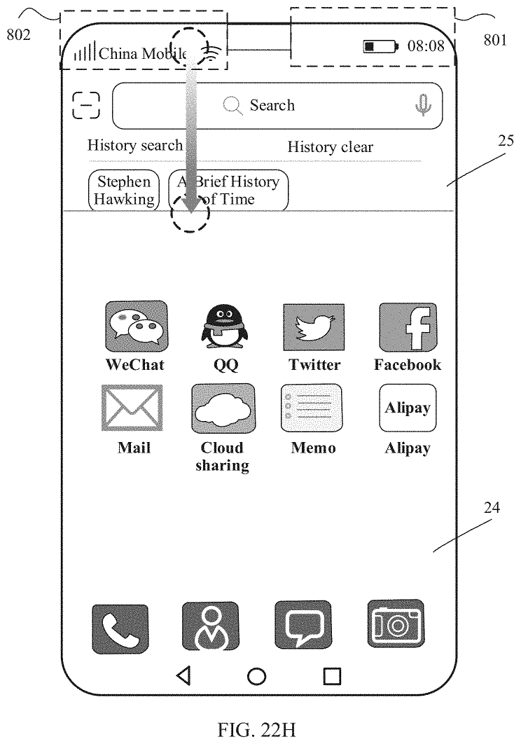

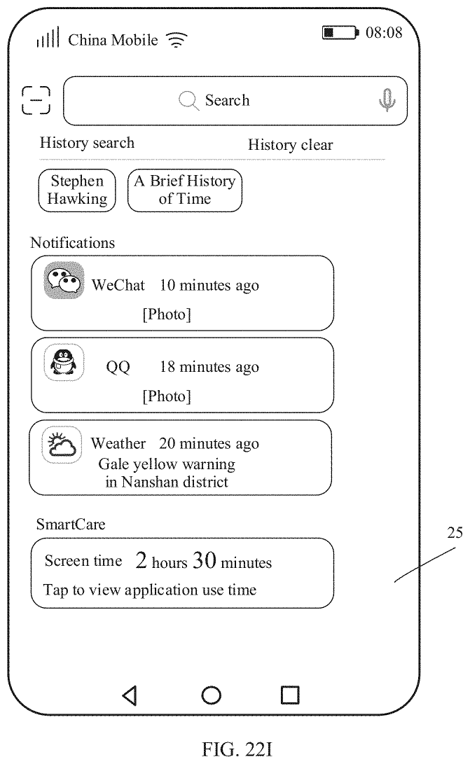

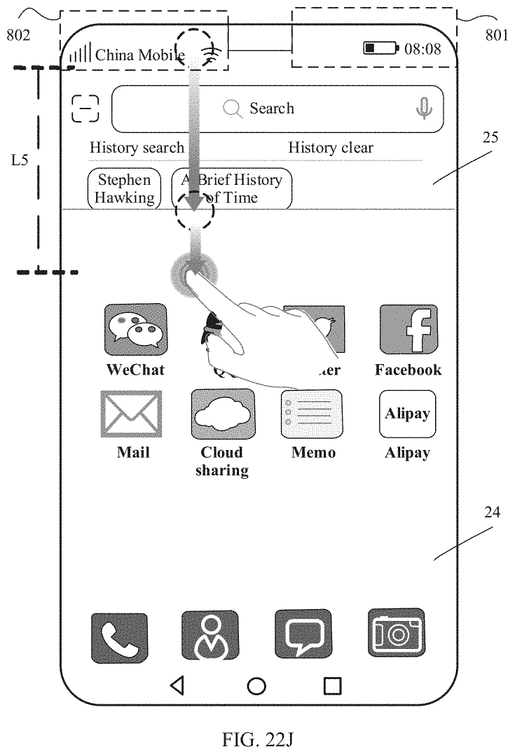

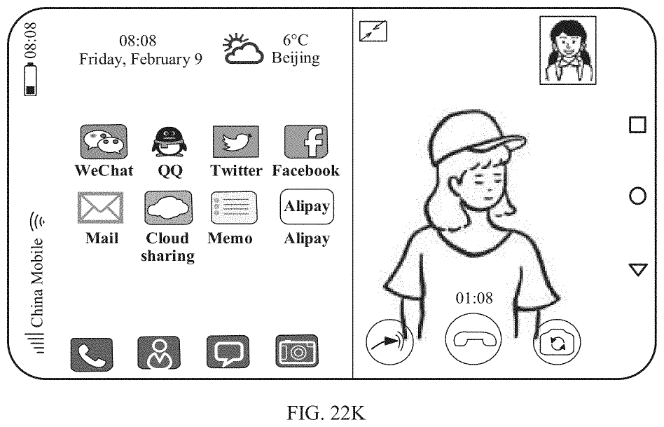

For example, a value of the eighth distance threshold is L8. As shown in FIG. 22A, FIG. 22B, FIG. 22C, and FIG. 22D, the finger of the user slides downward from the second preset area 802 of the status bar 321 on the display 194, and when a distance by which the finger of the user slides downward is less than the eighth distance threshold, the finger of the user stops sliding and stops touching the display 194. When the electronic device 100 detects the user operation, in response to the user operation, the electronic device 100 displays the floating window 22 at a preset location on the display 194. As shown in FIG. 22E and FIG. 22F, after the user operation shown in FIG. 22F, the finger of the user continues to slide downward, and when the electronic device 100 detects that a distance by which the finger of the user slides downward reaches the eighth distance threshold, in response to the user operation, the electronic device 100 displays, on the display 194 in full screen mode, the video call interface 20 corresponding to the floating window 22. For example, as shown in FIG. 22G. FIG. 22H, and FIG. 22I, the finger of the user slides downward from the second preset area 802 of the status bar 321 on the display 194, when a distance by which the finger of the user slides downward is less than the fifth distance threshold, the finger of the user stops sliding and stops touching the display 194, and when the electronic device 100 detects the user operation, in response to the user operation, the electronic device 100 displays the system notification bar interface 25 in full screen mode. As shown in FIG. 22J and FIG. 22K, after the user operation in FIG. 22G, the finger of the user continues to slide downward, and when the electronic device 100 detects that a distance by which the finger of the user slides downward reaches the fifth distance threshold, in response to the user operation, the electronic device 100 displays, in split-screen mode, the video call interface 20 corresponding to the floating window 22.

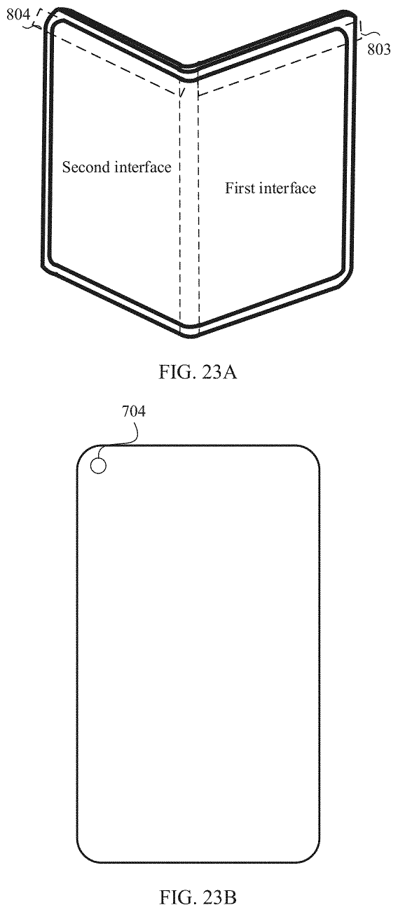

In some embodiments of this application, as shown in FIG. 23A, the display 194 may be divided into two parts: a first interface and a second interface by using a folding track of a foldable screen as a division line; and the first preset area is a status bar area 803 in the first interface, and the second preset area is a status bar area 804 in the second interface; or the first preset area is a status bar area 804 in the second interface, and the second preset area is a status bar area 803 in the first interface.

In some embodiments of this application, an area in which a small hole of the hole-punch display is located is used as a trigger point, and the finger of the user approaches, in a floating manner (or through single-tapping), the area in which the small hole of the hole-punch display is located. When the electronic device 100 detects the user operation, in response to the user operation, the electronic device 100 displays a menu navigation window on the display 194. The menu navigation window includes at least a first option control and a second option control. The first option control is configured to trigger the electronic device 100 to re-invoke the floating window. The second option control is configured to trigger the electronic device 100 to re-invoke the floating window, and display, in full screen mode, the video call interface 20 corresponding to the floating window 22. The second user operation may be that the finger of the user single-taps the first option control. The third user operation may be that the finger of the user single-taps the second option control.

For example, as shown in FIG. 23B, the hole-punch display may alternatively refer to a screen design in which a small hole 704 is disposed on the left of an upper edge of the display 194.

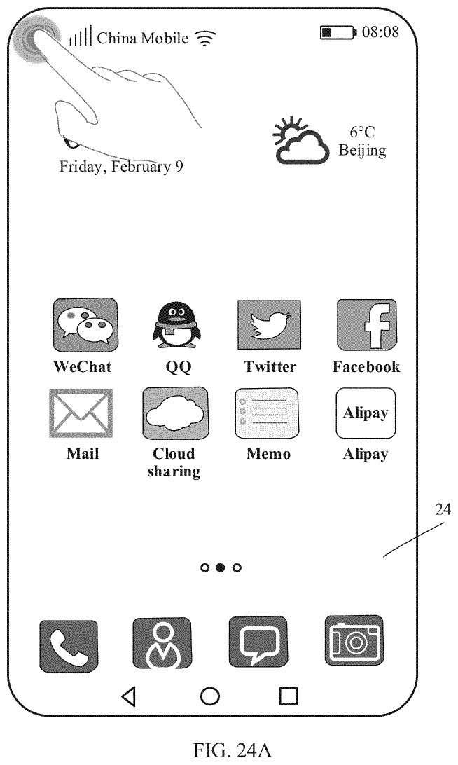

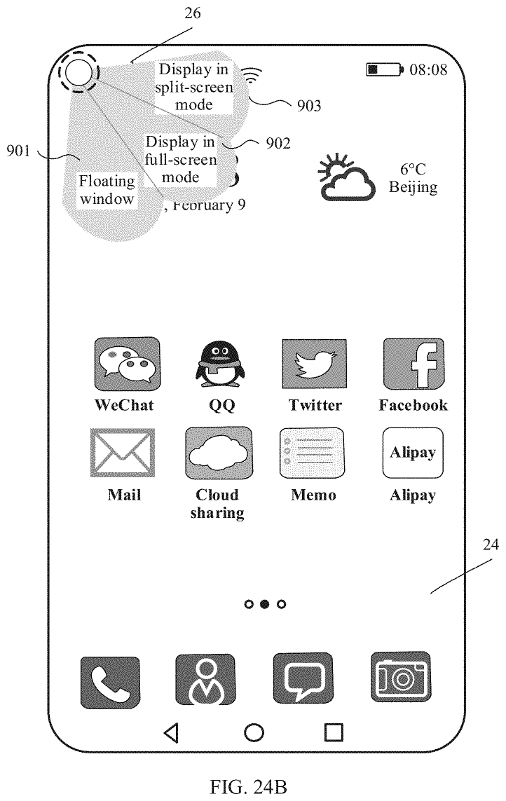

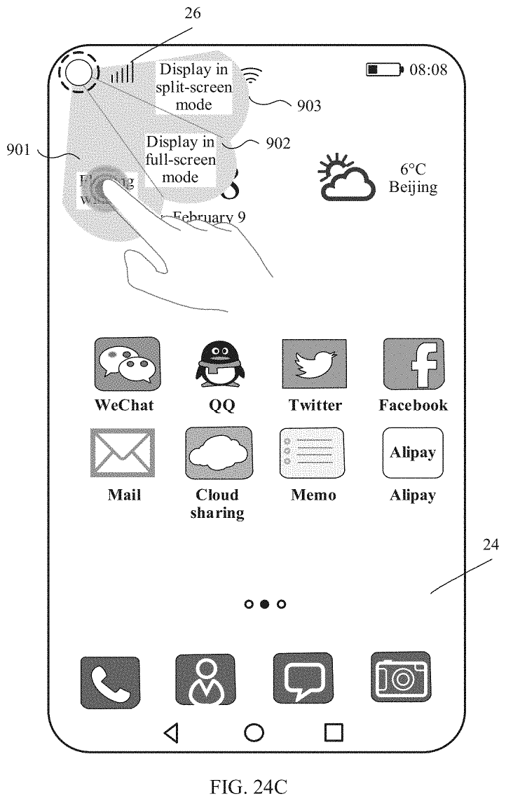

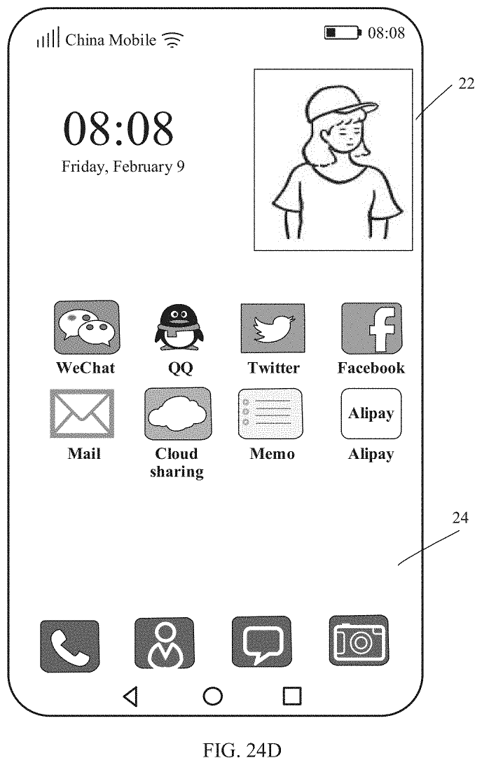

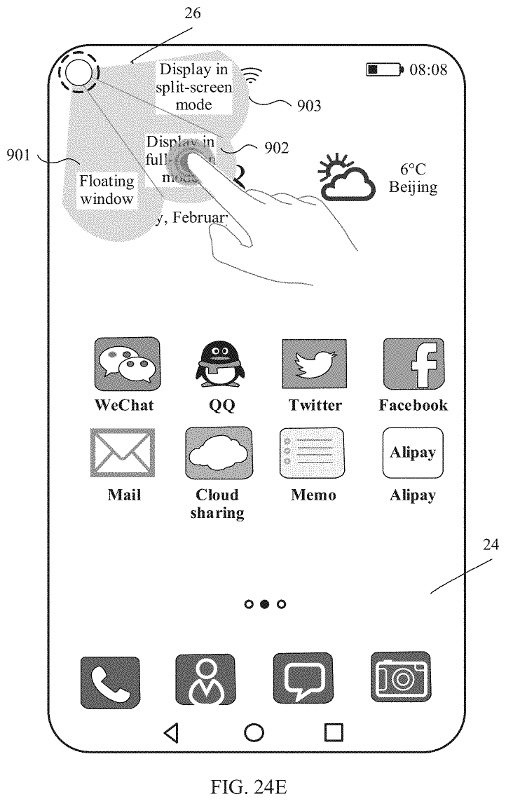

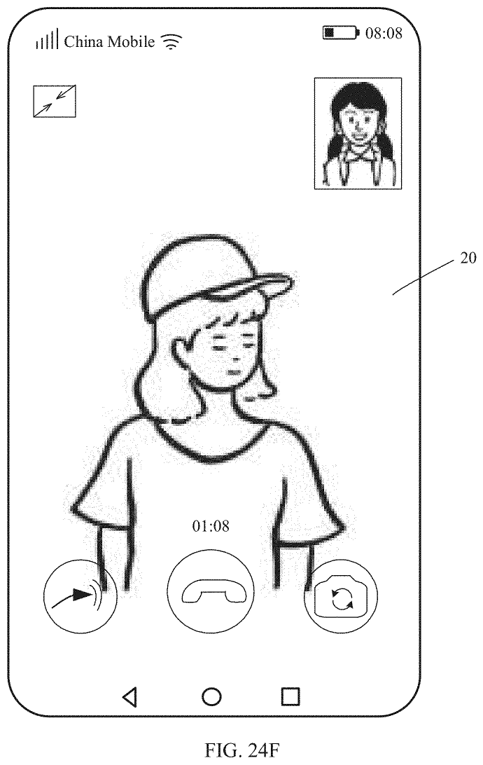

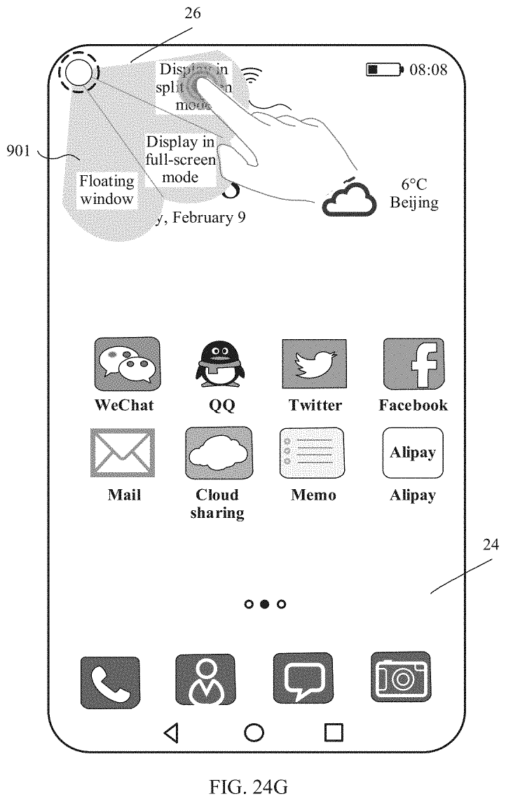

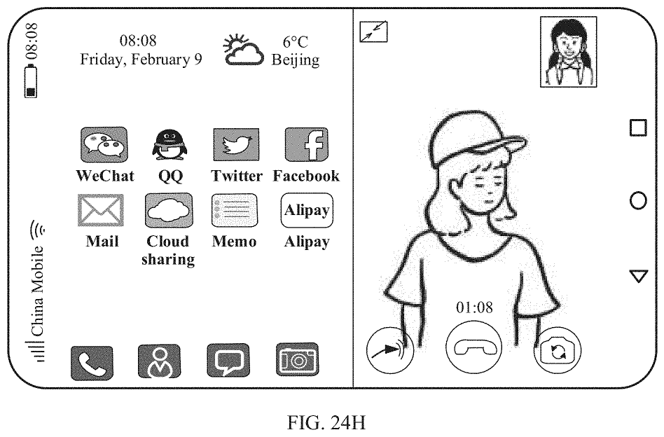

For example, as shown in FIG. 24A and FIG. 24B, the finger of the user single-taps an area in which a small hole of the hole-punch display is located, and the finger of the user touches touch points around the small hole of the display. When the electronic device 100 detects the user operation, in response to the user operation, the electronic device 100 displays a menu navigation window 26 on the display 194. The menu navigation window 26 includes a first option control 901, a second option control 902, and a third option control 903. As shown in FIG. 24C and FIG. 24D, the finger of the user touches the first option control 901. When the electronic device 100 detects the user operation, in response to the user operation, the electronic device 100 displays the floating window 22 at a preset location on the display 194. As shown in FIG. 24E and FIG. 24F, the finger of the user single-taps the second option control 902. When the electronic device 100 detects the user operation, in response to the user operation, the electronic device 100 displays, in full screen mode, the video call interface 20 corresponding to the floating window 22. As shown in FIG. 24G and FIG. 24H, the finger of the user single-taps the third option control 903. When the electronic device 100 detects the user operation, in response to the user operation, the electronic device 100 displays, in split-screen mode, the video call interface 20 corresponding to the floating window 22.

In addition to the foregoing user operation used to re-invoke the floating window 22, in a specific implementation, there may be another user operation to re-invoke the floating window 22.

For example, the user may re-invoke the floating window 22 by pressing the button 190.

Specifically, the button 190 used to re-invoke the floating window 22 may include any one or more of a volume up button, a volume down button, and a power button. A location of each button on the electronic device 100 is shown in FIG. 15. A manner of re-invoking the floating window 22 by pressing the button 190 is similar to a manner of hiding the floating window 22 by pressing the button 190. Details are not described herein again.

For example, the user may re-invoke the floating window 22 by using a voice.

Specifically, the electronic device 100 may collect, by using a microphone, the voice entered by the user, for example, specific content of the voice is “Please re-invoke the floating window”; compare the specific content “Please re-invoke the floating window” of the collected voice with a pre-stored voice keyword “Please re-invoke the floating window”, and compare a voice feature of the collected voice with a pre-stored voice feature of an owner; and re-invoke the floating window if the specific content of the voice is the same as the pre-stored voice keyword and a degree of matching between the voice feature of the collected voice and the voice feature of the owner exceeds a specific threshold. The floating window is re-invoked by using the voice. Therefore, the operation is simple and convenient. In addition, because another person cannot imitate the voice feature of the owner, the hidden floating window cannot be invoked randomly, and security is high. The foregoing manner of re-invoking the floating window is merely used an example for description. Actually, the floating window may alternatively be re-invoked in another manner, for example, a specific pattern is entered in a specific area in the user interface. This is not limited in this embodiment of this application.

According to this application, when displaying a floating window used for a video call, the electronic device 100 may hide the floating window based on a user operation, and the electronic device 100 may further re-invoke the hidden floating window based on a user operation. In addition, in the foregoing process, when the electronic device 100 continuously keeps the video call, the floating window is prevented from blocking the user interface, to improve convenience of the user operation.

The floating window management method provided in this application may be further applied to a voice call scenario.

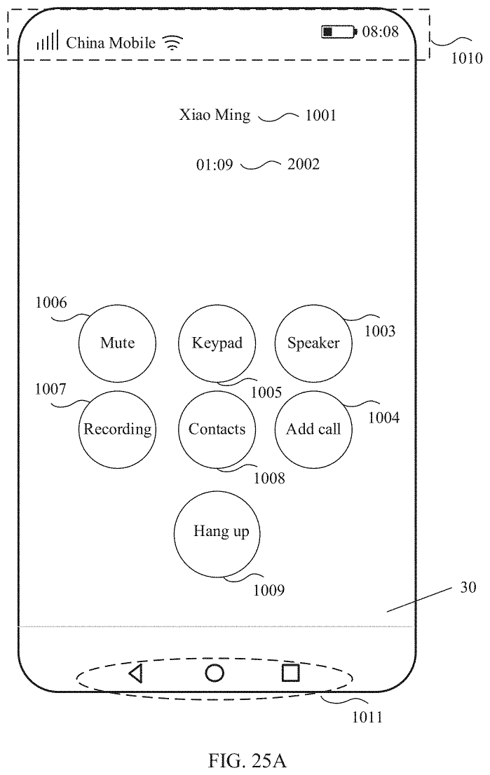

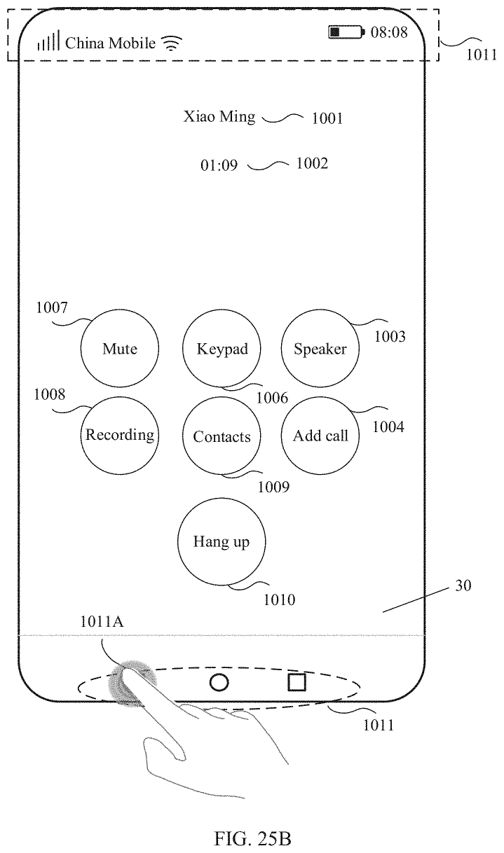

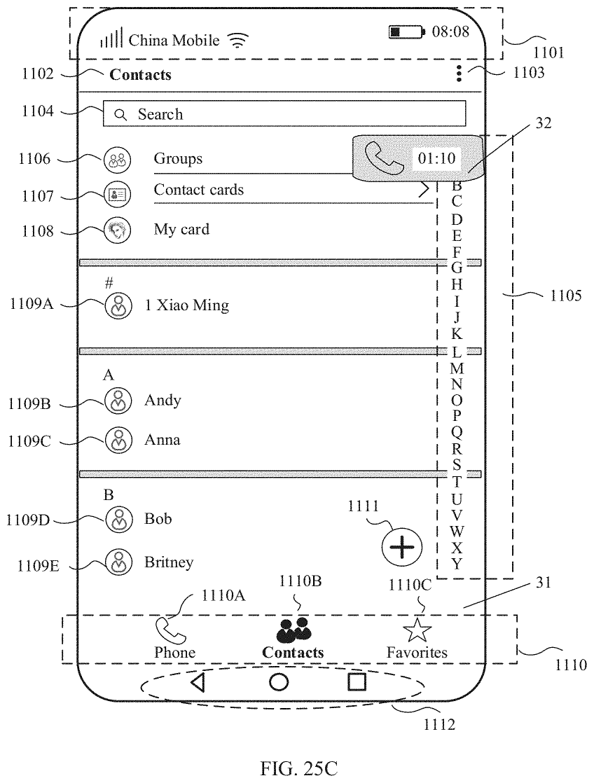

FIG. 25A shows an example user interface 30 used for a call. The user interface may be a user interface opened by a user by tapping a dial control in a contact interface included in the Contacts. The Contacts includes one or more phone numbers of one or more contacts. In addition, the user may tap a dial control after entering a phone number on a dialer screen, to open the user interface used for the call.

As shown in FIG. 25A, the user interface 30 used for the call may include a contact identifier 1001, a call duration indicator 1002, a speaker control 1003, an add call control 1004, a keypad control 1005, a mute control 1006, a recording control 1007, a contacts control 1008, a hang-up control 1009, a status bar 1010, and a navigation bar 1011.

The contact identifier 1001 is used to indicate an identity of a current call object.

The call duration indicator 1002 is used to indicate duration of a current call.

The speaker control 1003 is configured to switch a speaker working status. The speaker working status includes on and off. If the speaker working status is off, when the electronic device 100 detects a touch operation performed on the speaker control 1003 (for example, a tap operation on the speaker control 1003), the electronic device 100 may switch the speaker working status from off to on in response to the operation, and vice versa.

The add call control 1004 is configured to add a call. When the electronic device 100 may detect a touch operation performed on the add call control 1004 (for example, a tap operation on the add call control 1004), the electronic device 100 may display an add call user interface in response to the operation.

The keypad control 1005 is configured to open a keypad. When the electronic device 100 may detect a touch operation performed on the keypad control 1005 (for example, a tap operation on the keypad control 1005), the electronic device 100 may display the keypad in the user interface 30 in response to the operation.

The mute control 1006 is configured to turn on or turn off a microphone. If the microphone is in an on state, when the electronic device 100 detects a touch operation performed on the mute control 1006 (for example, a tap operation on the mute control 1006), the electronic device 100 may turn off the microphone in response to the operation, and vice versa.

The recording control 1007 is configured to start recording. When the electronic device 100 may detect a touch operation performed on the recording control 1007 (for example, a tap operation on the recording control 1006), the electronic device 100 may start recording in response to the operation.

The contacts control 1008 is configured to open the Contacts. When the electronic device 100 may detect a touch operation performed on the contacts control 1008 (for example, a tap operation on the contacts control 1008), the electronic device 100 may display information about at least one contact in response to the operation.

The hang-up control 1009 is configured to disconnect the call. When the electronic device 100 may detect a touch operation performed on the hang-up control 1009 (for example, a tap operation on the hang-up control 1009), the electronic device 100 may disconnect the call in response to the operation.

The status bar 1010 is the same as the status bar 207 in the user interface 20. Details are not described herein.

The navigation bar 1011 is the same as the navigation bar 208 in the user interface 20. Details are not described herein.

For example, a current user interface is the user interface 30 used for the voice call. As shown in FIG. 25B and FIG. 25C, when the electronic device 100 detects a tap operation performed on a return button 2011A, in response to the operation, the electronic device 100 displays both a contact list interface 31 and a floating window 32, and displays duration of a current voice call in the floating window 32. As shown in the figure, the floating window 32 is displayed in the contact list interface in a floating manner in a form of an icon.

The following describes the user interface 31 provided in the example UI embodiment shown in FIG. 25C. The user interface 31 may be a user interface opened by the user by tapping the return button 1011A in FIG. 23A.

As shown in FIG. 25C, the electronic device may display the user interface 31 on the display in full screen mode. The user interface 31 may include a status bar 1101 and a user interface used to display one or more contact entries.

For the status bar 1101, refer to the status bar 207 in the user interface 20 shown in FIG. 2A. Details are not described herein again.

The user interface used to display one or more contact entries may include an application title bar 1102, a control 1103, a search box 1104, a letter display bar 1105, a “Groups” entry 1106, a “Contact cards” entry 1107, a “My card” entry 1108, one or more contact entries such as 1109A to 1109E, a menu 1110, and a control 1111.

The application title bar 1102 may be used to indicate that a current page is used to display one or more pieces of contact information stored in the electronic device. The application title bar 1102 may be represented in a form of text information “Contacts” or a form of an icon, or in another form.

The control 1103 may receive a user operation (for example, a touch operation). In response to the detected user operation, the electronic device may display another control, for example, a control used to set a contact home page.

The “Groups” entry 1106 may receive a user operation (for example, a touch operation). In response to the detected user operation, the electronic device may display information about one or more groups created by the user. One group includes one or more contacts.

The “Contact cards” entry 1107 may receive a user operation (for example, a touch operation). In response to the detected user operation, the electronic device may display information carried in one or more paper business cards that are found (for example, found through a camera).

The “My card” entry 1108 may receive a user operation (for example, a touch operation). In response to the detected user operation, the electronic device may display information about a card of the user that is created by the user.

The contact entry is used to display one or more pieces of contact information stored in the electronic device. The contact information may include an avatar, a name, a nickname, a phone number, and the like. When a plurality of contact entries are displayed in the user interface used to display one or more contact entries, the plurality of contact entries may be arranged from top to bottom in an order of initials of contact names from “A” to “Z”. The user may slide up and down an area used to display the contact entries in the user interface 31, so as to view more contact entries.

The menu 1110 includes a control 1110A, a control 1110B, and a control 1110C. Content displayed in the user interface used to display one or more contact entries is related to a currently selected control in the menu 1110. As shown in FIG. 5A, in the current menu 1110, if the control 1110B is selected, the user interface 31 is used to display one or more contact entries stored in the electronic device; if the control 1110A is selected, that is, when the control 1110A receives a user operation (for example, a touch operation), the electronic device may display a dialer screen in response to the detected user operation; and if the control 1110C is selected, that is, when the control 1110C receives a user operation (for example, a touch operation), the electronic device may display information about a favorite contact in response to the detected user operation.

The control 1111 may receive a user operation (for example, a touch operation). In response to the detected user operation, the electronic device may display an interface used to add a new contact.

The navigation bar 1112 is the same as the navigation bar 208 in the user interface 20. Details are not described herein.

In this scenario, after the electronic device 100 exits the voice call interface 30, although the floating window 32 displayed by the electronic device 100 on the display 194 is presented in a form of an icon, the floating window 41 still blocks a user interface currently displayed on the display 194. The user may intend to hide the floating window 32, and keep the floating window running in the background, so that the user can re-invoke the floating window later.

Based on the foregoing voice call scenario, the following describes, from two aspects, some user interface embodiments implemented on the electronic device 100.

Aspect 1: How to hide the floating window 32.

In some embodiments of this application, the finger of the user slides on the display 194, to drag the floating window 32 to an area in which the status bar 1101 is located. A sliding start point of the finger of the user is in an area in which the floating window 32 is located, and a sliding trend of the finger of the user is sliding toward the top of the home screen. When the electronic device 100 detects the user operation, in response to the user operation, the electronic device 100 stops displaying the floating window 32.

In some embodiments of this application, the finger of the user drags the floating window 80 to the area in which the status bar 1101 is located. After an upper edge of the floating window 32 coincides with a lower edge of the status bar 1101, the electronic device 100 may hide the floating window 80.

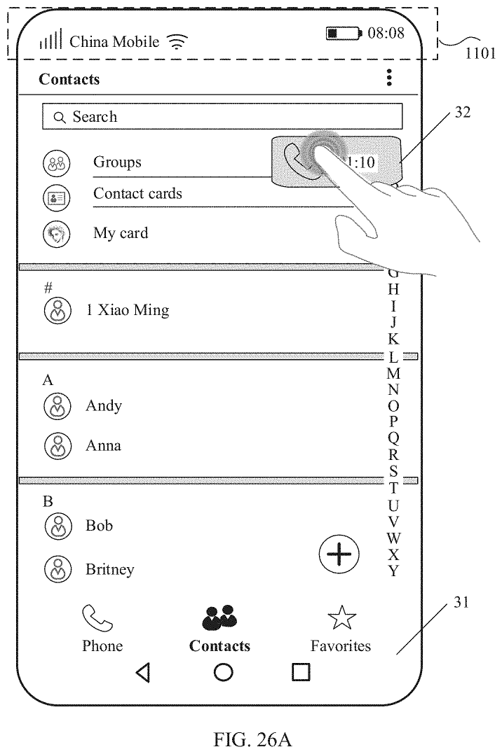

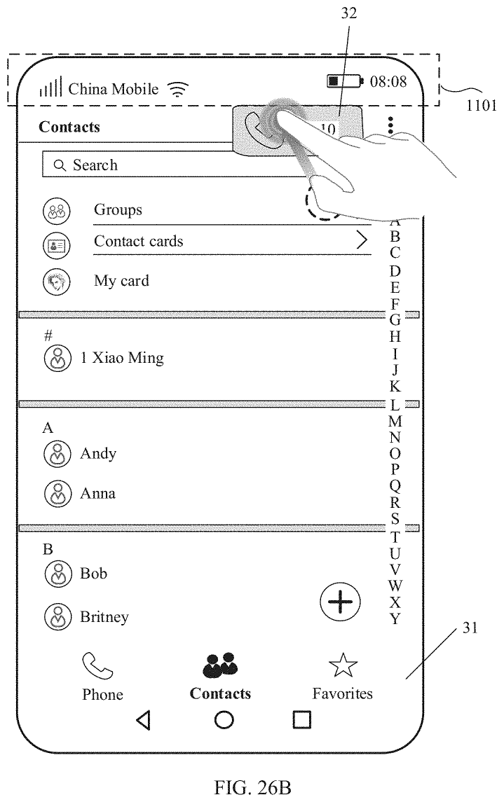

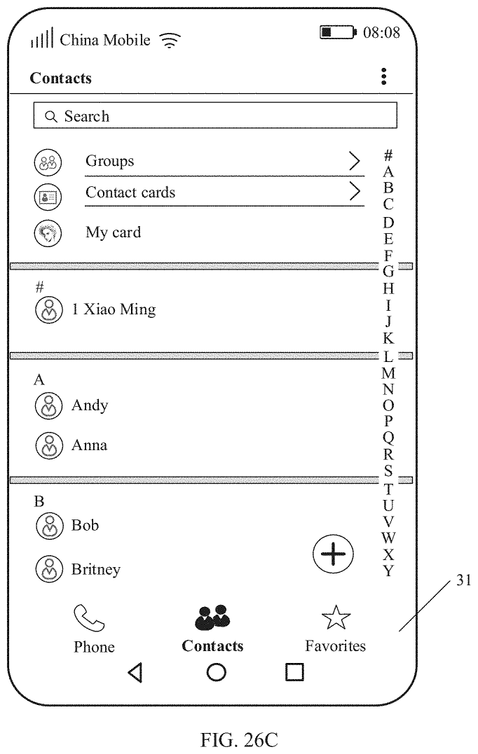

For example, as shown in FIG. 26A and FIG. 26B, the finger of the user slides on the display 194, to drag the floating window 80 to move in the contact list interface, until the upper edge of the floating window 32 coincides with the lower edge of the status bar 207. A sliding start point of the finger of the user is in the area in which the floating window 32 is located. As shown in FIG. 26C, when the electronic device 100 detects the user operation, in response to the user operation, the electronic device 100 stops displaying the floating window 32, and the electronic device 100 keeps the floating window 32 running in the background.

In this application, a user operation used to trigger the electronic device 100 to hide the floating window 32 may be preset by a system of the electronic device 100, or may be set by the user based on an operation habit of the user.

In the foregoing voice call scenario, for the user operation used to hide the floating window 32, refer to the first user operation in the video call scenario. Details are not described herein again.

Aspect 2: How to re-invoke the floating window 32.

It may be understood that after the user hides the floating window 32, the display 194 may display the contact list interface. Before the user re-invokes the floating window, the electronic device may receive a user operation performed by the user on the contact list interface. For example, the contact list interface is switched to a second user interface. In this case, a current user interface displayed on the display 194 of the electronic device 100 is the second user interface. If the electronic device 100 detects a user operation used to re-invoke the floating window 32, in response to the user operation, the electronic device 100 displays the floating window 32 in the second user interface in a floating manner. The second user interface may be the same as or may be different from the contact list interface. The following describes, by using an example m which the second user interface may be the same as the contact list interface, how to re-invoke the hidden floating window.

In some embodiments of this application, when the electronic device 100 may detect a user operation performed on the contact list interface (for example, the user single-taps the status bar 1101 in the contact list interface), the electronic device 100 may re-invoke the floating window 32 in response to the user operation. In addition to single-tapping the status bar 1101 in the contact list interface, the user operation may be double-tapping the status bar 1101 in the contact list interface, touching and holding the status bar 1101 in the contact list interface, or the like. Herein, the tap operation and the touch and hold operation may be performed by using one or more knuckles, a finger pad, a fingertip, a stylus, or the like.

It may be understood that when the electronic device 100 detects the user operation used to hide the floating window 32, the electronic device 100 first determines whether there is a hidden floating window (that is, the floating window running in the background), and if there is the hidden floating window, in response to the user operation, the electronic device 100 re-invokes the hidden floating window 32, and displays the floating window 32 at a preset location on the display 194.

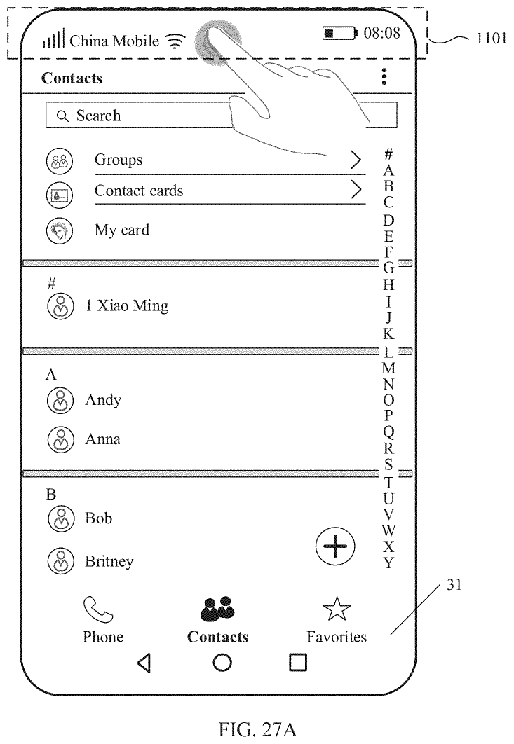

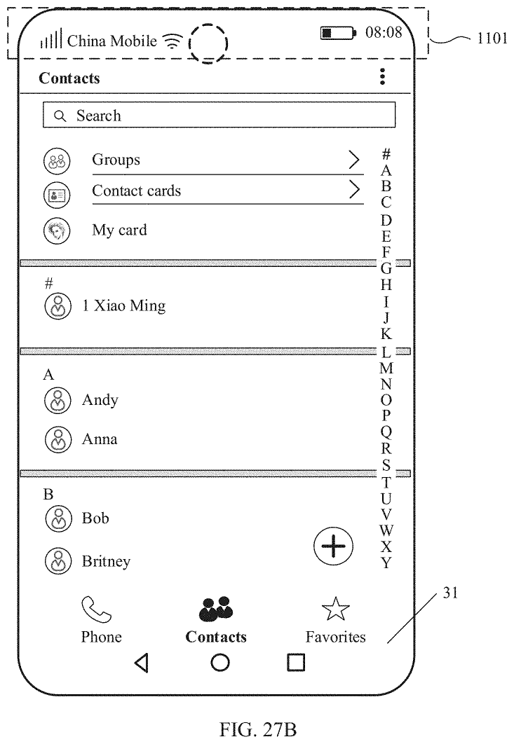

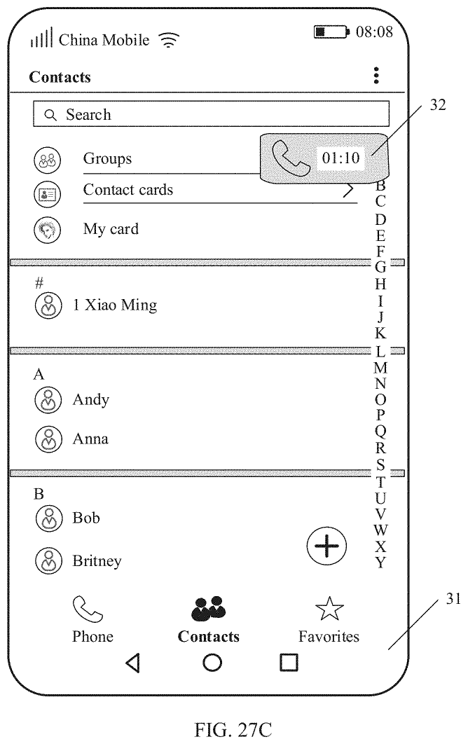

For example, as shown in FIG. 27A. FIG. 27B, and FIG. 27C, the finger of the user single-taps the area in which the status bar 1101 is located on the display 194. As shown in FIG. 27C, when the electronic device 100 detects the user operation, the electronic device 100 displays the floating window 32 at a preset location on the display 194.

In this application, the user operation used to trigger the electronic device 100 to re-invoke the floating window 32 may be preset by the system of the electronic device 100, or may be set by the user based on an operation habit of the user.

In the foregoing voice call scenario, for the user operation used to re-invoke the floating window 32, refer to the second user operation in the video call scenario. Details are not described herein again.

The floating window management method provided in this application may be further applied to a video playing scenario.

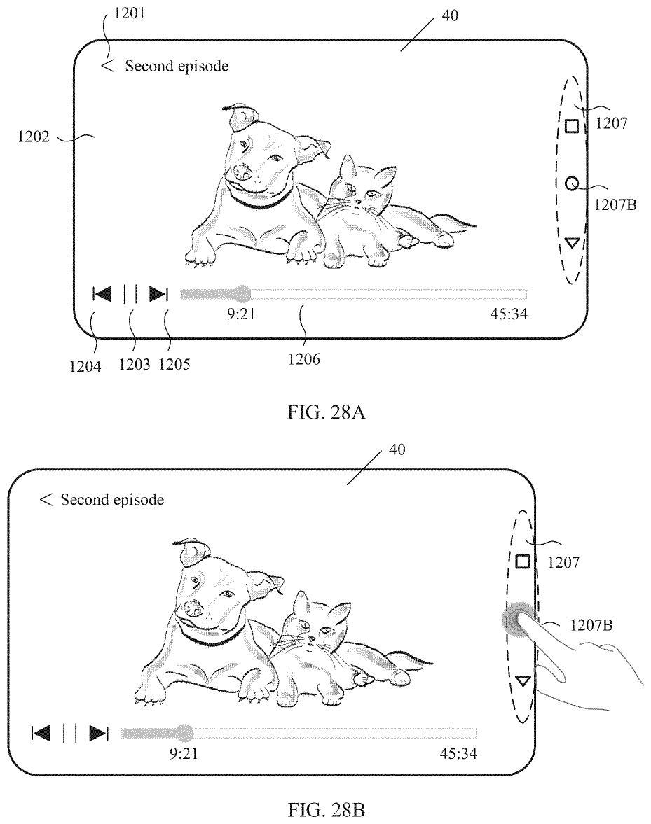

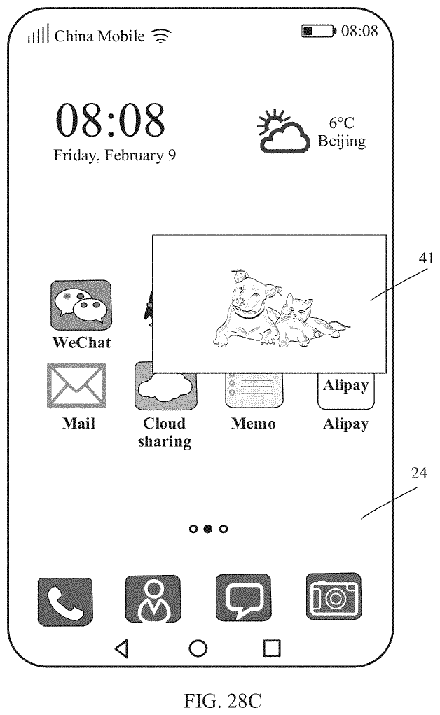

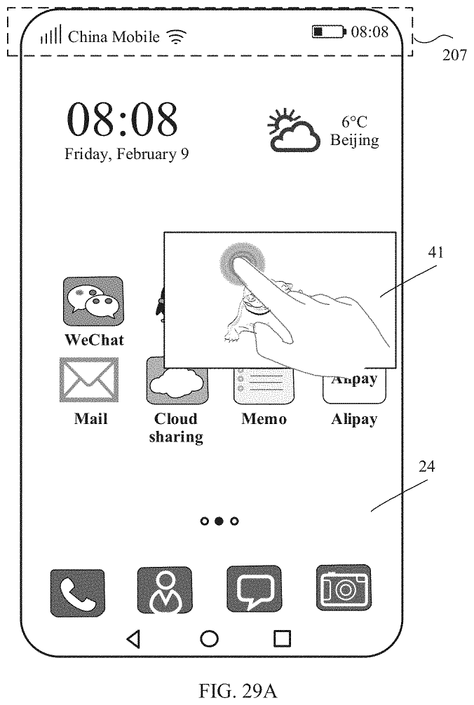

FIG. 28A shows an example video playing interface 40 displayed in full screen mode. The user interface may be a user interface provided by video playing software (for example, iQIYI or Youku).

In some embodiments of this application, displaying the video playing interface 40 in full screen mode means that the display 194 displays only the video playing interface 40 and does not display other content. In a possible implementation, when the video playing interface 40 is displayed in full screen mode, the video playing interface 40 may occupy an entire display area of the display 194. In another possible implementation, the video playing interface 40 may alternatively occupy only a part of a display area of the display 194. For example, when the display 194 is an abnormally cut screen (for example, a notch screen), the video interface is displayed in the middle of the abnormally cut screen, and an edge on one side or edges on both sides of the video interface are displayed in black, it may also be considered that the display 194 displays the video interface in full screen mode.

In some embodiments of this application, displaying the video playing interface 40 in full screen mode may mean that when displaying the video playing interface 40, the display 194 may further display a system-level interface element, for example, a status bar or a floating shortcut menu (for example, Assistive Touch of Apple). The status bar may include a name of an operator (for example, China Mobile), time, a Wi-Fi icon, signal strength, current remaining battery power, and the like.

As shown in FIG. 28A, in addition to the navigation bar 1207, the video playing interface 40 in which the user watches a video may further include an exit control 1201, a content display area 1202, a pause control 1203, a previous control 1204, a next control 1205, and a progress bar 1206.

The exit control 1201 may be configured to exit a current user interface. When the electronic device 100 may detect a touch operation performed on the exit control 1201 (for example, a tap operation on the exit control 1201), the electronic device 100 may exit the current user interface in response to the operation.

The content display area 1202 may be configured to display video content. In addition, the content display area 1202 may further adjust playing brightness and playing volume. When the electronic device 100 may detect a touch operation (for example, a slide-up operation or a slide-down operation) performed on a left side of the content display area 1202, the electronic device 100 may adjust (increase or decrease) current playing brightness in response to the operation. When the electronic device 100 may detect a touch operation (for example, a slide-up operation or a slide-down operation) performed on a right side of the content display area 1202, the electronic device 100 may adjust (increase or decrease) current playing volume in response to the operation.

The pause control 1203 may be configured to pause playing of a video. When the electronic device 100 may detect a touch operation performed on the pause control 1203 (for example, a tap operation on the pause control 1203), the electronic device 100 may pause playing of the video in response to the operation.

The previous control 1204 may be configured to switch played content to a previous episode. When the electronic device 100 may detect a touch operation performed on the previous control 1204 (for example, a tap operation on the previous control 1204), the electronic device 100 may switch the played content to the previous episode in response to the operation.

The next control 1205 may be configured to switch played content to a next episode. When the electronic device 100 may detect a touch operation performed on the next control 1205 (for example, a tap operation on the next control 505), the electronic device 100 may switch the played content to the next episode in response to the operation.

The progress bar 1206 is configured to display a current video playing progress, and may be configured to adjust the playing progress. When the electronic device 100 may detect a touch operation performed on the progress bar 1206 (for example, a tap operation on the progress bar 1206), the electronic device 100 may adjust the current playing progress in response to the operation.

For example, a current user interface is the user interface 40 used for video play. As shown in FIG. 28A, FIG. 28B, and FIG. 28C, when the electronic device 100 detects a tap operation performed on a home screen button 1207B, in response to the operation, the electronic device 100 displays both the home screen 24 and a floating window 41, and displays, in the floating window 41, a video image played in the content display area 902. From a perspective of a display effect, the electronic device 100 scales down a video playing window to obtain the floating window 41 used for video play. In this scenario, after the electronic device 100 exits the video playing interface 40, although the floating window 41 displayed by the electronic device 100 on the display 194 is presented in a form of a floating window, the floating window 41 still blocks a user interface currently displayed on the display 194. The user may intend to hide the floating window 41, and keep the floating window running in the background, so that the user can re-invoke the floating window later.

Based on the foregoing video playing scenario, the following describes, from two aspects, some user interface embodiments implemented on the electronic device 100.

Aspect 1: How to hide the floating window 41.

In some embodiments of this application, the finger of the user slides on the display 194, to drag the floating window 41 to an area in which the status bar 207 is located. A sliding start point of the finger of the user is in an area in which the floating window 41 is located, and a sliding trend of the finger of the user is sliding toward the top of the home screen. When the electronic device 100 detects the user operation, in response to the user operation, the electronic device 100 stops displaying the floating window 41.

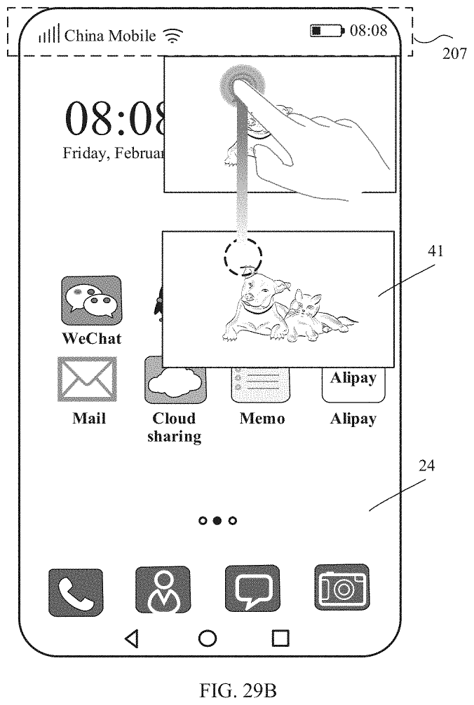

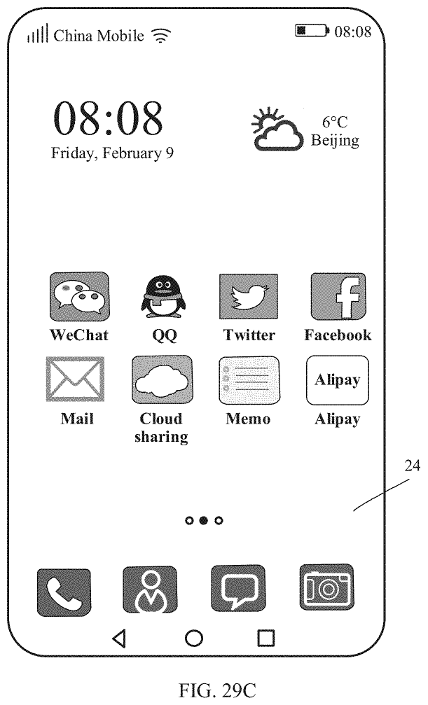

For example, as shown in FIG. 29A and FIG. 29B, the finger of the user slides on the display 194, to drag the floating window 41 to move on the home screen. A sliding start point of the finger of the user is in the area in which the floating window 41 is located. As shown in FIG. 29C, after the electronic device 100 detects that an upper edge of the floating window 41 coincides with a lower edge of the status bar 207, in response to the user operation, the electronic device 100 stops displaying the floating window 41, and the electronic device 100 keeps the floating window 41 running in the background.

In some embodiments of this application, based on Case 1, the finger of the user drags the floating window 41 to the area in which the status bar 207 is located. After the upper edge of the floating window 41 coincides with the lower edge of the status bar 207, the finger of the user continues to slide upward, and when the electronic device 100 detects that a distance by which the finger of the user continues to slide upward reaches the first distance threshold, the electronic device 100 stops displaying the floating window 41, and keeps the floating window 41 running in the background.

In this application, a user operation used to trigger the electronic device 100 to hide the floating window 41 may be preset by a system of the electronic device 100, or may be set by the user based on an operation habit of the user.

In the foregoing voice call scenario, for the user operation used to hide the floating window 41, refer to the first user operation in the video call scenario. Details are not described herein again.

Aspect 2: How to re-invoke the floating window 41.

It may be understood that after the user hides the floating window 41, the display 194 may display the home screen 24. Before the user re-invokes the floating window, the electronic device may receive a user operation performed by the user on the home screen 24. For example, the home screen 24 is switched to a third user interface. In this case, a current user interface displayed on the display 194 of the electronic device 100 is the third user interface. If the electronic device 100 detects a user operation used to re-invoke the floating window 41, in response to the user operation, the electronic device 100 displays the floating window 41 in the second user interface in a floating manner. The third user interface may be the same as or may be different from the home screen 24. The following describes, by using an example in which the third user interface may be the same as the home screen 24, how to re-invoke the hidden floating window.

In some embodiments of this application, when the electronic device 100 may detect a user operation performed on the home screen 24 (for example, the user single-taps the status bar 207 on the home screen 24), the electronic device 100 may re-invoke the floating window 41 in response to the user operation. In addition to single-tapping the status bar 207 on the home screen 24, the user operation may be double-tapping the status bar 207 on the home screen 24, touching and holding the status bar 207 on the home screen 24, or the like. Herein, the tap operation and the touch and hold operation may be performed by using one or more knuckles, a finger pad, a fingertip, a stylus, or the like.

It may be understood that when the electronic device 100 detects the user operation used to hide the floating window 41, the electronic device 100 first determines whether there is a hidden floating window (that is, the floating window running in the background), and if there is the hidden floating window, in response to the user operation, the electronic device 100 re-invokes the hidden floating window, and displays the floating window at a preset location on the display 194.

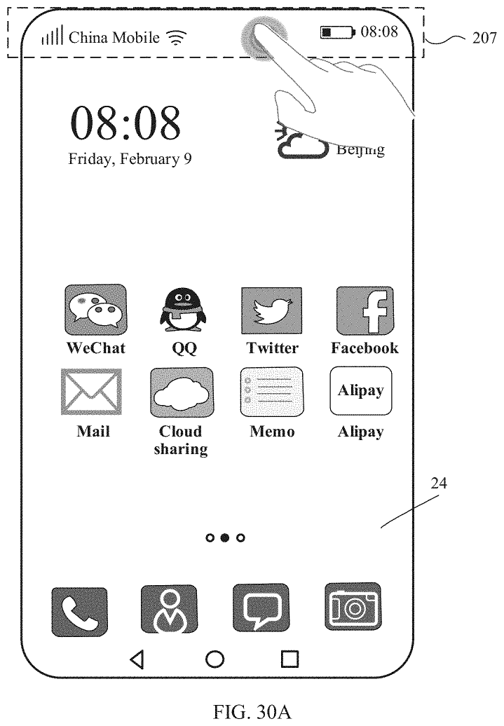

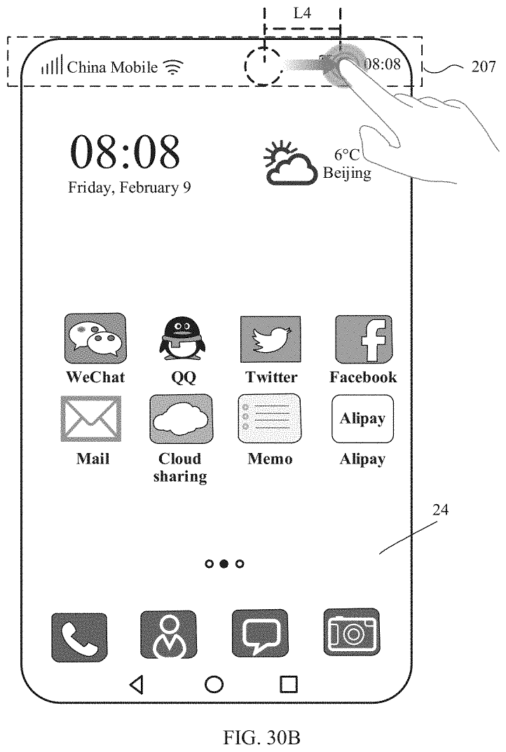

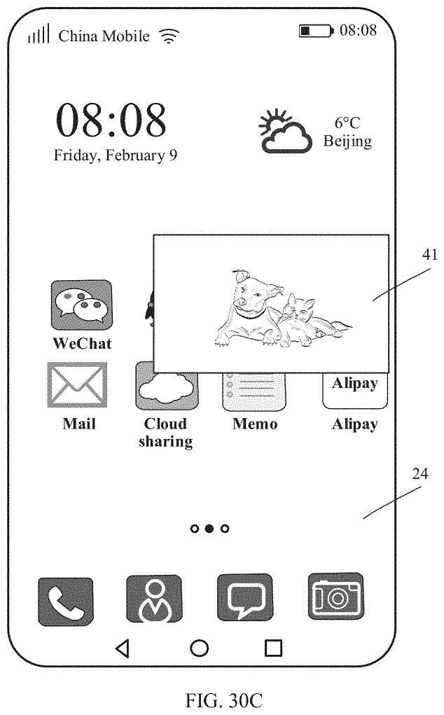

For example, as shown in FIG. 30A and FIG. 30B, the finger of the user slides leftward in the area in which the status bar 207 is located on the display 194. As shown in FIG. 30C, when the electronic device 100 detects that a distance by which the user operates to slide leftward reaches the fourth distance threshold, the electronic device 100 displays the floating window 41 at a preset location on the display 194.

In this application, the user operation used to trigger the electronic device 100 to re-invoke the floating window 41 may be preset by the system of the electronic device 100, or may be set by the user based on an operation habit of the user.

In the foregoing video playing scenario, for the user operation used to re-invoke the floating window 41, refer to the second user operation in the video call scenario. Details are not described herein again.

An embodiment of this application further provides a computer-readable storage medium. All or some of the procedures in the foregoing method embodiments may be completed by a computer program instructing related hardware. The program may be stored in the foregoing computer storage medium. When the program is executed, the procedures of the foregoing method embodiments may be included. The computer-readable storage medium includes any medium that can store program code, such as a read-only memory (read-only memory, ROM), a random access memory (random access memory, RAM), a magnetic disk, or an optical disc.

All or some of the foregoing embodiments may be implemented by software, hardware, firmware, or any combination thereof. When software is used to implement the embodiments, the embodiments may be implemented completely or partially in a form of a computer program product. The computer program product includes one or more computer instructions. When the computer program instructions are loaded and executed on a computer, all or some of the procedures or functions according to the embodiments of this application are generated. The computer may be a general-purpose computer, a dedicated computer, a computer network, or another programmable apparatus. The computer instructions may be stored in a computer-readable storage medium, or may be transmitted by using the computer-readable storage medium. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (solid-state drive, SSD)), or the like.

A sequence of the steps of the method in the embodiments of this application may be adjusted, combined, and deleted based on an actual requirement.

The modules in the apparatus in the embodiments of this application may be combined, divided, and deleted based on an actual requirement.

In conclusion, the foregoing embodiments are merely intended for describing the technical solutions of this application, but not for limiting this application. Although this application is described in detail with reference to the foregoing embodiments, a person of ordinary skill in the art should understand that modifications to the technical solutions recorded in the foregoing embodiments or equivalent replacements to some technical features thereof may still be made, without departing from the scope of the technical solutions of the embodiments of this application.

1. A method implemented by an electronic device, wherein the method comprises:
displaying a first user interface and a floating window on a display of the electronic device, wherein the floating window displays an image of a video contact;
receiving a first user operation of a user dragging the floating window to a first status bar in the first user interface; and
hiding, in response to the first user operation, the floating window.

2. The method of claim 1, wherein after hiding the floating window, the method further comprises:
receiving a second user operation performed on a second status bar in a second user interface; and
displaying, in response to the second user operation, the second user interface and the floating window on the display.

3. The method of claim 2, wherein after hiding the floating window, the method further comprises:
receiving a third user operation performed on the second status bar; and
displaying, on the display in a full screen mode in response to the third user operation, a video call interface corresponding to the floating window.

4. The method of claim 2, wherein hiding the floating window, the method further comprises:
receiving a fourth user operation performed on the second status bar; and
displaying, in response to the fourth user operation, the second user interface in a first area of the display and displaying a video call interface corresponding to the floating window in a second area of the display.

5. The method of claim 1, further comprising displaying the floating window and the first status bar in a non-overlapping manner, wherein the first user operation comprises sliding a finger on the display to drag the floating window upward to the first status bar until a first preset condition is met.

6. The method of claim 5, wherein the first preset condition comprises:
an upper edge of the floating window coincides with a lower edge of the first status bar;
the finger stops sliding and stops touching the floating window when the upper edge coincides with the lower edge of the status bar;
a distance by which the finger continues to slide upward on the display reaches a first distance threshold after the upper edge coincides with the lower edge;
the finger stops sliding and stops touching the display after the upper edge coincides with the lower edge when the distance is greater than or equal to the first distance threshold;
a time period during which the finger continues to touch the floating window reaches a first time threshold after the upper edge of the floating window coincides with the lower edge of the status bar; or
the finger stops touching the floating window after the upper edge of the floating window coincides with the lower edge of the status bar when the time period during which the finger continues to touch the floating window is greater than or equal to the first time threshold.

7. The method of claim 1, further comprising displaying the floating window and the first status bar in an overlapping manner, wherein the floating window stops moving upward after a first upper edge of the floating window coincides with a second upper edge of the first status bar, wherein a width of a third status bar on the electronic device is a first width value, and wherein the first user operation comprises sliding a finger on the display to drag the floating window upward to the first status bar until a second preset condition is met.

8. The method of claim 7, wherein the second preset condition comprises:
a first distance between the first upper edge of the floating window and the second upper edge of the status bar is less than the first width value;
the finger stops touching the floating window when the first distance is less than the first width value;
a first time period during which the finger stops sliding and continues to touch the floating window reaches a second time threshold when the first distance is less than the first width value;
the finger stops touching the floating window after the first distance is less than the first width value and the first time period during which the finger continues to touch the floating window is greater than or equal to the second time threshold;
the first upper edge of the floating window coincides with the first upper edge of the status bar;
the finger stops sliding and stops touching the floating window when the first upper edge of the floating window coincides with the second upper edge of the status bar;
a second distance over which the finger continues to slide upward on the display reaches a second distance threshold after the first upper edge of the floating window coincides with the second upper edge of the status bar;
the finger stops sliding and stops touching the display after the first upper edge of the floating window coincides with the second upper edge of the status bar and when the second distance is greater than or equal to the second distance threshold;
a second time period during which the finger continues to touch the floating window reaches a third time threshold after the first upper edge of the floating window coincides with the second upper edge of the status bar; or
the finger stops touching the floating window after the first upper edge of the floating coincides with the second upper edge of the status bar and the second time period during which the finger continues to touch the floating window is greater than or equal to the third time threshold.

9. The method of claim 1, further comprising displaying the floating window and the first status bar in an overlapping manner, wherein the floating window continues to move upward after a first upper edge of the floating window coincides with a send upper edge of the first status, wherein a current height of the floating window is a first height value, wherein a third distance threshold is less than the first height value, and wherein the first user operation comprises sliding a finger on the display to drag the floating window upward to the first status bar until a third preset condition is met.

10. The method of claim 9, wherein the third preset condition comprises:
a distance between a lower edge of the floating window and the second upper edge is less than the first height value;
the finger stops touching the floating window when the distance is less than the first height value;
the distance reaches the third distance threshold; or
the finger stops sliding and stops touching the display when the distance is less than the third distance threshold.

11. The method of claim 2, wherein the second user operation comprises:
a user finger single-tapping or double-tapping the second status bar;
sliding a finger leftward or rightward on the second status bar for a first time period greater than or equal to a fourth time threshold;
sliding a finger leftward or rightward on the second status bar by a first distance greater than or equal to a fourth distance threshold;
touching and holding the second status bar for a second time period greater than or equal to a fifth time threshold; or
sliding a finger downward by using the second status bar as a start point and stopping sliding and stopping touching the display when a second distance by which the finger slides downward is greater than a fifth distance threshold.

12. The method of claim 3, wherein the third user operation comprises:
a finger single-tapping or double-tapping the second status bar;
sliding a finger leftward or rightward on the second status bar for a first time period greater than or equal to a fourth time threshold;
sliding a finger leftward or rightward on the seeond status bar by a first distance greater than or equal to a fourth distance threshold;
touching and holding the second status bar for a second time period greater than or equal to a fifth time threshold; or
sliding a finger downward using the seeond status bar as a start point and stopping sliding and stopping touching the display when a second distance by which the finger slides downward is greater than a fifth distance threshold.

13. The method of claim 4, wherein the fourth user operation comprises:
a finger single-tapping or double-taping the second status bar;
sliding a finger leftward or rightward on the seeond status bar for a first time period greater than or equal to a fourth time threshold;
sliding a finger leftward or rightward on the second status bar by a first distance greater than or equal to a fourth distance threshold;
touching and holding the second status bar for a second time period greater than or equal to a fifth time threshold; or
sliding a finger downward using the seeond status bar as a start point and stopping sliding and stopping touching the display when a second distance by which the finger slides downward is greater than a fifth distance threshold.

14. The method of claim 4, wherein a fifth user operation comprises a finger sliding downward on the display using the second status bar as a first start point, and stopping sliding and steps-stopping touching the display when a first distance by which the finger slides downward is less than a fifth distance threshold, wherein the fifth user operation triggers the electronic device to display a system notification bar interface in a full screen mode, wherein the second user operation comprises sliding a finger downward on the display using the second status bar as a second start point and stopping sliding and stopping touching the display when a second distance by which the finger slides downward is greater than or equal to the fifth distance threshold and less than a sixth distance threshold, wherein a third user operation comprises sliding a finger downward on the display using the seeond status bar as a third start point and stopping sliding and stopping touching the display when a third distance by which the finger slides downward is greater than or equal to the sixth distance threshold and less than a seventh distance threshold, and wherein the fourth user operation comprises either sliding a finger downward using the display on the display using the second status bar as a fourth start point until a fourth distance by which the finger slides downward reaches the seventh distance threshold, or sliding a finger downward on the display using the seeond status bar as a fifth start point and stopping sliding and stopping touching the display when a fifth distance by which the finger slides downward is greater than or equal to the seventh distance threshold.

15. The method of claim 4, wherein the second user operation comprises sliding a finger downward on the display using a first preset area of the second status bar as a first start point and stopping sliding and stopping touching the display when a first distance by which the finger slides downward is less than an eighth distance threshold, wherein a third user operation comprises either sliding a finger downward on the display using the first preset area as a seeond start point until a second distance by which the finger slides downward reaches the eighth distance threshold or sliding a finger downward on the display using the first preset area as a third start point and stopping sliding and stopping touching the display when a third distance by which the finger slides downward is greater than or equal to the eighth distance threshold, wherein a fifth user operation comprises sliding a finger downward on the display using a second preset area of the second status bar as a fourth start point and stopping sliding and stopping touching the display when a fourth distance by which the finger slides downward is less than a fifth distance threshold, wherein the fourth user operation comprises sliding a finger downward on the display using the second preset area as a fifth start point until a fifth distance by which the finger slides downward reaches the fifth distance threshold, or sliding a finger downward on the display using the second preset area as a sixth start point and stopping sliding and stopping touching the display when a sixth distance by which the finger slides downward is greater than or equal to the fifth distance threshold, and wherein widths of the second status bar, the first preset area, and the second preset area are the same.

16. The method of claim 15, wherein the display comprises a notch screen or a hole-punch display, wherein a notch of the notch screen or a small hole of the hole-punch display is located at a middle location of an upper edge of the display, wherein the method further comprises dividing the second status bar into a left half part and a right half part using the notch or the small hole as a division point, wherein the first preset area is the left half part and the second preset area is the right half part, or wherein the first preset area is the right half part and the second preset area is the left half part.

17. The method of claim 15, wherein the display comprises a foldable screen, wherein the method further comprises dividing the second user interface into a first interface and a second interface using a folding track of the foldable screen as a division line, wherein the first preset area is a third status bar in the first interface and the second preset area is a fourth status bar in the second interface, or wherein the first preset area is a fifth status bar in the second interface and the second preset area is a sixth status bar in the first interface.

18. The method of claim 4, wherein the display comprises a hole-punch display comprising a small hole located on the second status bar, and wherein the method further comprises:
receiving a sixth user operation performed on the second status bar, wherein the sixth user operation comprises a finger approaching the small hole in a floating manner;
displaying, around the small hole and in response to the sixth user operation, a menu navigation window comprising a first option control, wherein the first option control is configured to trigger the electronic device to display the floating window when a seventh user operation is received; and
receiving a seventh user operation comprising a finger tapping the first option control.

19.-25. (canceled)

26. An electronic device, comprising:
a memory configured to store computer instructions; and
a processor coupled to the memory, wherein when executed by the processor, the computer instructions cause the electronic device to:
display a first user interface and a floating window on a display of the electronic device, wherein the floating window displays an image of a video contact;
receive a first user operation of a user dragging the floating window to a first status bar in the first user interface; and
hide, in response to the first user operation, the floating window.

27. A computer program product comprising computer instructions stored on a non-transitory computer-readable medium that, when executed by a processor, cause an electronic device to:
display a first user interface and a floating window on a display of the electronic device, wherein the floating window displays an image of a video contact;
receive a first user operation of a user dragging the floating window to a first status bar in the first user interface; and
hide, in response to the first user operation, the floating window.

28. (canceled)
